(19) United States
(12) Patent Application Publication
(10) Pub. No.: US 2025/0390813 A1
(43) Pub. Date: Dec. 25, 2025

(54) MATCHING SYSTEM, COMPUTING DEVICE, AND METHOD

(71) Applicant: Murata Manufacturing Co., Ltd., Nagaokakyo-shi (JP)

(72) Inventors: Masaharu ITAYA, Nagaokakyo-shi (JP); Yusuke MORI, Nagaokakyo-shi (JP); Kazuki MATSUI, Nagaokakyo-shi (JP); Yuuto NIWA, Nagaokakyo-shi (JP)

(73) Assignee: Murata Manufacturing Co., Ltd., Nagaokakyo-shi (JP)

(21) Appl. No.: 19/304,707

(22) Filed: Aug. 20, 2025

Related U.S. Application Data
(63) Continuation of application No. PCT/JP2023/039887, filed on Nov. 6, 2023.

(30) Foreign Application Priority Data
Feb. 22, 2023 (JP) 2023-026059

(51) Int. Cl. G06Q 10/0631

(52) U.S. Cl. CPC G06Q 10/063112

(57) ABSTRACT

A matching system that matches requesters with applicants by displaying educational content associated with posted projects. The system includes a first applicant device operated by a first applicant and a computing device.) in communication with the first applicant device and a database. The database stores first disclosure information defining a disclosure range for posted projects and second disclosure information defining a separate, independent disclosure range for associated educational content. In response to a request from the first applicant device, the computing device executes a filtering process that identifies a subset of posted projects permitted for disclosure based on the first disclosure information and identifies a subset of educational content permitted for disclosure based on the second disclosure information. The computing device generates for display a customized user interface presenting only the permitted projects and their corresponding permitted educational content to be displayed to the first applicant device.

### CROSS-REFERENCE TO RELATED APPLICATIONS

The present application is a continuation of International Application No. PCT/JP2023/039887, filed Nov. 6, 2023, which claims priority to Japanese patent application JP 2023-026059, filed Feb. 22, 2023, the entire contents of each of which being incorporated herein by reference.

### TECHNICAL FIELD

The present disclosure relates to a matching system, a computing device, and a method for matching a requester who solicits a contractor for a task with an applicant.

### BACKGROUND ART

As technologies advance rapidly and the aging of the population progresses, substantial changes are occurring in the industrial and employment structures. Workers and job seekers are asked to improve themselves so as to respond to the needs of the changing industrial structure.

There have been proposed education systems that provide educational content useful for such self-improvement. For example, Patent Document 1 discloses an education system that presents curriculums related to tasks for which a learner is responsible, and further presents the learner with application cases and related information that are useful for the practical understanding of learning content.

### CITATION LIST

### Patent Document

Patent Document 1: Japanese Unexamined Patent Application Publication No. 2005-222427

### SUMMARY

### Technical Problems

Those who attempt to improve themselves may consider utilizing a matching system related to their tasks in order to improve their practical skills. Users of the matching system can gain practical experience that could not be obtained from educational content, by fulfilling tasks that the users accept from requesters. This allows the users of the matching system to improve their practical skills.

To be selected as a contractor from among a large number of applicants, however, users themselves must have skills necessary for posted tasks. Even when a user is interested in a posted task, the user will hesitate to apply for the posted task if the user does not have the skill related to the posted task or if the level of the user's skills is low. Even if the user applies for the posted task, it is considered less likely that the user will be hired as a contractor.

For this reason, for those who plan to utilize the matching system as an applicant for the purpose of improving their practical skills, the inadequacy of their own skills will be an obstacle to their plans. Even for those who simply plan to accept a task with a high unit price rather than aiming to improve their practical skills, the inadequacy of their own skills will be an obstacle to their plans, depending on a relationship between a posted task and their own skills.

However, matching systems according to the related art have lacked a device to remove such an obstacle. Moreover, there have been no education systems aimed at clearing such an obstacle that arises when the matching system is utilized. For example, an education system described in Patent Document 1 is intended for a company to educate employees who belong to the company, and does not give any consideration to a matching system that is not bound by the framework of a company.

The present disclosure has been made to solve the problems described above. The present disclosure is directed to preventing the inadequacy of skills of those who plan to utilize a matching system as an applicant from becoming an obstacle to their plans.

### Solutions to Problems

A matching system according to a first aspect of the present disclosure is a matching system that matches a requester who solicits a contractor for a task with an applicant. The matching system includes a first applicant device operated by a first applicant; and a computing device that communicates with the first applicant device and is accessible to a database in which task information indicating content of a posted task is registered for each posted project. The computing device registers, in the database, content information that can identify educational content related to the posted project, in association with the posted project, and the computing device displays the content information together with the posted project on the first applicant device.

A computing device according to a second aspect of the present disclosure is a computing device included in a matching system that matches a requester who solicits a contractor for a task with an applicant. The computing device includes a communication interface that communicates with a first applicant device operated by a first applicant; and a processor that communicates with the first applicant device and is accessible to a database in which task information indicating content of a posted task is registered for each posted project. The processor registers, in the database, content information that can identify educational content related to the posted project, in association with the posted project, and the processor displays the content information together with the posted project on the first applicant device.

A method according to a third aspect of the present disclosure is a method for matching a requester who solicits a contractor for a task with an applicant. The method includes steps of communicating with a first applicant device operated by a first applicant; communicating with the first applicant device and accessing a database in which task information indicating content of a posted task is registered for each posted project; registering, in the database, content information that can identify educational content related to the posted project, in association with the posted project, and displaying the content information together with the posted project on the first applicant device.

### Advantageous Effects

According to the present disclosure, it is possible to prevent the inadequacy of skills of those who plan to utilize a matching system as an applicant from becoming an obstacle to their plans.

### BRIEF DESCRIPTION OF DRAWINGS

FIG. 1 is a block diagram illustrating an overview of a matching system.

FIG. 2 is a block diagram illustrating configurations of a sharing server, a requester device, and an applicant device.

FIG. 3 is a diagram illustrating an example of a company database.

FIG. 4 is a diagram illustrating an example of a member database.

FIG. 5 is a diagram illustrating an example of a community database.

FIG. 6 is a diagram illustrating an example of a posted project database.

FIG. 7 is a diagram illustrating an example of a side job database.

FIG. 8 is a diagram illustrating an example of an evaluation input database.

FIG. 9 is a diagram illustrating an example of an evaluation summary database.

FIG. 10 is a diagram for explaining functions of the sharing server, the requester device, and the applicant device.

FIG. 11 is a diagram for explaining the functions of the sharing server, the requester device, and the applicant device.

FIG. 12 is a diagram for explaining the functions of the sharing server, the requester device, and the applicant device.

FIG. 13 is a diagram for further explaining the function of the applicant device.

FIG. 14 is a diagram for explaining a procedure for registering a posted project in the posted project database.

FIG. 15 is a diagram for explaining a procedure for searching for a posted project from the database.

FIG. 16 is a diagram for explaining a procedure for registering a side job plan and performance in the database.

FIG. 17 is a diagram for explaining a procedure for registering an evaluation for the applicant in the database.

FIG. 18 is a diagram for explaining a procedure for registering an evaluation for the requester in the database.

FIG. 19 is a diagram for explaining a procedure for displaying the evaluation for the applicant and member search results on a display.

FIG. 20 is a diagram for explaining a procedure for displaying the evaluation for the requester and member search results on the display.

FIG. 21 is a diagram for explaining a viewable range of the evaluation summary database.

FIG. 22 is a diagram illustrating a screen to be displayed on a supervisor's applicant device when a supervisor (a superior of the applicant) checks side job statuses of his/her subordinates.

FIG. 23 is a diagram illustrating details of project contents included in the posted project database.

FIG. 24 is a diagram illustrating an example in which a posted project and educational content are restricted for each company by disclosure information.

FIG. 25 is a diagram illustrating an example in which a disclosure range is set according to a disclosure level.

FIG. 26 is a diagram illustrating an example in which a disclosure range of a posted project and a disclosure range of educational content are set according to the disclosure level.

FIG. 27 is a diagram illustrating a display example of a list of posted projects.

FIG. 28 is a diagram illustrating another display example of the list of posted projects.

FIG. 29 is a diagram illustrating an example of a first-type content database.

FIG. 30 is a diagram illustrating an example of a second-type content database.

FIG. 31 is a diagram illustrating an example of a required skill database.

FIG. 32 is a diagram illustrating an example of a content management database.

FIG. 33 is a flowchart illustrating a processing procedure for registering a posted project together with educational content.

FIG. 34 is a flowchart illustrating a processing procedure of a project registration unit.

FIG. 35 is a flowchart illustrating a processing procedure of a content specification unit.

FIG. 36 is a flowchart illustrating a processing procedure of a disclosure range setting unit.

FIG. 37 is a flowchart illustrating a processing procedure for providing an applicant with educational content related to a posted project, in response to an operation by the applicant.

FIG. 38 is a diagram illustrating a display example of a list of posted projects according to Modification Example 1.

FIG. 39 is a diagram illustrating another display example of the list of posted projects according to Modification Example 1.

FIG. 40 is a diagram for explaining functions of a sharing server, a requester device, and an applicant device according to Modification Example 2.

FIG. 41 is a diagram illustrating an example of a member database according to Modification Example 2.

FIG. 42 is a flowchart illustrating a processing procedure of counter offer member search processing according to Modification Example 2.

FIG. 43 is a block diagram illustrating configurations of a sharing server, a requester device, and an applicant device according to Modification Example 3.

FIG. 44 is a diagram illustrating an example of a member group database according to Modification Example 3.

FIG. 45 is a diagram illustrating an example of a posted project database according to Modification Example 3.

FIG. 46 is a diagram for explaining functions of the sharing server, the requester device, and the applicant device according to Modification Example 3.

FIG. 47 is a diagram for explaining a procedure for registering a posted project in a posted project database according to Modification Example 3.

### DESCRIPTION OF EMBODIMENTS

In the following, embodiments of the present disclosure will be described in detail with reference to the drawings. Note that in the figures, the same or corresponding parts are designated by the same reference numerals, and a description thereof will not be repeated.

### [Background for Proposing Matching System 1]

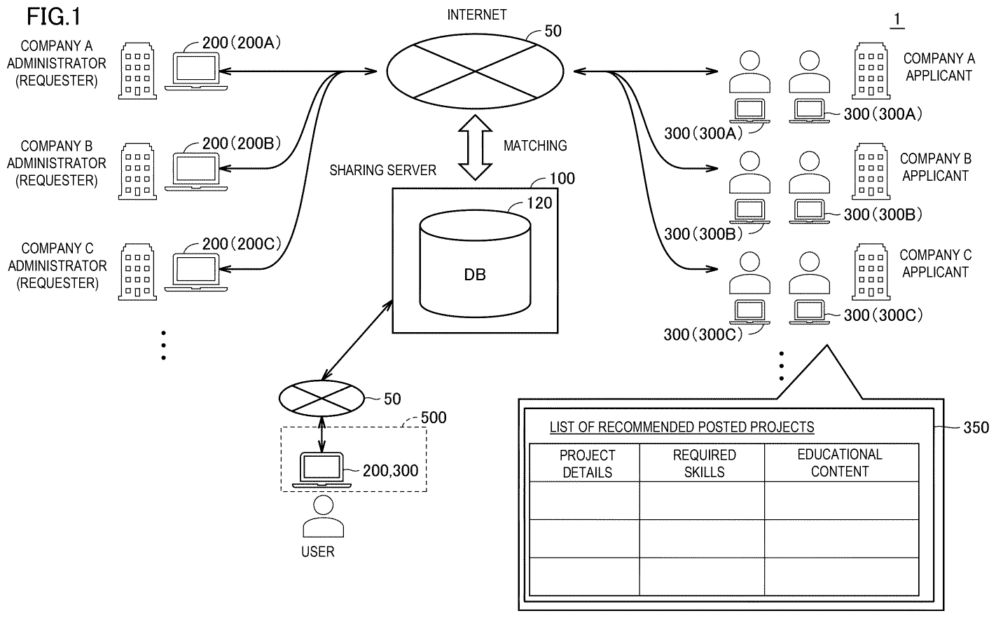

FIG. 1 is a block diagram illustrating an overview of a matching system 1 according to the present embodiment. First, in the present embodiment, a description will be given of a background for proposing the matching system 1.

The matching system 1 is utilized, for example, in crowdsourcing between companies. In general, crowdsourcing is a process that solicits contributions from a large indefinite number of people to obtain needed services, ideas, or contents.

There are not a few companies that encourage side jobs to effectively utilize their human resources. Crowdsourcing between companies makes it possible to utilize abilities of employees of the companies.

However, directly applying a typical crowdsourcing method between companies might result in problems to be described below.

### [Possibility That Confidential Information May Leak]

Adoption of crowdsourcing entails a company risk or a personal risk because in the typical crowdsourcing method, no consideration is given to a relationship between a company on orderer side and a company on contractor side. For example, there is a risk that confidential information may be leaked to a company in a rival relationship, through an employee's side job. A crowdsourcing method according to the related art does not allow a supervisor to confirm that an employee is not accepting a project of the competitor company as a side job.

### [Possibility of Overwork]

If a company allows its employees to undertake side jobs, there is a risk that employees' working hours may become excessively long. To clear the risk of overwork, it is conceivable that a company defines an upper limit on a number of overtime hours, including a main job and a side job. However, as long as employees can freely accept a side job, it is difficult for the company to control side job hours of the employees. This may result in overwork of the employees.

### [Possibility That Side Job Results Are Not Properly Evaluated]

There have been crowdsourcing systems that request an orderer to evaluate a contractor. If an appropriate evaluation made by the orderer is shared on the crowdsourcing systems, those who solicit a contractor for a task can refer to the evaluation and select a highly capable person from among many applicants who wish to accept the task.

However, an orderer of a certain company may give excessive consideration to a contractor from another company to be evaluated, so that the orderer may input a higher evaluation than an actual evaluation into the system. In addition, an orderer of a certain company may avoid giving a low evaluation to a contractor from another company, considering the possibility that a relationship between the companies may worsen. Furthermore, orderers cannot find any benefit in making evaluations and may input an evaluation that is far from the actual evaluation into the system. Given these possibilities, there is a risk that reliability of evaluations provided by the system may decrease. In this case, even if evaluations for contractors are shared, orderers of a task cannot utilize the evaluations as reference data when selecting a contractor.

### [Possibility That Accurate Information Regarding Requesters Cannot Be Obtained]

In the crowdsourcing systems as described above, applicants who plan to apply for a posted task will select a task that they find reasonable, while referring to task contents, rewards, or the like. However, there may exist some requesters that make an additional request that is outside of the scope of a contracted task or that often instruct changes to the task contents. Applicants would wish to apply for a posted task, avoiding such requesters. Conversely, there exist requesters that do not cause any problems until the task is completed. Applicants would wish to apply for a task being posted by such requesters if possible. Therefore, it is desirable that crowdsourcing systems widely share evaluations for requesters (orderers) as well as evaluations for applicants (contractors).

When appropriate evaluations of requesters are shared in the crowdsourcing systems, those who plan to apply for a task can refer to the evaluations, considering past business records of the requesters, and select a task that they find reasonable, from among a large number of posted tasks.

However, when constructing an evaluation system capable of evaluating requesters, a similar problem may arise as in a case of constructing an evaluation system capable of evaluating contractors. That is, a contractor (applicant) of a certain company may give excessive consideration to an orderer (requester) from another company to be evaluated, so that the contractor may enter a higher evaluation than an actual evaluation in the system. In addition, a contractor (applicant) of a certain company may avoid giving a low evaluation to an orderer (requester) from another company, considering the possibility that a relationship between the companies may worsen. Furthermore, a contractor (applicant) cannot find any benefit in making evaluations and input an evaluation that is far from the actual evaluation into the system. Given these possibilities, there is a risk that the reliability of evaluations provided by the system may decrease. In this case, even if evaluations for requesters are shared, applicants cannot utilize the evaluations as reference data when selecting a requester.

### [Special Characteristics Related to Company Being Matching Entity]

In general, in order to match human resources and tasks across companies, it is necessary that companies that perform matching of human resources and tasks have a close relationship such as a relationship of mutual trust, or the like. Therefore, it is very difficult to perform the matching of human resources and tasks across companies that have no capital ties. Moreover, for large companies like those that are publicly listed, there exist special circumstances where they tend to compete with other companies due to their diversified operations. This leads to cannibalization with other companies, making the matching of human resources and tasks impossible in many companies.

[Problem of Inadequacy of Skill that Arises When Planning Utilization for the Purpose of Improving Skills]

Some companies build educational platforms for their employees, as one of the approaches to improve employees' practical skills. However, unless employees are provided with opportunities to use knowledge obtained through utilization of the educational platforms, the employees cannot improve their practical skills. Therefore, employees need to acquire both “knowledge” and “experience” in order to improve their practical skills.

Then, as another approach to improve employees' practical skills, some companies introduce a task matching system for internal use. By utilizing such a task matching system, employees can be involved in in-house tasks different from those of which they are currently in charge. As a result, employees can acquire new practical skills.

However, in the task matching system, the scope of which is limited to within a company, the number of projects available for application is limited, and tasks that can be applied for are not highly varied. Thus, an attempt is made to adopt a crowdsourcing method that is common to companies. This allows an employee of one company to apply, as an applicant, for a posted task of another company. As a result, the employee can select a task related to a practical skill that he/she wishes to improve, from a large number of highly varied tasks.

To be selected as a contractor from among a large number of applicants, however, employees themselves must have skills necessary for posted tasks. Even when an employee is interested in a posted task, the employee will hesitate to apply for the posted task if the employee does not have the skill related to the posted task or if the level of the employee's skills is low. Even if the employee applies for the posted task, it is considered less likely that the user will be hired as a contractor.

For this reason, for employees who plan to utilize the matching system as an applicant for the purpose of improving their practical skills, the inadequacy of their own skills will be an obstacle to their plans. Even for employees who simply plan to accept a task with a high unit price rather than aiming to improve their practical skills, the inadequacy of their own skills will be an obstacle to their plans, depending on a relationship between a posted task and their own skills.

In the present embodiment, the matching system 1, to be detailed below, is proposed in order to solve at least one of the above-described various issues that the crowdsourcing systems according to the related art have.

### [Overall Configuration]

A configuration of the matching system 1 will be described with reference to FIG. 1. The matching system 1 includes a sharing server 100, requester devices 200A, 200B, 200C, . . . , and applicant devices 300A, 300B, 300C, . . . .

The sharing server 100 provides a large number of companies with a matching service that performs the matching of order placement and order acceptance for tasks among companies. FIG. 1 illustrates Company A, Company B, Company C, . . . as examples of companies that utilize the matching service. Company A, Company B, Company C, . . . are registered as company members of the matching system 1. Among employees of Company A, Company B, Company C, . . . those who utilize the matching system 1 are also individually registered as members of the matching system 1.

Tasks assigned in the matching system 1 are, for example, temporary tasks assumed to be completed in a predetermined period of time. Therefore, a person who accepts a task assigned in the matching system 1 is engaged in tasks of a specific department to which she/he belongs within a company, as his/her main job, and is engaged in a task assigned in the matching system 1, as a side job. Note that in the matching system 1, for example, an applicant from Company A can accept a task of Company A. Therefore, in the matching system 1, an applicant who belongs to a different department Y of Company A is also allowed to accept a task from a department X of Company A.

Hereinafter, a task for which a contractor is solicited in the matching system 1 may be referred to as a “posted task” or a “posted project”, those who provide a posted project may be referred to as a “requester”, and those who apply to accept an order for a posted project may be referred to as an “applicant”. Applying for a posted task may be referred to as “application for a posted task” or “application for a posted project”.

An applicant who accepts an order for a posted project corresponds to a “contractor”, and a requester who places an order for a project with a contractor corresponds to an “orderer”. However, hereinafter, the term “applicant” may also include the “contractor” and the term “requester” may include the “orderer”.

A database 120 necessary for the matching service is constructed in the sharing server 100. The database 120 includes various databases in which information necessary for providing the matching service is registered. For example, information on members, posted tasks, or the like, is registered in the database 120. The sharing server 100 is managed and operated by a company other than companies that utilize the matching service. Any of the companies utilizing the matching service may manage and operate the sharing server 100.

The requester device 200A is operated by an administrator of Company A. The requester device 200B is operated by an administrator of Company B. The requester device 200C is operated by an administrator of Company C. Hereinafter, the requester devices 200A, 200B, 200C, . . . may be collectively referred to as the “requester devices 200”.

The applicant device 300A is operated by an applicant of Company A. The applicant device 300B is operated by an applicant of Company B. The applicant device 300C is operated by an applicant of Company C. Hereinafter, the applicant devices 300A, 300B, 300C, . . . may be collectively referred to as the “applicant devices 300”. FIG. 1 illustrates two applicants for each of the companies, but the number of applicants is not limited thereto. There may be more applicants in each of the companies or a certain company may have only one applicant. The sharing server 100 may accept those who do not belong to a company, such as freelancers, as applicants.

In the present embodiment, administrators of Company A, Company B, Company C, . . . shall assume a role of requesters. Therefore, hereinafter, the administrator in each of the companies may be referred to as a “requester”. A requester can also act as an applicant for a task being posted by another requester. In that case, the requester device 200 functions as the applicant device 300. In the present embodiment, when a company administrator acts as a requester, a device used by the administrator for utilizing the matching service is referred to as the requester device 200.

There may be one administrator or more than one administrator in Company A. If an administrator is arranged in Company A, the requester device 200 may be given to each administrator or the one requester device 200 may be shared by more than one person. This similarly applies to Company B, Company C, . . . .

The sharing server 100 and the requester devices 200 are configured to be able to communicate with each other via Internet 50, which is one example of a communication network. The sharing server 100 and the applicant devices 300 are configured to be able to communicate with each other via the Internet 50.

When receiving access from the requester device 200, the sharing server 100 requests sign-in with input of a member ID and a password. Similarly, when receiving access from the applicant device 300, the sharing server 100 requests sign-in with a member ID and a password. The sharing server 100 individually identifies the requester and the applicant using the member ID notified at the time of signing in.

The requester device 200 receives various operations by the requester. For example, the requester device 200 receives an operation to input a posted project (requested task), an operation to input an evaluation for a contractor who has completed a task, and an operation to search for a member of the matching service, or the like.

The requester device 200 communicates with the sharing server 100 in response to each of the operations on the requester device 200. The sharing server 100 registers a posted project in the database 120 in response to the operation to input a posted project (requested task), registers an evaluation for the target applicant (contractor) in the database 120 in response to the operation to input an evaluation, and provides the requester device 200 with member information in response to the operation to search for a member.

The applicant device 300 receives various operations by the applicants. For example, the applicant device 300 receives an operation to search for a posted project, an operation to apply for a posted project, an operation to input task performance, an operation to input an evaluation for a requester (orderer), and the like.

The applicant device 300 communicates with the sharing server 100 in response to each of the operations on the applicant devices 300. The sharing server 100 provides the applicant device 300 with an appropriate posted project in response to the operation to search for a posted project, issues to the applicant device 300 a notice of hiring or non-hiring in response to the operation to apply for a posted project, registers the task performance in the database 120 in response to the operation to input task performance, and registers the evaluation for the target requester (orderer) in the database 120 in response to the operation to input an evaluation.

As described above, the matching system 1 includes an evaluation system that evaluates applicants (contractors) and requesters (orderers) of a task, and a posting system that solicits a contractor for a task.

By utilizing the matching system 1, a requester who belongs to a certain department in Company A can employ an applicant who belongs to another department in Company A, as a contractor of a posted project. By utilizing the matching system 1, a requester who belongs to Company A can employ an applicant who belongs to Company B as a contractor of a posted project.

A member who utilizes the matching system 1 accesses the sharing server 100 as a requester or an applicant. Hereinafter, a member of the matching system 1 may be referred to as a “user”. In addition, hereinafter, the requester device 200 and the applicant device 300 operated by the members may be collectively referred to as a “user device 500”.

FIG. 1 exemplarily illustrates a screen 350 displayed on the applicant device 300. As illustrated in FIG. 1, a list of posted projects is displayed on the screen 350. Utilizing a predetermined recommendation algorithm, the sharing server 100 extracts posted projects that are estimated to attract applicants' attention from among a large number of posted projects, and displays extraction results as a “list of recommended posted projects” on the screen 350.

The list of posted projects includes columns for project details, required skills, and educational content. Project Details column lists details of posted projects. Required Skills column lists details of skills required of applicants. Educational Content column lists titles of educational content that is recommended for viewing in order to acquire the required skills. For example, when an operation to click a title is received, a screen for viewing video data, which is an example of educational content, is displayed on the applicant device 300.

An applicant looks at Project Details column and Required Skills column, and selects a project to apply for. The applicant determines whether or not he/she possesses skills required by the posted project, by comparing skills possessed by him/her with skills listed in Required Skills column.

If the applicant himself/herself possesses the skills required by the posted project, the applicant will select the posted project as one of the candidates for application. If the applicant does not possess the skills required by the posted project, the applicant may hesitate to select the posted project as one of the candidates for application.

For employees who plan to utilize the matching system 1 as an applicant for the purpose of improving their practical skills, the inadequacy of their own skills will be an obstacle to their plans. Even for employees who simply plan to accept a task with a high unit price rather than aiming to improve their practical skills, the inadequacy of their own skills will be an obstacle to their plans, depending on a relationship between a posted task and their own skills.

However, in the matching system 1 according to this embodiment, the list of posted projects displays information on educational content that is useful for acquiring the skills required by the posted project. For this reason, the applicant can learn the skill required by the posted project by viewing the educational content listed in Educational Content column.

After learning educational content, the applicant may select a posted project he/she avoided selecting before learning, as one of the candidates for application. Therefore, according to this embodiment, it is possible to prevent the inadequacy of skills of those who plan to utilize a matching system 1 as an applicant from becoming an obstacle to their plans.

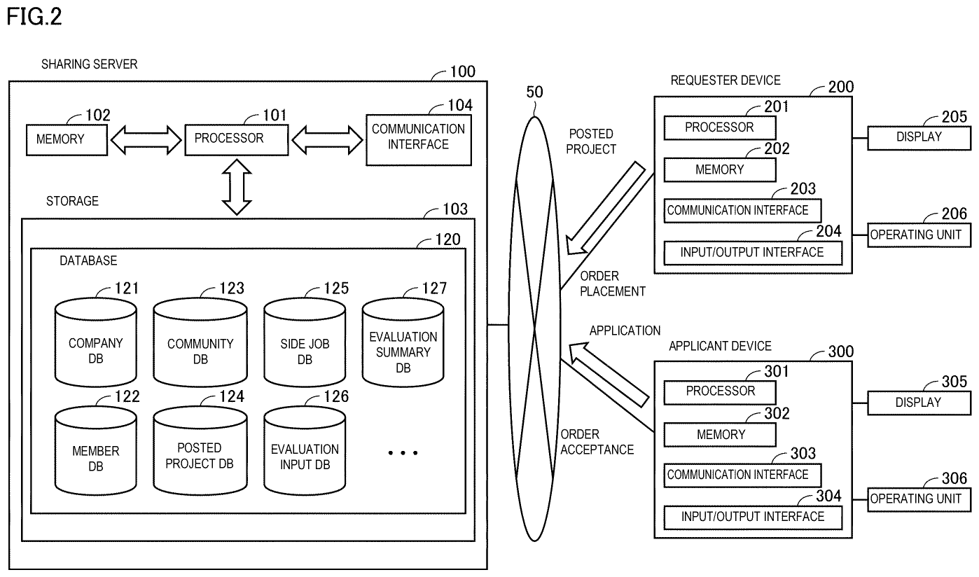

FIG. 2 is a block diagram illustrating configurations of the sharing server 100, the requester device 200, and the applicant device 300.

### [Configuration of Sharing Server 100]

The sharing server 100 includes a processor 101, a memory 102, a storage 103, and a communication interface 104.

The memory 102 includes a RAM (Random Access Memory), a ROM (Read Only Memory), a flash memory, or any other suitable memory system. The memory 102 stores a program necessary for arithmetic processing of the processor 101, temporary data calculated from the arithmetic processing, or the like.

The storage 103 includes a hard disk drive, a solid-state drive, and the like. The storage 103 stores the database 120. The database 120 includes a plurality of types of databases. The plurality of types of databases include a company database (company DB) 121, a member database (member DB) 122, a community database (community DB) 123, a posted project database (posted project DB) 124, a side job database (side job DB) 125, an evaluation input database (evaluation input) 126, an evaluation summary database (evaluation summary DB) 127, and many other databases.

Some of the plurality of types of databases may be stored in a storage that is provided separately from the sharing server 100. For example, some of the plurality of types of databases connected to a cloud service separate from the sharing server 100 and illustrated in FIG. 2 may be stored on that cloud. In this case, the sharing server 100 can access a necessary database by communicating with that cloud via the Internet 50.

The processor 101 connects to the Internet 50 via the communication interface 104, in accordance with the program stored in the memory 102. The processor 101 connects to the Internet 50 to communicate with the requester device 200 and the applicant device 300. The processor 101 accesses the database 120 and performs processing of extracting necessary data, processing of registering new data in the database 120, processing of updating data registered in the database 120, and the like.

### [Configuration of Requester Device 200]

The requester device 200 includes a processor 201, a memory 202, a communication interface 203, an input/output interface 204, a display 205, and an operating unit 206. The operating unit 206 includes a mouse and a keyboard, or the like.

The memory 202 includes a RAM (Random Access Memory), a ROM (Read Only Memory), a flash memory, or any other suitable memory system. The memory 202 stores a program necessary for arithmetic processing of the processor 201, temporary data calculated from the arithmetic processing, or the like.

The processor 201 connects to the Internet 50 via the communication interface 203, in accordance with the program stored in the memory 202. The processor 201 connects to the Internet 50 to communicate with the sharing server 100. The processor 201 communicates with the sharing server 100 and performs processing of transmitting a posted project, processing of displaying information on a member, who is an applicant, on the display 205, processing of ordering a task to a contractor selected from applicants, processing of transmitting, to the sharing server 100, contents of an evaluation, which is input by a requester, for a contractor, and the like.

Information input by operating the operating unit 206 is notified to the processor 201 via the input/output interface 204.

### [Configuration of Applicant Device 300]

The applicant device 300 includes a processor 301, a memory 302, a communication interface 303, an input/output interface 304, a display 305, and an operating unit 306. The operating unit 306 includes a mouse and a keyboard, or the like.

The memory 302 includes a RAM (Random Access Memory), a ROM (Read Only Memory), a flash memory, or any other suitable memory system. The memory 302 stores a program necessary for arithmetic processing of the processor 301, temporary data calculated from the arithmetic processing, or the like.

The processor 301 connects to the Internet 50 via the communication interface 303, in accordance with the program stored in the memory 302. The processor 301 connects to the Internet 50 to communicate with the sharing server 100. The processor 301 communicates with the sharing server 100 and performs processing of applying for a posted project, processing of displaying a notice of hiring or non-hiring of an applied project on the display 305, processing of transmitting, to the sharing server 100, performance of an accepted task, processing of transmitting, to the sharing server 100, contents of an evaluation, which is input by an applicant, for a requester, and the like.

Information input by operating the operating unit 306 is notified to the processor 301 via the input/output interface 304.

### [Overview of Database 120]

In the following, an overview of the database 120 will be described. Information on companies affiliated with the matching system 1 is registered in a company database 121. Information on users who utilize the matching system 1 is registered in a member database 122. Many of the members are employees of the companies affiliated with the matching system 1.

The members registered in the member database 122 can act as a requester (orderer) or an applicant (contractor) by utilizing the matching system 1. The members may also include individuals (freelancers) who do not belong to a company, in addition to the employees belonging to the companies registered in the company database 121.

Information for identifying companies belonging to a community is stored in a community database 123. A community is formed by agreement between companies. Therefore, it is possible to form a plurality of communities depending on how an agreement is reached between companies. It is also possible to set a number of companies that belong to one community in various ways. A relationship of mutual trust is formed between companies having a community relationship, to the extent defined by the manner of agreement when a community is formed. The information for identifying companies belonging to a community is registered in the community database 123, for each community.

Tasks (posted projects) for which contractors are solicited are registered in a posted project database 124. Employees of each company can be engaged in their main jobs in departments of companies to which they belong, while, as members of the matching system 1, the employees can accept orders for projects from other departments of their own companies or projects from other companies that are registered in the posted project database 124. In this case, the members accept the project from the other departments of their own companies or the projects from the other companies as a side job.

Data indicating side job statuses is registered for each of the members in a side job database 125. The data indicating side job statuses includes information on side job performance, planned side jobs, or the like.

Information on evaluations for applicants (contractors) and information on evaluations for requesters (orderers) are registered in an evaluation input database 126. By utilizing the matching system 1, requesters (orderers) can evaluate, as evaluators, work performance of applicants (contractors) who have completed tasks. By utilizing the matching system 1, the applicants (contractors) can evaluate, as evaluators, the requesters (orderers). Evaluations made by individual evaluators are registered in the evaluation input database 126.

Evaluation summaries are registered in an evaluation summary database 127. The evaluation summaries are registered for each member in the evaluation summary database 127. The evaluation summaries include a requester evaluation summary and an applicant evaluation summary. The requester evaluation summary indicates level of evaluation when the member behaves as a requester (orderer). The applicant evaluation summary indicates the level of evaluation when the member behaves as an applicant (contractor). The requester evaluation summary is created based on the evaluation for the requester from the applicant. The applicant evaluation summary is created based on the evaluation for the applicant from the requester.

Members can view the evaluation summaries. While viewing the applicant evaluation summary of each member, requesters can select a member considered to be suitable as a contractor. While viewing the requester evaluation summary of each member, applicants can apply for tasks of the requesters that are considered to be suitable.

### [Company Database 121]

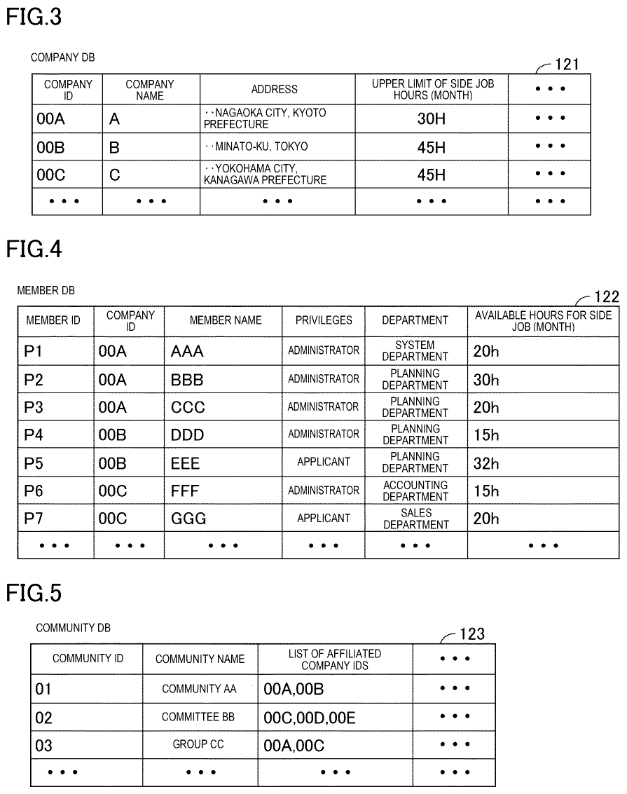

FIG. 3 is a diagram illustrating an example of the company database 121. In the company database 121, a company ID for identifying the company, a company name, a company address, and an upper limit of side job hours are registered for each company. The upper limit of side job hours is the upper limit of hours during which an employee is permitted to work in a project as a side job, separately from his/her main job. The upper limit of side job hours is defined for each company. For example, the upper limit of side job hours can be calculated using “prescribed overtime hours-overtime hours of a main job excluding a side job”. The prescribed overtime hours vary depending on the company. Note that FIG. 3 illustrates the upper limit of side job hours in months, but the upper time of side job hours may be in weeks. A unit of the upper limit of side job hours may also be defined for each company.

In the present embodiment, a member is permitted to apply for a task solicited by various companies and departments and accept the task, to an extent that does not exceed the upper limit of side job hours defined by the company to which that member belongs.

### [Member Database 122]

FIG. 4 is a diagram illustrating an example of the member database 122. Various types of member information are registered in the member database 122. The various types of member information include a member ID for identifying a member, an ID of a company to which a member belongs, a member name, member privileges, a department to which a member belongs, and the upper limit of side job hours.

Types of member privileges include an administrator privilege and an applicant privilege. Members with the administrator privilege are granted a privilege to utilize the matching system 1 as a requester and an applicant. Members with the applicant privilege are granted the privilege to utilize the matching system 1, but not the privilege to utilize the matching system 1 as a requester. Department heads within a company are granted the administrator privilege to manage side job statuses of subordinates within departments. Administrators with the administrator privilege are granted the privilege to approve applications from applicants who are their subordinates. Therefore, the administrators function as approvers.

Available hours for side job are remaining hours available for engagement in a side job. The available hours for side job are calculated using “the upper limit of side job hours−total side job hours”. If a target person is engaged in a plurality of side jobs, the total side job hours include hours that have already been spent on the plurality of side jobs. The total side job hours include expected hours for side job. The expected hours for side job are calculated using estimated man-hours registered in the posted project database 124. FIG. 4 illustrates the available hours for side job in months. For applicants who search for posted tasks utilizing the matching system 1, only tasks that can be completed within a range of the available hours for side job are provided, as projects for which they can apply.

### [Community Database 123]

FIG. 5 is a diagram illustrating an example of the community database 123. Information on communities formed between companies is registered in the community database 123. The information on communities includes a community ID for identifying a community, a community name, and a list of IDs of companies that belong to communities. Each company can form various communities by reaching an agreement with other companies. A company belonging to a community can change targeted companies belonging to the communities by reaching an agreement with other companies.

### [Posted Project Database 124]

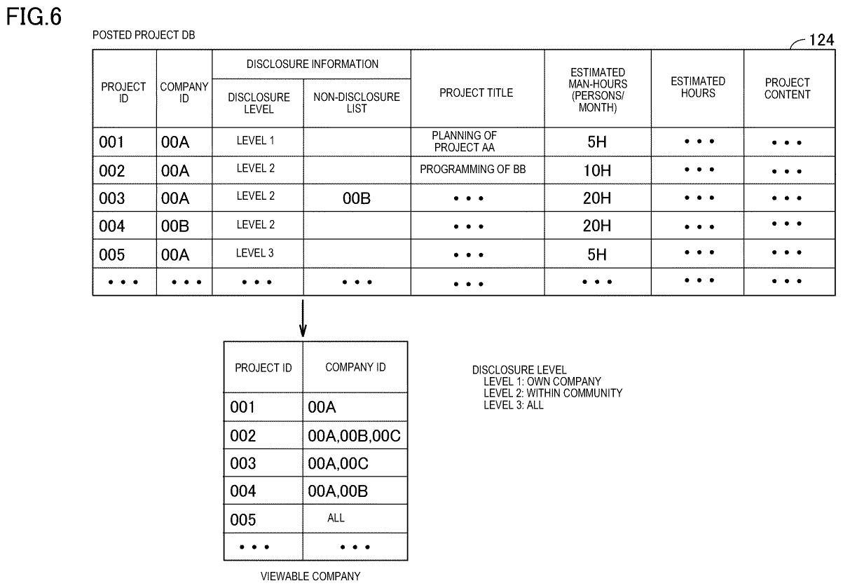

FIG. 6 is a diagram illustrating an example of the posted project database 124. Information on posted projects is registered in the posted project database 124. The information on posted projects includes a project ID for identifying a posted project, an ID of a company to which a requester who registered a posted project belongs, disclosure information, a project title, estimated man-hours, an estimated period, and project contents.

The “disclosure information” is used to limit a disclosure range of “posted projects”. The “disclosure information” is also used to limit the disclosure range of “educational content”. The matching system 1 separately stores the “disclosure information” that is applied to the “posted projects” and the “disclosure information” that is applied to the “educational content”. FIG. 6 illustrates an example in which the disclosure range of the posted projects is limited by the disclosure information that is applied to the posted projects.

As illustrated in FIG. 6, the “disclosure information” includes a “disclosure level” and a “list of non-disclosure company IDs”. The disclosure level is classified into Levels 1 to 3. Level 1 corresponds to disclosing posted projects only to own companies. Level 2 corresponds to disclosing posted projects only to communities. Level 3 corresponds to disclosing posted projects to all companies.

A “non-disclosure list” is used to further put a limitation on a range to be limited by the disclosure level. For example, if a company ID of Company X is set in the non-disclosure list, while setting the disclosure level to 3, the posted project will be disclosed to all companies except Company X.

Note that here, a description is given of the “disclosure information” that is applied to the “posted projects”, but the “disclosure information” that is applied to the “educational content” similarly includes the “disclosure level” and the “list of non-disclosure company IDs”. In the “disclosure information” that is applied to the “educational content”, Level 1 corresponds to disclosing educational content only to own companies. Level 2 corresponds to disclosing the educational content only to communities. Level 3 corresponds to disclosing the educational content to all companies. For example, if a company ID of Company X is set in the non-disclosure list, while setting the disclosure level to Level 3, the educational content will be disclosed to all companies except Company X.

To the lower side of the posted project database 124 in FIG. 6 are illustrated IDs of companies whose posted projects are viewable. For example, in a posted project corresponding to a project ID=001, the disclosure level is set to “Level 1 (Own Company)”. In this case, only members belonging to the company (company ID=00A) that registered the posted project can view the posted project corresponding to the project ID=001.

Hereinafter, the posted projects corresponding to respective project IDs may be referred to as Project 001, Project 002, Project 003, . . . using the project IDs. Similarly, the communities corresponding to respective community IDs may be referred to as Community 01, Community 02, Community 03, . . . using the community IDs, and the members corresponding to respective member IDs may be referred to as Member P1, Member P2, Member P3, . . . using the member IDs. In addition, hereinafter, the companies corresponding to respective company IDs may be referred to as Company A, Company B, Company C, . . . using some of the company IDs.

In Project 002, the disclosure level is set to “Level 2 (Within Community)”. According to the community database 123 illustrated in FIG. 5, companies having a community relationship with Company A, which registered Project 002, are Company B and Company C. Therefore, as illustrated in FIG. 6, only members belonging to any of Company A, Company B, and Company C can view Project 002.

The company that registered the posted project and the disclosure level of Project 003 are the same as those of Project 002. However, in Project 003, “00B” is registered in the list of non-disclosure company IDs. Therefore, as illustrated in FIG. 6, only members who belong to any of Company A and Company C can view Project 003, and members who belong to Company B are not granted the privilege to view Project 003.

For a posted project for which the disclosure level is set to “Level 3 (All)”, all members can view the target posted project. This is the case for Project 005 illustrated in FIG. 6. If one or more company IDs are registered in the list of non-disclosure company IDs of Project 005, members who belong to the companies with those company IDs are not granted the privilege to view Project 005.

The estimated man-hours and the estimated period are used by applicants and the matching system 1 to estimate time to process a posted project.

### [Side Job Database 125]

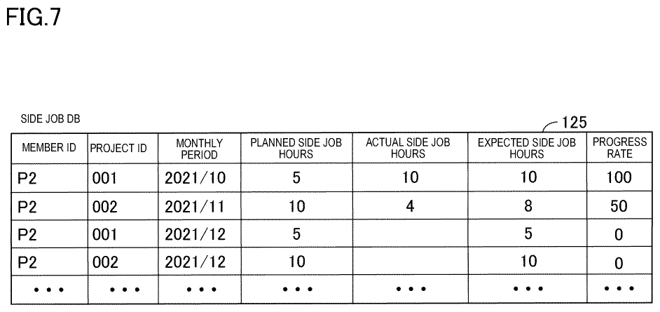

FIG. 7 is a diagram illustrating an example of the side job database 125. Information indicating side job statuses of the members is registered for each side job project in the side job database 125. The information indicating side job statuses includes an ID of a member engaged in a side job, a project ID, a monthly period (period of engagement in a side job), planned side job hours, actual side job hours, expected side job hours, and a progress rate.

The planned side job hours are hours considered necessary for the member to handle the project that he/she has accepted. Members who have accepted side jobs input monthly planned side job hours from their own applicant device 300. The input planned side job hours are reflected in the side job database 125. For example, the estimated man-hours for Project 001 are set to 5 hours/person/month in the posted project database 124. This means a workload is 5 hours per person per month. Usually, the members input the planned side job hours using the estimated man-hours for the posted project as a guide.

The actual side job hours are hours during which the member was actually engaged in the project that he/she has accepted. In other words, the actual side job hours are hours during which the member has already been engaged in actual work. Every time the member is engaged in the project, the member inputs hours during which he/she was engaged in the task of the project at any timing on his/her own applicant device 300, until the task of the project he/she has accepted is completed. The side job database 125 registers a cumulative value of the hours input on the applicant device 300 as the actual side job hours for each month.

The expected side job hours are hours expected to be necessary for the task of the target project. In other words, the expected side job hours are the time expected as the member's expected hours of labor in the future. The sharing server 100 automatically sets the expected side job hours, in consideration of the planned side job hours and the actual side job hours. The member may be able to/may be allowed to input the expected side job hours on his/her applicant device 300 at any timing, until the task of the target project is completed. In addition, the member may be once able to modify the expected side job hours that are automatically set. It is desirable that the expected side job hours be equal to or less than the planned side job hours. However, depending on the situation of the project, the expected side job hours may be longer than the planned side job hours. The member engaged in the project may be able to/may be allowed to update the expected side job hours at any timing until the task of the project is completed.

The progress rate indicates a degree of progress of a side job. The progress rate is input at the discretion of the person engaged in the side job. The progress rate is input, for example, between 0 (%) and 100 (%).

For example, when the member initially accepts an order for a certain project, the progress rate is 0%, the actual side job hours are 0 hours, and the planned side job hours and the expected side job hours match. As the member proceeds with the task of the project, the expected side job hours change in conjunction with input of the actual side job hours and the progress rate.

The side job database 125 illustrated in FIG. 7 illustrates data for the side jobs of Member P2 from October 2021 to December 2021. By referring to the side job database 125 illustrated in FIG. 7, it can be seen that Member P2 was engaged in Project 001 and Project 002 between October 2021 and December 2021.

As data for the period of October for Project 001, the planned side job hours=5, the actual side job hours=10, and the expected side job hours=10 are registered in the side job database 125. It can be seen from this that in October, Member P2 was engaged in Project 001 beyond the planned side job hours.

As data for the period of November for Project 002, the planned side job hours=10, the actual side job hours=4, and the expected side job hours=8 are registered in the side job database 125. It can be seen from this that in November, Member P2 was engaged in Project 002 without exceeding the set expected side job hours. Since the progress rate is 50, it can be seen that in November, Member P2 completed half of the entire task for Project 002.

As data for the period of December for Project 001, the planned side job hours=5 and the expected side job hours=5 are registered in the side job database 125, and no actual side job hours are registered. Similarly to the data for the period of December for Project 002, no actual side job hours are registered. This means that input of the actual side job hours by Member P2 is awaited.

The sharing server 100 calculates the member's spare capacity to take on additional side jobs, using the expected side job hours and the actual side job hours in the side job database 125. When the member is engaged in a plurality of side jobs, the sharing server 100 calculates “total expected side job hours”, which is a sum of the expected side job hours corresponding to the plurality of side jobs, and “total actual side job hours”, which is a sum of the actual side job hours corresponding to the plurality of side jobs. The sharing server 100 calculates the spare capacity for side jobs by calculating “the upper limit of side job hours−(the total expected side job hours+the total actual side job hours)”. Here, if “the total expected side job hours+the total actual side job hours” is defined as “the total side job hours”, the spare capacity for side jobs, that is, the “available hours for side job” will be calculated using “the upper limit of side job hours-total side job hours”. For example, in the side job database 125 illustrated in FIG. 7, the total expected side job hours, which is the sum of the expected side job hours of Member P2 for December, are 15 hours (5 hours+10 hours). In addition, the total actual side job hours of Member P2 for December is zero. At this time, if the “upper limit of side job hours” defined at the company to which Member P2 belongs is 30 hours, the Member P2's spare capacity for side job (the available hours for side job) is calculated as 15 hours (30 hours−15 hours).

Here, an example of a more specific procedure for calculating the expected side job hours will be described. For example, the “expected side job hours” may be calculated based on a calculation formula of “(man-hour progress rate/progress rate)×planned side job hours−actual side job hours”. Here, the “man-hour progress rate” is calculated by the “actual side job hours/planned side job hours”. As already described, the “progress rate” is a rate that is input into the side job database 125 at the discretion of the person engaged in the side job.

For example, when the planned side job hours=10 hours and the actual side job hours=2 hours, the man-hour progress rate is calculated to be 20%. Here, the progress rate is assumed to be 40%. At this time, the expected side job hours is calculated to be “(208/40%)×10 hours-2 hours”=3 hours. That is, according to this calculation result, the expected side job hours for the target side job is 3 hours.

### [Evaluation Input Database 126]

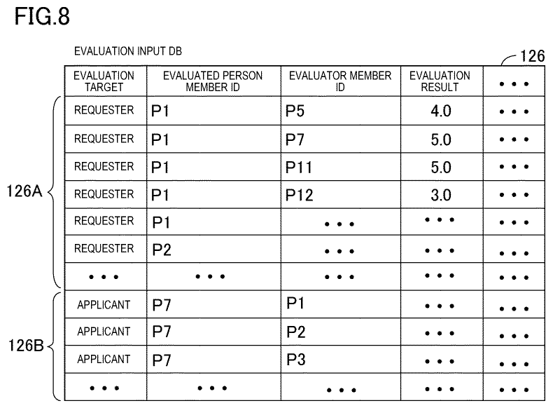

FIG. 8 is a diagram illustrating an example of the evaluation input database 126. Information on evaluations on evaluated persons is registered in the evaluation input database 126. The information on evaluations includes an evaluation target, a member ID of an evaluated person, a member ID of an evaluator, and an evaluation result.

The evaluation input database 126 includes a requester evaluation unit 126A and an applicant evaluation unit 126B. Information on evaluations for requesters (orderers) is registered in the requester evaluation unit 126A. Information on evaluations for applicants (contractors) is registered in the applicant evaluation unit 126B.

In the requester evaluation unit 126A, the requester (orderer) corresponds to an evaluation target (evaluated person), and an applicant who applied for a solicited task of the party to be evaluated and accepted an order for the task corresponds to an evaluator. An evaluation for the evaluated person is registered for each evaluated person in the requester evaluation unit 126A. FIG. 8 illustrates an example in which Members P1 and P2, who correspond to evaluated persons, are evaluated by evaluator members. In particular, FIG. 8 illustrates an example in which Member P1 is evaluated by each of Evaluator Members P5, P7, P11, and P12. Evaluation results (evaluation values) are expressed by a numerical value with 10 being the maximum value and 0 being the minimum value.

In the applicant evaluation unit 126B, the applicant (contractor) for the posted project corresponds to the evaluation target (evaluated person), and the requester (orderer) of that project corresponds to the evaluator. An evaluation for the evaluated person is registered for each evaluated person in the applicant evaluation unit 126B. FIG. 8 illustrates an example in which Member P7, who corresponds to the evaluated person, is evaluated by each of Members P1, P2, and P3, who correspond to the evaluators. Note that in FIG. 8, an example of evaluation results in the applicant evaluation unit 126B is omitted, but various evaluation results are registered therein, similarly to the requester evaluation unit 126A.

The applicant (contractor), when the task that he/she accepted from the requester (orderer) is completed, evaluates the evaluated person who is the requester, as the evaluator, using the applicant device 300. The result of evaluator's evaluation is registered in the evaluation input database 126. When an applicant accepts an order for another task again from a requester from whom the applicant has previously accepted a task, the applicant evaluates the requester again. In this case, an average value of the previous evaluation result and the subsequent evaluation result is registered in the evaluation input database 126.

When the applicant (contractor) completes the task requested by the requester (orderer), the requester (orderer) evaluates the evaluated person who is the applicant (contractor), as the evaluator, using the requester device 200. The result of evaluator's evaluation is registered in the evaluation input database 126. When a requester places an order for another task again to an applicant whom the requester has previously requested to undertake a task, the requester evaluates the applicant again. In this case, an average value of the previous evaluation result and the subsequent evaluation result is registered in the evaluation input database 126.

Therefore, the average values of evaluations for the evaluated persons by respective evaluators are reflected in the evaluation results registered in the evaluation input database 126. Note that instead of the average values, a weighted average value calculated according to the number of evaluations, a deviation value, or the like, may be adopted. The evaluation input database 126 may further register evaluation results for each project ID.

### [Evaluation Summary Database 127]

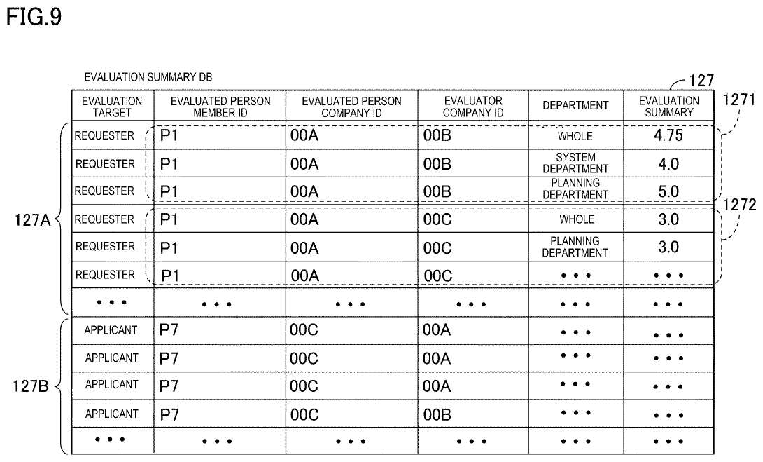

FIG. 9 is a diagram illustrating an example of the evaluation summary database 127. Information on evaluations of evaluated persons by department is registered in the evaluation summary database 127. The information on evaluations by department includes an evaluation target, a member ID of an evaluated person, an ID of a company to which an evaluated person belongs, an ID of a company to which an evaluator belongs, a department to which an evaluator belongs, and an evaluation summary.

The evaluation summary database 127 includes a requester evaluation summary unit 127A and an applicant evaluation summary unit 127B. In the requester evaluation summary unit 127A, the requester (orderer) corresponds to the evaluation target (evaluated person). In the applicant evaluation summary unit 127B, the applicant (contractor) corresponds to the evaluation target (evaluated person). Evaluation summaries for the evaluation targets are registered by department in the evaluation summary database 127.

An evaluation summary is calculated based on aggregate results of the evaluation input database 126. Department categories include each department such as “System Department” or “Planning Department” that belong to a company, and “Whole” meaning a company as a whole. The evaluation summary is calculated for each of such “departments”.

FIG. 9 illustrates an example in which Member P1 corresponds to an evaluated person as the requester evaluation summary unit 127A. The company ID of the evaluated person is “00A”. Therefore, Member P1 belongs to Company A. In FIG. 9, a data group 1271 represents Company B's evaluation for Member P1 who behaves as the requester, and a data group 1272 represents Company C's evaluation for Member P1 who behaves as the requester.

With reference to the data group 1271, it can be seen that the Company B's evaluation is classified into an evaluation as the company as a whole, an evaluation of System Department within Company B, and an evaluation of Planning Department within Company B. An average value corresponding to each of the classified categories is registered in the evaluation summary.

For example, as the evaluation summary corresponding to Company B as a whole, an average value of evaluation results of Company B's members who evaluated Member P1 who behaves as the requester is registered. In FIG. 9, that value is “4.75”. As the evaluation summary corresponding to System Department, an average value of the evaluation results of the members of System Department, among the members of Company B who evaluated Member P1 who behaves as the requester, is registered. In FIG. 9, that value is “4.0”. As the evaluation summary corresponding to Planning Department, an average value of the evaluation results of the members of Planning Department, among the members of Company B who evaluated Member P1 who behaves as the requester, is registered. In FIG. 9, that value is “5.0”.

Also, for the data group 1272, similarly to the data group 1271, Company C's evaluation is classified into an evaluation as the company as a whole and an evaluation of each department within Company C. The data groups 1271 and 1272 are data having the requester as the evaluation target. Therefore, the evaluation summaries registered in the data groups 1271 and 1272 are the requester evaluation summaries.

The requester evaluation summary unit 127A has been described above in detail. Next, the applicant evaluation summary unit 127B will be described. FIG. 9 illustrates an example in which Member P7 corresponds to an evaluated person as the applicant evaluation summary unit 127B. The company ID of the evaluated person is “00C”. Therefore, Member P7 belongs to Company C. In the applicant evaluation summary unit 127B, evaluation by each department for Member P7 who behaves as the applicant is registered.

The applicant evaluation summary unit 127B has a similar configuration to the requester evaluation summary unit 127A, except that the evaluation target is the “applicant” and not the “requester”. Therefore, here, the description of the requester evaluation summary unit 127A already given will replace the description of the applicant evaluation summary unit 127B.

The sharing server 100 identifies the evaluation result of each member, using the evaluation input database 126, and identifies affiliation of each member, using the member database 122. The sharing server 100 updates the data in the evaluation summary database 127, based on these identification results.

Note that in FIG. 9, only Members P1 and P7 are illustrated as the evaluated persons, but other Members P2 to P6, Member P8, and Member P9, . . . are similarly registered as the evaluated persons in the evaluation summary database 127. The evaluation summary database 127 may include data in which a same member is the evaluation target as a requester and an applicant. For example, in the evaluation summary database 127 illustrated in FIG. 9, the applicant evaluation summary regarding Member P1 may be registered, in addition to the requester evaluation summary regarding Member P1.

### [Functions of Sharing Server, Requester Device, and Applicant Device]

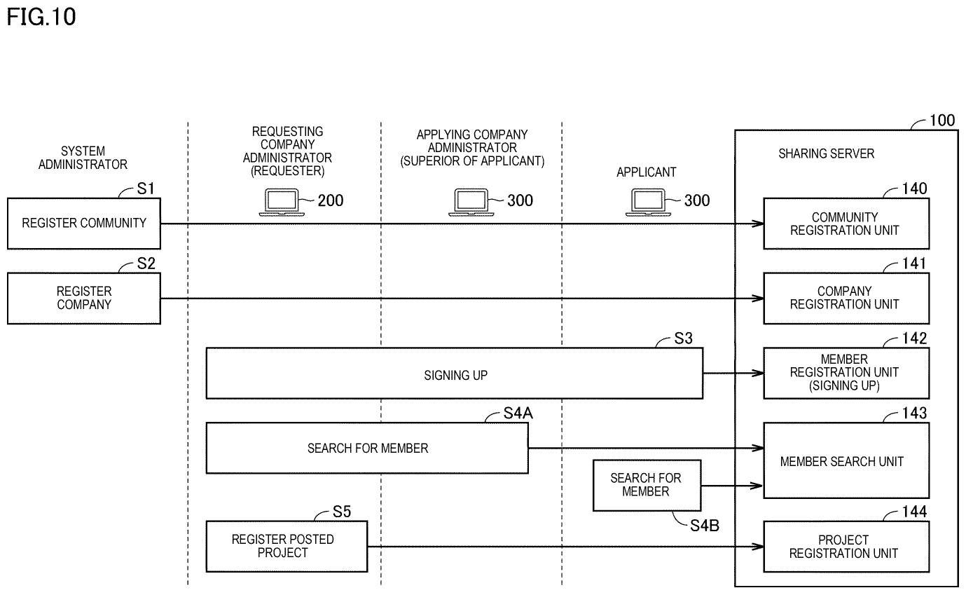

FIG. 10 to FIG. 12 are diagrams for describing functions of the sharing server, the applicant device, and the requester device.

As illustrated in FIG. 10, the sharing server 100 functionally includes a community registration unit 140, a company registration unit 141, a member registration unit 142, a member search unit 143, and a project registration unit 144. These various types of functions are realized by the processor 101, the memory 102, the storage 103, and the communication interface 104 that the sharing server 100 includes.

The community registration unit 140 includes a function to register a community in the community database 123. A system administrator who manages the matching system 1 uses an operating unit, such as a keyboard (not illustrated), or the like, to input information regarding the community into the sharing server 100.

The information regarding the community includes a community name, and information on the companies belonging to the community. The community registration unit 140 registers communities in the community database 123, according to input by the system administrator (Step S1). The community registration unit 140 further includes a function to update the information on the communities registered in the community database 123.

The company registration unit 141 includes a function to register a new company affiliated with the matching system 1. The system administrator inputs the information regarding the company into the sharing server 100, using the operating unit such as the keyboard, or the like.

The information regarding the company includes a company name, an address, the upper limit of side job hours, or the like. The company registration unit 141 sets the company in the company database 121, according to input by the system administrator (step S2). The company registration unit 141 further includes a function to update the company information that has been already registered.

The member registration unit 142 includes a function to register (sign up) a new member who joins the matching system 1. The member registration unit 142 issues a member ID and a password in response to a request from those who belong to the company affiliated with the matching system 1. Those who wish to become a member perform sign up processing, using a personal computer, or the like (step S3).

Specifically, a person who wishes to become a member inputs information such as his/her name, a company to which he/she belongs, a department to which he/she belongs, or the like, in a personal computer, or the like, and transmits the input information to the sharing server 100. The member registration unit 142 registers the input information in the member database 122. A new member can sign in to the sharing server 100 using the personal computer used for member registration. In this case, the personal computer functions as the requester device 200 or the applicant device 300.

FIG. 10 illustrates two applicant devices 300. One is a device that is assumed to be operated by an administrator of the applying company. The other is a device that is assumed to be operated by someone in the applying company other than the administrator. The administrator of the applying company is engaged in management posts such as a department head, or the like, and corresponds to the superior of the applicant who is his/her subordinate. In the present embodiment, the administrator of the applying company assumes a role as an approver who approves application by the subordinate for a posted project.

The member search unit 143 includes a function to search for members of the matching system 1. In response to requests from the requester device 200 and the applicant device 300, the member search unit 143 provides the requester device 200 and the applicant device 300 with the member information registered in the member database 122.

When receiving an operation to search for a requester, the requester device 200 performs member search processing (step S4A). This enables the requester to view, for example, information on applicants. The requester can select an applicant to accept a task from among a plurality of applicants, considering information on the applicants. Similarly, when receiving an operation to search for a supervisor who corresponds to a superior of a certain applicant, the applicant device 300 performs the member search processing (step S4A).

Furthermore, when receiving an operation to search for an applicant, the applicant device 300 performs the member search processing (Step S4B). This enables the applicant to view, for example, information on the requester. The applicant can select a task for which he/she accepts an order, from a plurality of posted tasks, considering information on requesters.

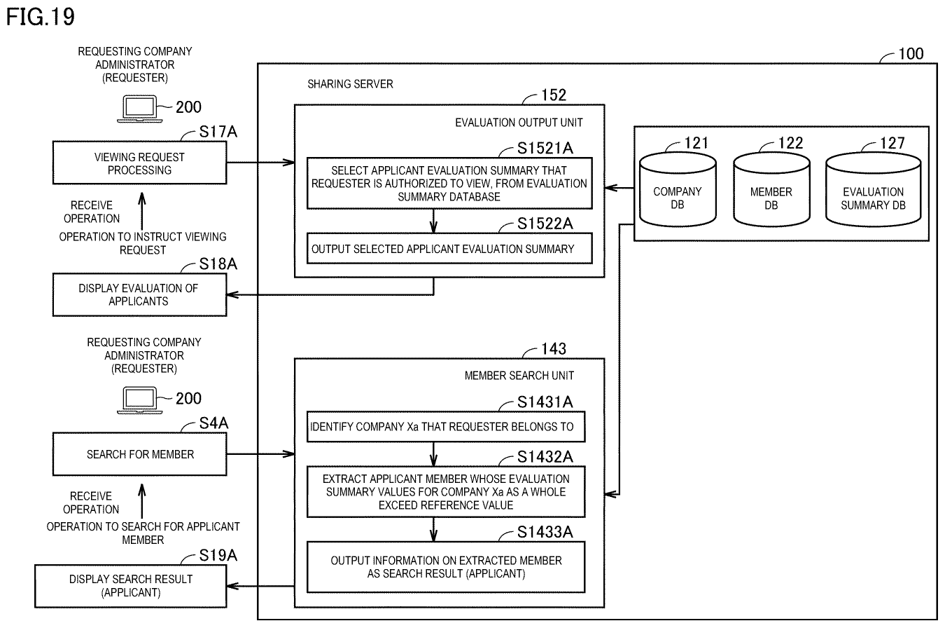

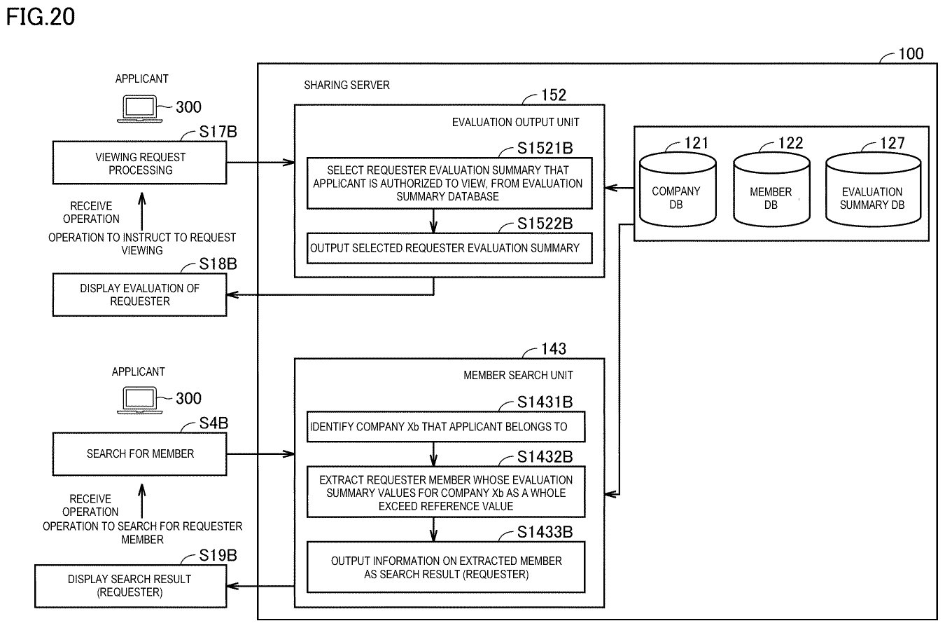

The member search processing (step S4A) performed by the requester device 200 and the processing by the member search unit 143 will be described later in detail with reference to FIG. 19. The member search processing (step S4B) performed by the applicant device 300 and the processing by the member search unit 143 will be described later in detail with reference to FIG. 20.

The project registration unit 144 includes a function to register posted projects in the posted project database 124. When receiving an operation to input a posted project, the requester device 200 performs processing of registering the posted project (step S5). In the processing of registering a posted project, the requester device 200 transmits information on the posted project to the sharing server 100. The project registration unit 144 registers the received information on the posted project in the posted project database 124.

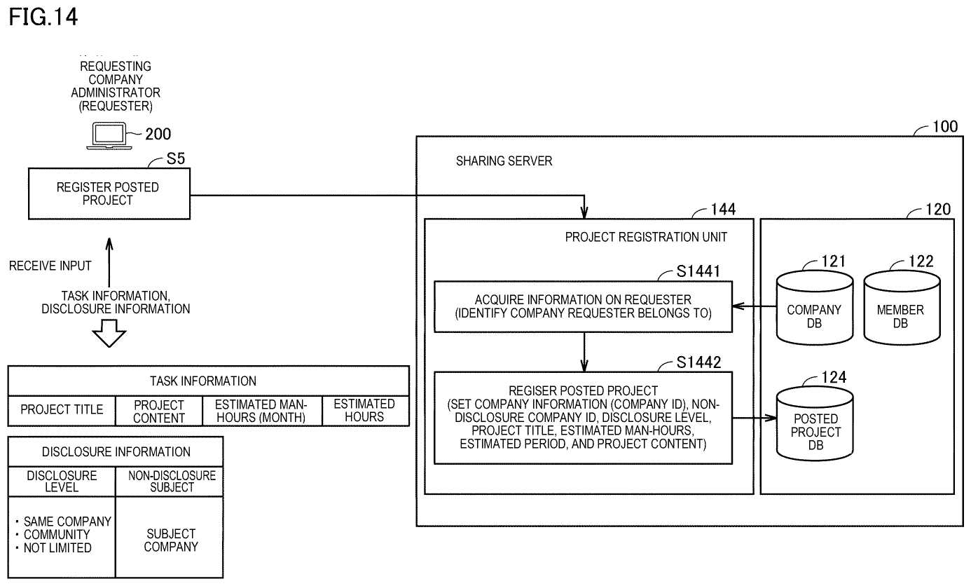

The posted project registration processing (step S5) performed by the requester device 200 and the processing by the project registration unit 144 will be described later in detail with reference to FIG. 14.

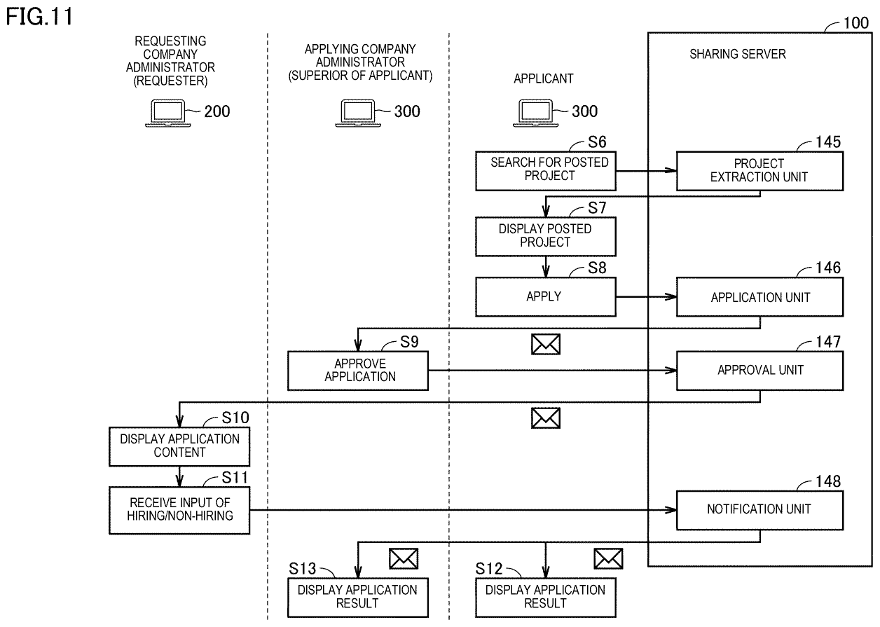

As illustrated in FIG. 11, the sharing server 100 functionally includes a project extraction unit 145, a submission unit 146, an approval unit 147, and a notification unit 148. These various types of functions are realized by the processor 101, the memory 102, the storage 103, and the communication interface 104 that the sharing server 100 includes.

The project extraction unit 145 includes a function to extract a posted project that can be viewed by the applicants. The submission unit 146 includes a function to submit an application by an applicant to a supervisor (the superior of the applicant). The approval unit 147 includes a function to transmit contents of the application for the posted project to the requester, on the condition that an approval for the application has been received from the supervisor (approver). The notification unit 148 has a function to receive, from the requester, a result of whether or not to hire the applicant, and to notify the applicant and the supervisor of the result.

The submission unit 146, the approval unit 147, and the notification unit 148 realize notification to the supervisor asking for approval, notification of an applicant to a requester, and notification of an application result to an applicant through a workflow system.

When receiving an applicant's operation requesting a search for posted projects, the applicant device 300 performs processing of searching for posted projects (step S6). In the processing of searching for posted projects, the applicant device 300 transmits a search request to the project extraction unit 145 of the sharing server 100.

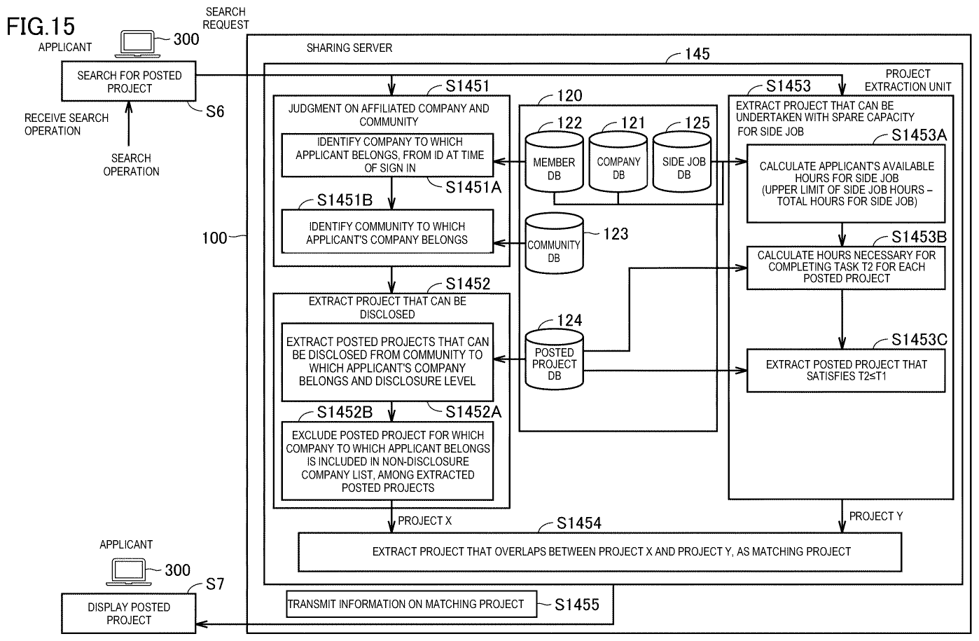

When receiving the search request, the project extraction unit 145 extracts a project allowed to be viewed by the applicant, from among the posted projects registered in the posted project database 124, and transmits the extracted project to the applicant device 300. The project extraction unit 145 judges that the project is allowed to be viewed by the applicant, based on a first criterion and a second criterion. The first criterion is a disclosure range set for posted projects. The second criterion is an applicant's spare capacity for a side job. The disclosure range is defined by disclosure information illustrated in FIG. 14. The spare capacity for a side job is calculated as the available hours for side job illustrated in FIG. 15.

The project extraction unit 145 determines a project that satisfies both the first and second criteria, as the project allowed to be viewed by the applicant. Therefore, the project extraction unit 145 extracts a project that is permitted to be disclosed to the applicant who received the search request, from among the posted projects registered in the posted project database 124. Furthermore, the project extraction unit 145 extracts a project that can be handled within the available hours for side job of the applicant who received the search request, from among the posted projects registered in the posted project database 124. The project extraction unit 145 transmits the project allowed to be viewed by the applicant to the applicant device 300.

The project extraction unit 145 may receive an operation to set a criterion for extracting projects. For example, a function may be added to the sharing server 100 that allows the system administrator to select any of first setting to enable only the first criterion, second setting to enable only the second criterion, and third setting to enable both the first and second criteria.

The applicant device 300 receives posted projects from the project extraction unit 145. The applicant device 300 displays the received posted projects on the display 305 (step S7).

Note that the posted project search processing (step S6), the processing of displaying a posted project (step S7), and the processing of the project extraction unit 145 will be described later in detail with reference to FIG. 15.

At the applicant device 300, the applicant performs an operation to select an application target from the posted projects displayed on the display 305. The applicant device 300 performs application processing in response to operations by the applicant (step S8). In the application processing, the applicant device 300 transmits application information listing projects to be applied for to the submission unit 146 of the sharing server 100. As a result, a request to accept an order for the task is transmitted from the applicant device 300 to the submission unit 146.

The submission unit 146 transmits the application information received from the applicant device 30 to the applicant device 300 of the supervisor (superior of the applicant). The submission unit 146 identifies a member ID of the superior, who is the supervisor of the applicant, for example, based on a relationship between the applicant's member ID and the superior's member ID that are registered in the member database 122. The submission unit 146 transmits the subordinate's application information to the applicant device 300 corresponding to the identified superior's member ID. The supervisor checks the task for which his/her subordinate is applying, on his own applicant device 300. The supervisor performs an operation to approve the application on the applicant device 300. The applicant device 300 receives an approval operation, and performs processing of approving the application (step S9). In the processing of approving the application, the applicant device 300 transmits approval information to the approval unit 147 of the sharing server 100. As a result, the approval information, which is an example of an approval notice, is transmitted from the applicant device 300 of the supervisor (approver) to the approval unit 147.

The approval unit 147 receives the applicant's application on the condition that the approval information has been received from the applicant device 300. As such, in the present embodiment, the applicant's application is received on the condition that approval has been given by the supervisor to whom the applicant belongs. Therefore, the supervisor can check in advance contents of the posted task for which his/her subordinate plans to apply. Consequently, it is possible to prevent confidential information from being leaked outside the company through employees' side job actions.

Note that FIG. 11 illustrates a flow when the supervisor approves the application. If an operation to reject the application is received in step S9, rejection information is transmitted from the applicant device 300 of the supervisor to the approval unit 147. When receiving the rejection information, the approval unit 147 may notify the applicant device 300 of the applicant that the application has been rejected.

The approval unit 147 that has received the applicant's application transmits the application information to the requester device 200. The application information includes information on the applicant and contents of the task to be applied for. The requester device 200 displays contents of the application on the display 205 (step S10). The requester checks the applicant and the task for which the applicant has applied based on the display on the display 205, and determines whether or not to hire the applicant.

The requester inputs the result of the determination on hiring or non-hiring into the requester device 200. The requester device 200 receives the input result (step S11). The requester device 200 transmits the received result of hiring or non-hiring to the notification unit 148 of the sharing server 100.

When receiving the result of hiring or non-hiring from the requester device 200, the notification unit 148 transmits the application result (result of hiring or non-hiring) to the applicant device 300 of the applicant and the applicant device 300 of the supervisor.

The applicant device 300 of the applicant and the applicant device 300 of the supervisor display the application result on the display 305 (step S12 and step S13). The applicant and the supervisor confirm the application result by looking at the display on the display 305.

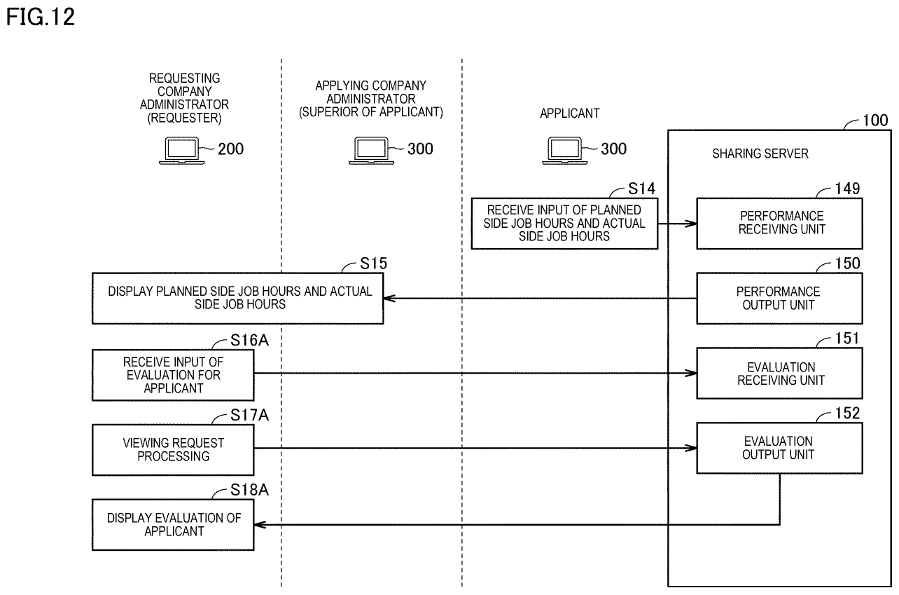

As illustrated in FIG. 12, the sharing server 100 functionally includes a performance receiving unit 149, a performance output unit 150, an evaluation receiving unit 151, and an evaluation output unit 152. These various types of functions are realized by the processor 101, the memory 102, the storage 103, and the communication interface 104 that the sharing server 100 includes.

The performance receiving unit 149 includes a function to receive planned side job hours and actual side job hours input by the applicant on the applicant device 300. The performance output unit 150 includes a function to output information including the applicant's planned side job hours and actual side job hours to the requester device 200 or the supervisor's applicant device 300.

The evaluation receiving unit 151 includes a function to receive the evaluation for the applicant (contractor) that is input by the requester on the requester device 200. The evaluation output unit 152 includes a function to output information indicating the evaluation for the applicant to the requester device 200.

When being engaged in a side job, the applicant inputs the planned side job hours and the actual side job hours in the applicant device 300. When accepting an order for a new side job, the applicant usually inputs the planned side job hours into the applicant device 300, and inputs the actual side job hours into the applicant device 300 at any timing while being engaged in the side job. For example, when accepting an order for a task that is estimated to span a plurality of months, as a side job, the applicant inputs the actual side job hours for each month into the applicant device 300.

The applicant device 300 receives input of the planned side job hours and the actual side job hours (step S14). The applicant device 300 transmits the received planned side job hours and actual side job hours to the performance receiving unit 149 of the sharing server 100.

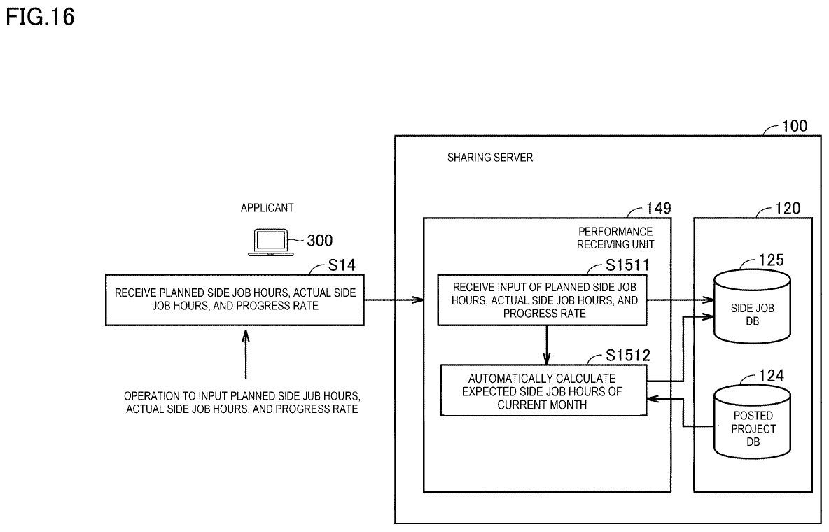

The performance receiving unit 149 registers the received planned side job hours and actual side job hours in the side job database 125. The processing of step S14 performed by the applicant device 300 and the processing of the performance receiving unit 149 will be described later in detail with reference to FIG. 16.

The performance output unit 150 transmits the planned side job hours and the actual side job hours registered in the side job database 125 to the requester device 200 and the supervisor's applicant device 300. The requester device 200 displays the received planned side job hours and actual side job hours on the display 205, and the supervisor's applicant device 300 displays information including the received planned side job hours and actual side job hours on the display 305 (step S15). However, when the information transmitted to the requester device 200 and the information transmitted to the supervisor's applicant device 300 are compared, the projects to be transmitted are different.

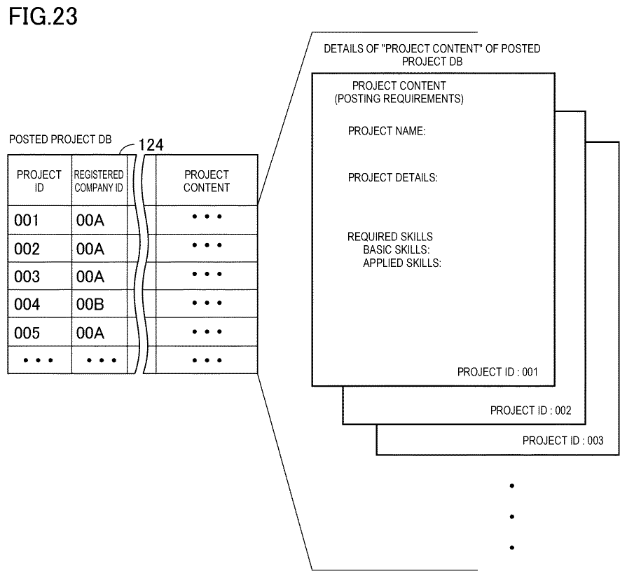

Data corresponding to the project of which the subordinate is in charge, among the many projects registered in the side job database 125, is transmitted from the performance receiving unit 149 to the supervisor's applicant device 300. The supervisor can check the subordinate's side job status by looking at the display 305. Note that the screen to be displayed on the supervisor's applicant device 300 when the supervisor checks the subordinate's side job status will be described later with reference to FIG. 23.

Data corresponding to the project solicited by the requester among the many projects registered in the side job database 125 is transmitted from the performance receiving unit 149 to the requester device 200. For example, in the side job database 125 illustrated in FIG. 7, consider a case in which, among a plurality of requesters, a first requester solicits Project 001 and a second requester solicits Project 002.

In this case, various types of data corresponding to Project 001 in the side job database 125 are transmitted from the performance receiving unit 149 to the requester device 200 operated by the first requester. Various types of data corresponding to Project 002 in the side job database 125 are transmitted from the performance receiving unit 149 to the requester device 200 operated by the second requester.

The first requester and the second requester can check how his/her own project progresses by viewing the planned side job hours, the actual side job hours, and the like, displayed on the display 305 of the requester device 200.

When the side job is completed, the requester inputs an evaluation for the applicant in the requester device 200. The requester device 200 receives input of the evaluation for the applicant (step S16A). Therefore, when receiving the input evaluation, the requester device 200 functions as the evaluator device operated by the evaluator (requester).

The requester device 200 transmits the received evaluation to the evaluation receiving unit 151 of the sharing server 100. The evaluation receiving unit 151 updates the evaluation input database 126 and the evaluation summary database 127 based on the received evaluation. As a result, the information in the applicant evaluation unit 126B is updated in the evaluation input database 126, and the information in the applicant evaluation summary unit 127B is updated in the evaluation summary database 127.

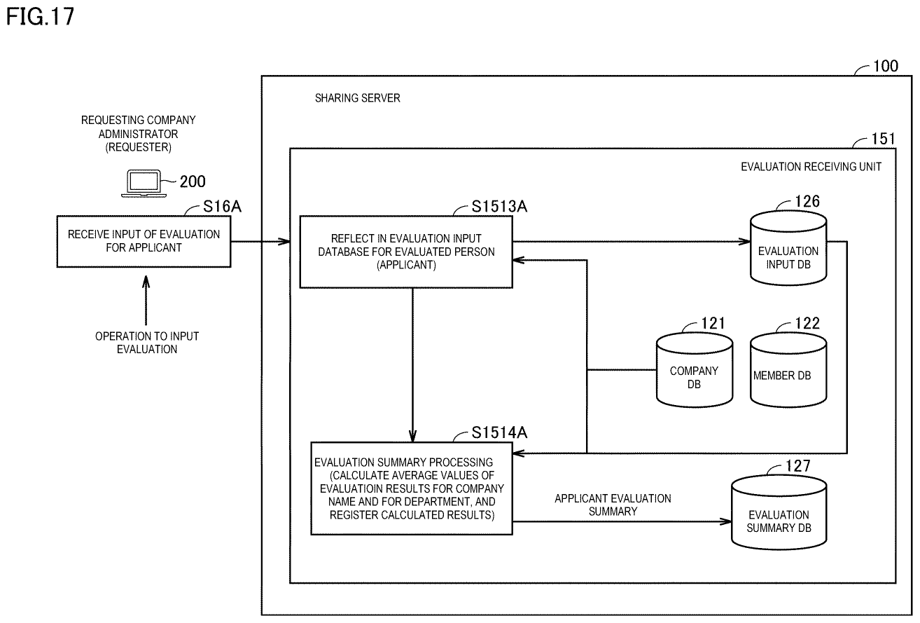

The processing of step S16A performed by the requester device 200 and the processing of the evaluation receiving unit 151 will be described later in detail with reference to FIG. 17.

When receiving an operation for the requester to view the applicant's evaluation, the requester device 200 performs viewing request processing (step S17A). In the viewing request processing, the requester device 200 transmits a viewing request to the evaluation output unit 152 of the sharing server 100. In response to the viewing request, the evaluation output unit 152 transmits the evaluation for applicant (applicant evaluation summary) registered in the evaluation summary database 127 to the requester device 200. The requester device 200 displays the evaluation for applicant on the display 205 (step S18A).

The processing of step S17A and step S18A performed by the requester device 200 and the processing of the evaluation output unit 152 will be described later in detail with reference to FIG. 19.

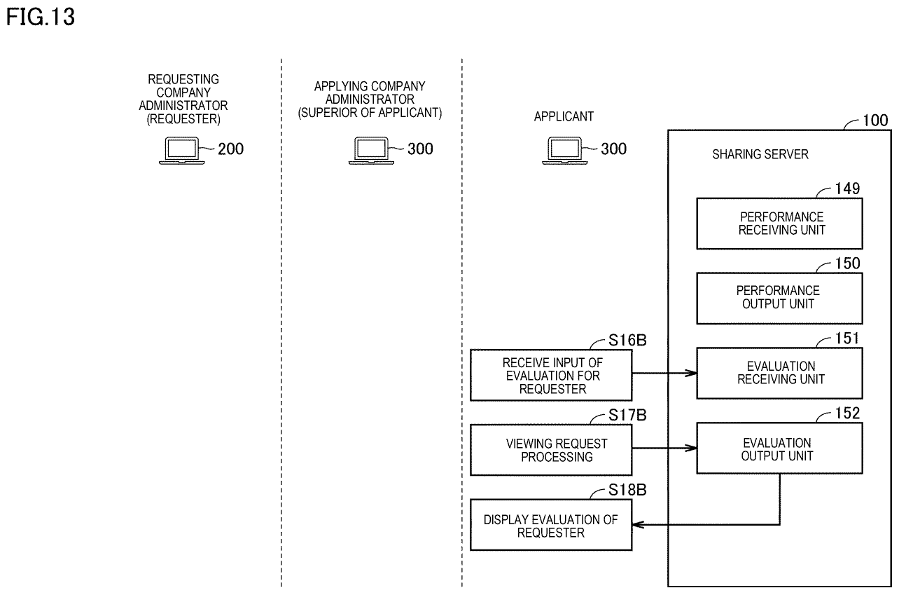

FIG. 13 is a diagram for further explaining the function of the applicant device 300. Here, input and output of the evaluation for the requester will be described with reference to FIG. 13. The evaluation receiving unit 151 further includes a function to receive the evaluation for the requester that is input by the applicant on the applicant device 300. The evaluation output unit 152 further includes a function to output information indicating the evaluation for the requester to the applicant device 300. When completing the task for which the applicant received an order, the applicant inputs the evaluation for the requester into the applicant device 300. There are various points in which the applicant evaluates the requester.

For example, when the applicant could communicate smoothly with the requester and complete the task within an appropriate period of time, the applicant would highly evaluate the requester. Conversely, if there are a number of requests for additions, changes, and modifications to the task contents, when too many man-hours are spent outside the scope of the task, when instructions are communicated too late, and instructions on modification of the task contents are given unilaterally without prior consultation, the applicant would poorly evaluate the requester.

The applicant device 300 receives input of the evaluation for the requester (step S16B). Therefore, when receiving the input evaluation, the applicant device 300 functions as an evaluator device operated by the evaluator (applicant).

The applicant device 300 transmits the received evaluation to the evaluation receiving unit 151 of the sharing server 100. The evaluation receiving unit 151 updates the evaluation input database 126 and the evaluation summary database 127 based on the received evaluation. As a result, the information in the requester evaluation unit 126A is updated in the evaluation input database 126, and the information in the requester evaluation summary unit 127A is updated in the evaluation summary database 127.

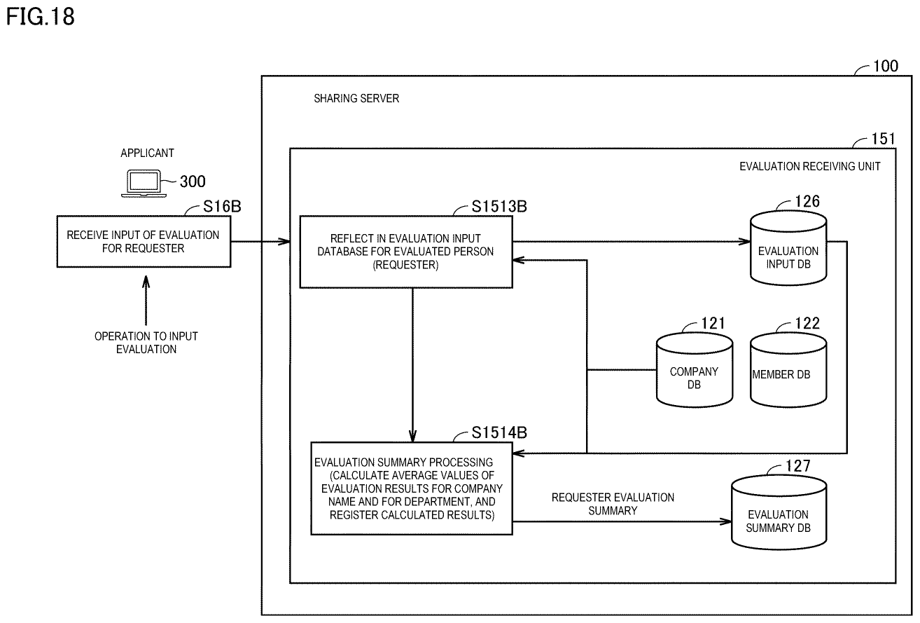

The processing of step S16B performed by the applicant device 300 and the processing of the evaluation receiving unit 151 will be described later in detail with reference to FIG. 18.

When receiving an operation for the applicant to view the evaluation for the requester, the applicant device 300 performs the viewing request processing (step S17B). In the viewing request processing, the requester device 200 transmits a viewing request to the evaluation output unit 152 of the sharing server 100. In response to the viewing request, the evaluation output unit 152 transmits the evaluation for the requester (requester evaluation summary) registered in the evaluation summary database 127 to the applicant device 300. The applicant device 300 displays the received evaluation for the requester on the display 305 (step S18B).

The step S17B performed by the applicant device 300, the processing of step S18B, and the processing of the evaluation output unit 152 will be described later in detail with reference to FIG. 20.

### [Details of Processing of Project Registration Unit 144 and Requester Device 200]

FIG. 14 is a diagram for explaining a procedure for registering a posted project in the posted project database 124. The step S5 of FIG. 10 and the function of the project registration unit 144 will be described in more detail with reference to FIG. 14.

The requester who registers a posted project first signs in to the sharing server 100, using the requester device 200. This establishes a logical communication path identified by the requester's member ID between the requester device 200 and the sharing server 100. Then, the requester inputs task information and disclosure information of the posted project into the requester device 200, using the operating unit 206 such as a mouse and a keyboard, or the like.

The information input by the operating unit 206 is notified to the processor 201 via the input/output interface 204 of the requester device 200. The operating unit 206 and the input/output interface 204 constitute an interface that receives an operation to input task contents, and an operation to input the disclosure information that specifies a target to which the task is disclosed.

The task information for the posted project includes a project title, project contents, estimated man-hours (person/month), and an estimated period. The disclosure information may include a disclosure level. The disclosure information may include an ID of a company which is a non-disclosure target, depending on a requester's selection.

The requester device 200 receives input of the task information and the disclosure information of the posted project, and performs processing of registering the posted project (step S5). In the processing of registering the posted project, the requester device 200 transmits the task information and the disclosure information of the posted project to the sharing server 100.

The project registration unit 144 of the sharing server 100 acquires information on the requester (step S1441). Specifically, the project registration unit 144 specifies the company to which the requester belongs.

When a member signs in the sharing server 100 using the requester device 200 or the applicant device 300, the sharing server 100 stores the member ID used in the sign-in. When the sharing server 100 receives any information from the requester device 200 or the applicant device 300 in communication established by this member ID, the sharing server 100 identifies the member who is the source of the information using the member ID used in the sign-in.

Therefore, when receiving the task information and the disclosure information of the posted task from the requester device 200, the project registration unit 144 uses the member ID used in the sign-in to identify the requester who operates the requester device 200. The project registration unit 144 uses the identified member ID, the member database 122, and the company database 121 to identify the member, who is the requester, and the company to which the requester belongs.

Next, the project registration unit 144 performs processing to register the posted project in the posted project database 124 (step S1442). Specifically, after generating a project ID, the project registration unit 144 registers company information (company ID), an ID of a company not to be disclosed, a disclosure level, a project title, estimated man-hours, an estimated period, project contents, and the like, in the posted project database 124 in association with the generated project ID.

According to the present embodiment, the requester can freely control the disclosure range of the posted project at the level of “Within Own Company”, “Within Community”, and “Not Limited”. Consequently, it is possible to prevent a posted project from being disclosed to a specific company without the requester's intention.

According to the present embodiment, a company not to be disclosed can be set separately from the disclosure level. For this reason, the requester can set the disclosure range by excluding some companies among a plurality of companies having a community relationship with the company to which the requester belongs. Consequently, it is possible to prevent a task related to a specific company within the community from being disclosed to that specific company.

Instead of or in addition to the list of non-disclosure company IDs, the posted project database 124 may be provided with a list of non-disclosure member IDs for registering IDs of members to whom disclosure of posted projects is prohibited. The requester device 200 may receive an operation to specify a member to whom disclosure of posted projects is prohibited, and transmit that member's ID to the sharing server 100. The sharing server 100 may choose not to provide the member corresponding to the member ID listed in the list of non-disclosure member IDs with the posted project corresponding to that list. In this manner, the requester device 200 may receive any of the company and the member as a target party to which disclosure of tasks is prohibited.

FIG. 15 is a diagram for explaining a procedure for searching for a posted project from the database 120. The processing of step S6 and step S7 of FIG. 11 and the function of the project extraction unit 145 will be described in more detail with reference to FIG. 15.

When receiving the applicant's operation requesting a search for a posted project, the applicant device 300 performs processing of searching for the posted project (step S6). In the processing of searching for the posted project, the applicant device 300 transmits a search request to the project extraction unit 145 of the sharing server 100.

When receiving the search request, the project extraction unit 145 extracts the project allowed to be viewed by the applicant from the posted projects registered in the posted project database 124. To this end, the project extraction unit 145 performs the processing from steps S1451 to S1454.

Step S1451 and step S1452 are processing of extracting the project allowed to be viewed by the applicant, based on the disclosure range set for the posted project. In step S1451, the company to which the applicant belongs and the community of the company to which the applicant belongs are judged. In step S1452, a project that can be disclosed is extracted.

Step S1453 is processing of extracting the project allowed to be viewed by the applicant based on the applicant's spare capacity for a side job. Step S1454 is processing of finally extracting a project that matches the applicant.

### [Processing of Extracting Projects Based on Disclosure Range]

Step S1451 includes step S1451A and step S1451B.

In step S1451A, the company to which the applicant belongs is identified based on the member ID used at the time of sign in, the company database 121, and the member database 122.

In step S1451B, the community of the company to which the applicant belongs is identified based on the ID of the company to which the applicant belongs and the community database 123.

Step S1452 includes step S1452A and step S1452B.

In step S1452A, posted projects that can be disclosed are extracted from the posted project database 124 based on the community to which the applicant's company belongs and the disclosure level.

In step S1452B, among the posted projects extracted in step S1452A, posted projects for which the company to which the applicant belongs is included in the non-disclosure company list are excluded. Here, the project extracted by the processing of step S1452B is referred to as Project X.

### [Processing of Extracting Projects Based on Spare Capacity for Side Job]

Step S1453 includes step S1453A, step S1453B, and step S1453C.

In step S1453A, the applicant's available hours for side job T1 are calculated. The available hours for side job are derived by calculating “the upper limit of side job hours−total side job hours”. The upper limit of side job hours is time defined by the company to which the applicant belongs, and is registered in the company database 121. The calculated available hours for side job are registered in the member database 122. The project extraction unit 145 may calculate the available hours for side job of all the members at regular intervals, and register the calculated available hours for side job in the member database 122.

The total side job hours is calculated by the calculation formula of “total expected side job hours+total actual side job hours” based on the expected side job hours and the actual side job hours registered in the side job database 125. That is, the total side job hours include expected hours that have not yet been spent on the side job, in addition to hours that have already been spent on the side job.

In step S1453B, hours T2 necessary for completing the task is calculated for each of the posted projects. The hours T2 are calculated based on the estimated man-hours (person/month) and the estimated period registered in the posted project database 124. For example, hours of the estimated man-hours (month) may be adopted as the hours T2. For example, as the hours T2, 5 hours may be set as hours for each month for the posted project corresponding to Project ID 001.

In step S1453C, the posted project that falls under “Hours T2≤available hours for side job T1” is extracted from the posted project database 124. Here, the project extracted by the processing of step S1453C is referred to as Project Y.

### [Processing of Extracting Projects Based on Disclosure Range and Spare Capacity for Side Job]

After extracting Project X based on the disclosure range and Project Y based on the spare capacity for side job, the project extraction unit 145 extracts the project that overlaps between Project X and Project Y, as the applicant's matching condition (step S1454).

### [Processing of Providing Extracted Projects]

Next, the project extraction unit 145 transmits information on the matching project to the applicant device 300 (step S1455). The applicant device 300 receives the matching project. The applicant device 300 lists the received matching project as the posted project on the display 305 (step S7).

As a result, the posted project that is appropriate from two perspectives is provided. That is, first, the applicant is provided with the posted project that can be handled without exceeding the applicant's upper limit of side job hours. This can prevent the applicant from becoming overworked. Secondly, the requester's posted project is provided only to the applicants who fall within the disclosure range intended by the requester. This can prevent confidential information of the company to which the requester belongs from being leaked to competitors.

### [Processing of Registering Planned Side Job Hours and Actual Side Job Hours]

FIG. 16 is a diagram for explaining a procedure for registering the side job plan and performance in the database 120. Step S14 of FIG. 12 and the function of the performance receiving unit 149 will be described in more detail with reference to FIG. 16.

The applicant inputs the planned side job hours into the applicant device 300, for example, when accepting an order for a new side job, and inputs the actual side job hours into the applicant device 300 at any timing while being engaged in the side job. The applicant device 300 receives input of the planned side job hours (step S14). The applicant device 300 transmits the received planned side job hours and actual side job hours to the performance receiving unit 149 of the sharing server 100.

The performance receiving unit 149 receives the applicant's planned side job hours and actual side job hours, and registers the received side job hours and actual side job hours of the applicant in the side job database 125 (step S1511). As a result, the applicant's planned side job hours and actual side job hours for each month are registered in the side job database 125 by the project ID.

Usually, after the applicant inputs the planned side job hours, the applicant inputs the actual side job hours at the end of the month. For this reason, the side job database 125 may include projects for which the planned side job hours are registered, but the actual side job hours have not yet been registered. For example, when the applicant who has received an order for a side job inputs the planned side job hours, as data corresponding to the side job, no actual side job hours are registered although the planned side job hours are registered.

Next, the performance receiving unit 149 automatically calculates the expected side job hours of the current month (step S1512). The performance receiving unit 149 calculates the expected side job hours based on the planned side job hours and the actual side job hours. Specifically, as already described, the “expected side job hours” are calculated based on the calculation formula of “(man-hour progress rate/progress rate)×planned side job hours−actual side job hours”. Note that the performance receiving unit 149 may calculate with the calculation formula of the “planned side job hours−actual side job hours”. The performance receiving unit 149 registers the calculated expected side job hours in the side job database 125. As illustrated in the side job database 125 of FIG. 7, the expected side job hours are registered for each project ID.

### [Processing of Registering Evaluation Result (Evaluation for Applicant)]

FIG. 17 is a diagram for explaining a procedure for registering an evaluation for the applicant in the database 120. Step S16A of FIG. 12 and the function of the evaluation receiving unit 151 will be described in more detail with reference to FIG. 17.

When completing the side job, the applicant reports delivery and completion to the requester, and undergoes the requester's inspection. Thereafter, the requester operates the requester device 200 to input an evaluation for the applicant into the requester device 200. The requester device 200 receives the input evaluation (step S16A). The requester device 200 transmits the received evaluation to the evaluation receiving unit 151 of the sharing server 100. Information transmitted from the requester device 200 to the sharing server 100 includes the member ID of the applicant who is an evaluated person and an evaluation value (0 to 10).

When receiving the information on the evaluation for the evaluated person (applicant) from the requester device 200, the evaluation receiving unit 151 reflects the evaluation for the evaluated person in the evaluation input database 126 (step S1513A).

If the evaluation result for the evaluated person (applicant) has already been registered in the evaluation input database 126, the evaluation receiving unit 151 calculates an average value of the evaluation result for the evaluated person, including the evaluation value received this time. The evaluation receiving unit 151 updates the evaluation results registered in the evaluation input database 126 with the calculated average value. As a result, the average values (evaluation results) of the evaluations for the evaluated person (applicant) are registered in the evaluation input database 126 by the evaluator (requester). This updates the information in the applicant evaluation unit 126B in the evaluation input database 126.

Next, the evaluation receiving unit 151 performs evaluation summary processing (step S1514A). In the evaluation summary processing, the evaluation receiving unit 151 calculates the average value of the evaluation results for the evaluated person (applicant) for each company and for each department, and registers the calculation results in the evaluation summary database 127. This updates the information of the applicant evaluation summary unit 127B in the evaluation summary database 127.

For example, the evaluation receiving unit 151 identifies the evaluator (requester), using the member ID used by the requester device 200 for sign in to perform step S16A. The evaluation receiving unit 151 identifies the company ID to which the evaluator belongs, the department to which the evaluator belongs, the member ID of the evaluated person, and the ID of the company to which the evaluated person belongs, based on the evaluation information received in step S1513A, the company database 121, and the member database 122. The “member ID” is an example of “identification information that enables the sharing server 100 including the evaluation receiving unit 151 to identify (the company and the department) to which a person who accessed the sharing server 100 belongs and the viewing privilege”.

The evaluation receiving unit 151 accesses the evaluation summary database 127, and detects a data row in which the identified IDs (the member ID of the evaluated person, the ID of the company to which the evaluated person belongs, and the ID of the company to which the evaluator belongs) are arranged. The evaluation receiving unit 151 updates the value of the applicant evaluation summary corresponding to the detected data row.

### [Processing of Registering Evaluation Result (Evaluation for Requester)]

FIG. 18 is a diagram for explaining a procedure for registering an evaluation for the requester in the database. Step S16B of FIG. 13 and the function of the evaluation receiving unit 151 will be described in more detail with reference to FIG. 18.

As described above, when completing the side job, the applicant reports the delivery and completion to the requester, and undergoes the requester's inspection. Thereafter, the applicant operates the applicant device 300 to input an evaluation for the requester into the applicant device 300. The applicant device 300 receives the input evaluation (step S16B). The applicant device 300 transmits the received evaluation to the evaluation receiving unit 151 of the sharing server 100. Information transmitted from the applicant device 300 to the sharing server 100 includes the member ID of the requester who is an evaluated person and an evaluation value (0 to 10).

When receiving information on the evaluation for the evaluated person (requester) from the applicant device 300, the evaluation receiving unit 151 reflects the evaluation for the evaluated person (requester) in the evaluation input database 126 (step S1513B).

If the evaluation result for the evaluated person (requester) has already been registered in the evaluation input database 126, the evaluation receiving unit 151 calculates an average value of the evaluation result for the evaluated person, including the evaluation value received this time. The evaluation receiving unit 151 updates the evaluation results registered in the evaluation input database 126 with the calculated average value. As a result, the average values (evaluation results) of the evaluations for the evaluated person (requester) are registered in the evaluation input database 126 by the evaluator (applicant). This updates the information in the requester evaluation unit 126A in the evaluation input database 126.

Next, the evaluation receiving unit 151 performs the evaluation summary processing (step S1514B). In the evaluation summary processing, the evaluation receiving unit 151 calculates the average value of the evaluation results for the evaluated person (requester) for each company and for each department, and registers the calculation result in the evaluation summary database 127. This updates the information of the requester evaluation summary unit 127A in the evaluation summary database 127.

For example, the evaluation receiving unit 151 identifies the evaluator (applicant), using the member ID used by the applicant device 300 for sign in to perform step S16B. The evaluation receiving unit 151 identifies the ID of the company to which the evaluator belongs, the department to which the evaluator belongs, the member ID of the evaluated person, and the ID of the company to which the evaluated person belongs, based on the evaluation information received in step S1513B, the company database 121, and the member database 122. The “member ID” is an example of “identification information that enables the sharing server 100 including the evaluation receiving unit 151 to identify (the company and the department) to which a person who accessed the sharing server 100 belongs and the viewing privilege”.

The evaluation receiving unit 151 accesses the evaluation summary database 127, and detects a data row in which the identified IDs (the member ID of the evaluated person, the ID of the company to which the evaluated person belongs, and the ID of the company to which the evaluator belongs) are arranged. The evaluation receiving unit 151 updates the value of the requester evaluation summary corresponding to the detected data row.

For example, in the data group 1271 of FIG. 9, the member ID of the evaluated person=P1, the ID of the company to which the evaluated person belongs=00A, and the ID of the company to which the evaluator belongs=00B are arranged. When the member belonging to System Department of Company B evaluates Member P1, the evaluation is received in step S1513B.

In this case, in step S1514B, the evaluations received in step S1513B are reflected in the requester evaluation summary corresponding to “All” of the data group 1271 and in the requester evaluation summary corresponding to “System Department”.

More specifically, the evaluation receiving unit 151 sets the average value of the evaluations for Company B as a whole including the evaluation received in step S1513B, as the requester evaluation summary corresponding to “Whole” of the data group 1271. Similarly, the evaluation receiving unit 151 sets the average value of the evaluations of System Department including the evaluation received in step S1513B, as the requester evaluation summary corresponding to “System Department” of the data group 1271.

FIG. 19 is a diagram for explaining a procedure for displaying the evaluation for the applicant and member search results on the display 205. Step S4A (processing of the requester device 200) of FIG. 10 and the function of the member search unit 143, as well as step S17A and step S18A of FIG. 12 and the function of the evaluation output unit 152 will be described in more detail, with reference to FIG. 19.

### [Processing of Outputting Evaluation Summary for Applicant]

First, each processing of step S17A, step S18A, step S1521A, and step S1522A illustrated in FIG. 19 will be described.

When receiving an operation for the requester to view the evaluation for the applicant, the requester device 200 performs the viewing request processing (step S17A). In the viewing request processing, the requester device 200 transmits a viewing request to the evaluation output unit 152 of the sharing server 100. In response to the viewing request, the evaluation output unit 152 selects, from the evaluation summary database 127, the applicant evaluation summary that the requester (person who requests viewing) is privileged to view (step S1521A).

The requester who made the viewing request is privileged to view the applicant evaluation summary for the requester's company as a whole and the applicant evaluation summaries for the department to which the requester belongs. The requester who made the viewing request is not privileged to view any evaluation summaries other than these. The evaluation output unit 152 judges the viewing privilege based on the member ID of the requester who transmits the viewing request, the company database 121, and the member database 122. The “member ID” is an example of “identification information that enables the sharing server 100 including the evaluation receiving unit 151 to identify (the company and the department) to which a person who accessed the sharing server 100 belongs and the viewing privilege”.

The evaluation output unit 152 selects the applicant evaluation summary corresponding to the viewing privilege from the evaluation summary database 127. The evaluation output unit 152 transmits data including the selected applicant evaluation summary to the requester device 200 (step S1522A). The data to be transmitted includes the member ID of the applicant (evaluated person), information on the company to which the applicant belongs, information on the department to which the applicant belongs, or the like, in addition to the applicant evaluation summary. The data to be transmitted may include the applicant evaluation summary corresponding to each of a plurality of applicants (evaluated person), in response to the viewing request.

The requester device 200 that has received the applicant evaluation summary displays the applicant evaluation summary on the display 205, together with the information on the company to which the applicant belongs and the information on the department to which the applicant belongs (step S18A). When receiving the applicant evaluation summary corresponding to each of the plurality of applicants (evaluated persons), the requester device 200 displays the applicant evaluation summary listing the plurality of applicants (evaluated persons).

In this manner, when receiving the viewing request in communication established by the member ID capable of identifying the company and the department to which the requester belongs, the sharing server 100 transmits the applicant evaluation summaries, which are examples of the evaluation information, to the requester device 200 of the requester who is a transmission source that transmitted that viewing request.

### [Processing of Searching for Member (Applicant)]

Processing of each of Step S4A, step S19A, and step S1431A to step S1433A will be described continuously referring to FIG. 19.

When receiving a search operation from the requester, the requester device 200 performs the member search processing for searching for information regarding the applicant (step S4A). In the member search processing, the requester device 200 transmits a search request to the member search unit 143 of the sharing server 100. The search request includes a reference value for searching, by excluding members with poor evaluations as an applicant. This reference value is defined, for example, based on the values of the applicant evaluation summaries.

The member search unit 143 that has received the search request identifies the company to which the requester who transmitted the search request belongs (step S1431A). Here, the company identified by step S1431A is referred to as “Company Xa”.

The member search unit 143 identifies the requester that operates the requester device 200, using the member ID used by the requester device 200 to sign in to the sharing server 100. The member search unit 143 uses the company database 121 and the member database 122 to identify the company Xa to which the requester belongs.

Next, the member search unit 143 extracts, from the evaluation summary database 127, members for which the values of the applicant evaluation summaries covering the identified Company Xa as a whole exceed a reference value (step S1432A). That is, the member search unit 143 extracts search results by excluding members having poor evaluation of Company Xa as a whole.

Here, it is to be noted that the member search unit 143 judges whether or not the evaluation is poor, based on the applicant evaluation summaries. That is, Member a, who has both requester and applicant privileges, may behave as a requester and behave as an applicant. Thus, as the evaluation summary for such Member a, the requester evaluation summary and the applicant evaluation summary are registered in the evaluation summary database 127. Member a may be highly evaluated as the requester, while Member a may be poorly evaluated as the applicant. In this case, Member may be excluded from extraction targets in step S1432A.

The sharing server 100 may be provided with a function to receive reference value setting information from the requester device 200 of each company. This enables each company to exclude the poorly evaluated members from search results based on its unique reference value.

Next, the member search unit 143 outputs information of the extracted members as search results to the requester device 200 who made the search request (step S1433A). The requester device 200 lists the received search results on the display 205 (step S19A).

As a result, the requester can view, on the display 205, the search results from which the members for whom the overall evaluation of the requester's company is poor are excluded. Therefore, when selecting a contractor from among applicants, the requester can save the effort of visually excluding the members for whom the company's overall evaluation is poor.

Note that in the present embodiment, even when members are poorly evaluated by a certain department of the company to which the requester belongs, the members are not excluded from search results if the members are not poorly evaluated by the company as a whole. However, the member search unit 143 may further exclude such members from the search results.

FIG. 20 is a diagram for explaining a procedure for displaying the evaluation for the requester and the member search results on the display 305. Step S4B (processing of the applicant device 300) of FIG. 10 and the function of the member search unit 143, as well as step S17B and step S18B of FIG. 13 and the function of the evaluation output unit 152 will be described in more detail with reference to FIG. 20.

### [Processing of Outputting Evaluation Summary for Requester]

First, processing of each of step S17B, step S18B, step S1521b, and step S1522B illustrated in FIG. 20 will be described.

When receiving an operation for the applicant to view an evaluation for the requester, the applicant device 300 performs the viewing request processing (step S17B). In the viewing request processing, the applicant device 300 transmits a viewing request to the evaluation output unit 152 of the sharing server 100. In response to the viewing request, the evaluation output unit 152 selects, from the evaluation summary database 127, requester evaluation summaries that the applicant (person who requests viewing) is privileged to view (step S1521B).

The applicant who made the viewing request is privileged to view the requester evaluation summary for the applicant's company as a whole and the requester evaluation summaries for the department to which the applicant belongs. The applicant who made the viewing request is not privileged to view any evaluation summaries other than these. The evaluation output unit 152 judges on the viewing privilege, based on the member ID of the applicant who transmits the viewing request, the company database 121, and the member database 122. The “member ID” is an example of “identification information that allows the sharing server 100 including the evaluation receiving unit 151 to identify affiliation (company and department) of a person who accessed the sharing server 100”.

The evaluation output unit 152 selects the requester evaluation summary corresponding to the viewing privilege from the evaluation summary database 127. The evaluation output unit 152 transmits data including the selected requester evaluation summary to the applicant device 300 (step S1522B). The data to be transmitted includes the member ID of the requester (evaluated person), information on the company to which the requester belongs, information on the department to which the requester belongs, or the like, in addition to the requester evaluation summary. The data to be transmitted may include the requester evaluation summary corresponding to each of the plurality of requesters (evaluated persons), in response to the viewing request.

The applicant device 300 that has received the requester evaluation summaries displays the requester evaluation summaries together with the information on the company to which the requester belongs and the information on the department to which the requester belongs on the display 305 (step S18B). When receiving the requester evaluation summaries corresponding to each of a plurality of requesters (evaluated persons), the applicant device 300 displays the requester evaluation summary listing the plurality of requesters (evaluated persons).

In this manner, when receiving the viewing request in communication established by the member ID capable of identifying the company and department to which the applicant belongs, the sharing server 100 transmits the requester evaluation summaries, which are examples of the evaluation information, to the applicant device 300 of the applicant who is the transmission source that transmitted that viewing request.

### [Processing of Searching for Member (Requester)]

Processing of each of Step S4B, step S19B, and step S1431B to step S1433B will be described continuously referring to FIG. 20.

When receiving a search operation from the applicant, the applicant device 300 performs the member search processing for searching for information regarding the requester (step S4B). In the member search processing, the applicant device 300 transmits a search request to the member search unit 143 of the sharing server 100. The search request includes a reference value for searching, by excluding members with poor evaluations as the requester. This reference value is defined, for example, based on the values of the requester evaluation summaries.

The member search unit 143 that has received the search request identifies the company to which the applicant who transmitted the search request belongs (step S1431B). Here, the company identified by step S1431B is referred to as “Company Xb”.

The member search unit 143 identifies the applicant that operates the applicant device 300, using the member ID used by the applicant device 300 to sign in to the sharing server 100. The member search unit 143 uses the company database 121 and the member database 122 to identify the company Xb to which the applicant belongs.

Next, the member search unit 143 extracts, from the evaluation summary database 127, members for which the values of the requester evaluation summaries covering the identified Company Xb as a whole exceed a reference value (step S1432B). That is, the member search unit 143 extracts search results by excluding members having poor evaluation of Company Xb as a whole.

The sharing server 100 may be provided with a function to receive the reference value setting information from the requester device 200 of each company. This enables each company to exclude the poorly evaluated members from search results based on its unique reference value.

Next, the member search unit 143 outputs information of the extracted members as search results to the applicant device 300 who made the search request (step S1433B). The applicant device 300 lists the received search results on the display 305 (step S19B).

As a result, the applicant can view, on the display 305, the search results from which the members for whom the overall evaluation of the applicant's company is poor are excluded. Therefore, when selecting a contractor from among requesters, the applicant can save the effort of visually excluding the members for whom the company's overall evaluation is poor. Accordingly, the requester is presented with a filtered list of candidates, alleviating the need to manually review and exclude members who do not meet a predetermined evaluation threshold.

Note that in the present embodiment, even when members are poorly evaluated by a certain department of the company to which the applicant belongs, the members are not excluded from search results if the members are not poorly evaluated by the company as a whole. However, the member search unit 143 may further exclude such members from the search results.

### [Viewable Range of Evaluation Summary Database 127]

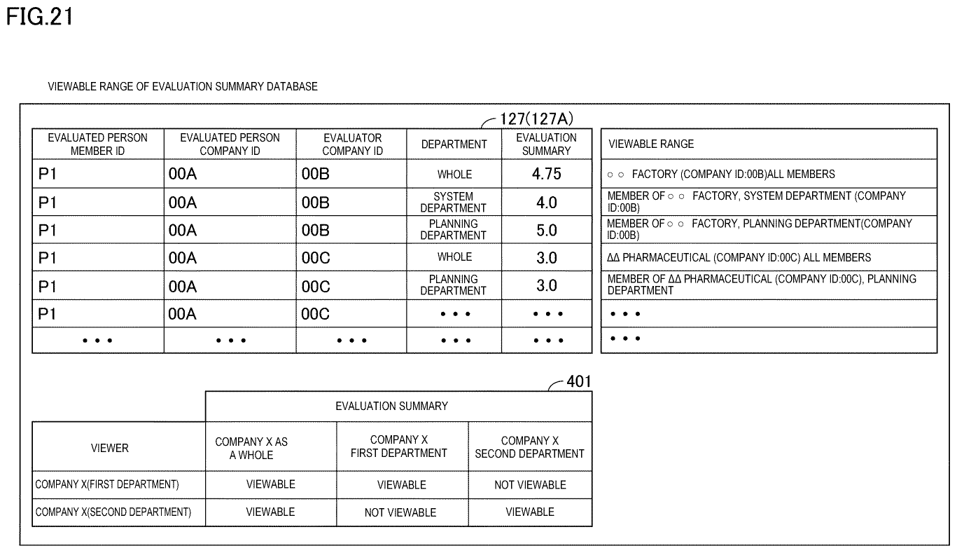

FIG. 21 is a diagram for explaining a viewable range of the evaluation summary database 127. Here, the viewable range will be described by taking, as an example, the requester evaluation summary unit 127A, which is also illustrated in FIG. 9, of the evaluation summary database 127.

The requester evaluation summary unit 127A illustrated in FIG. 21 includes evaluation summaries from each of Company B and Company C for Member P1 who behaves as the “requester”. Member P1 belongs to Company A. The evaluation summary of Company B is classified into “Whole”, “System Department”, and “Planning Department”. The evaluation summary of Company C is classified into “Whole”, “Planning Department”, and the like. Members belonging to Companies B and C view the evaluation summaries for Member P1 as the “applicant”.

The viewing privilege for the evaluation summaries that is calculated from the evaluation of Company B as a whole is granted to all members belonging to Company B, as illustrated in the “Viewable Range” column in FIG. 21.

The viewing privilege for the evaluation summaries that is calculated from the evaluation of System Department of Company B is granted to members of System Department of Company B, but is not granted to members other than those of System Department of Company B. The viewing privilege for the evaluation summaries that is calculated from the evaluation of Planning Department of Company B is granted to members of Planning Department of Company B, but is not granted to members other than those of Planning Department of Company B.

The viewing privilege for the evaluation summaries that is calculated from the evaluation of Company C as a whole is granted to all members belonging to Company C. The viewing privilege for the evaluation summaries that is calculated from the evaluation of Planning Department of Company C is granted to members of Planning Department of Company C, but is not granted to members other than those of Planning Department of Company C.

As above, the viewable range is described taking the requester evaluation summary unit 127A as an example. In the matching system 1, the viewable range for the applicant evaluation summary unit 127B (See FIG. 9) is also defined based on the design concept similar to that of the requester evaluation summary unit 127A.

If viewers are members from First Department of Company X and members from Second Department of Company X, viewers' privileges for the evaluation summary of Company X as a whole, the evaluation summary of First Department of Company X, and the evaluation summary of Second Department of Company X are as illustrated in Table 401 in FIG. 21. Here, when the applicant falls under the “viewers”, a viewing target is the evaluation summaries of the “requesters”. Conversely, when the requester falls under the “viewers”, the viewing target is the evaluation summaries of the “applicant”.

Members who belong to First Department of Company X can view the evaluation summaries of Company X as a whole and the evaluation summaries of First Department of Company X, but cannot view the evaluation summaries of Second Department of Company X. Members who belong to Second Department of Company X can view the evaluation summaries of Company X as a whole and the evaluation summaries of Second Department of Company X, but cannot view the evaluation summaries of Second Department of Company X. Members belonging to Company Y other than Company X cannot view the evaluation summaries of Company X as a whole, the evaluation summaries of First Department of Company X, and the evaluation summaries of Second Department of Company X.

The evaluation summaries of Company X as a whole, the evaluation summaries of First Department of Company X, and the evaluation summaries of Second Department of Company X will not be disclosed to members of companies other than Company X. Therefore, in a scene where a member, who belongs to Company Y and behaves as an applicant, evaluates a requester who belongs to Company X, the member can objectively evaluate the requester belonging to Company X without considering a relationship between the companies, or the like. Similarly, in a scene where a member, who belongs to Company Y and behaves as a requester, evaluates an applicant who belongs to Company X, the member can objectively evaluate the applicant belonging to Company X without considering a relationship between the companies, or the like.

In addition, evaluations made by the members belonging to Company X (evaluations for the requester, and evaluations for the applicant) are shared within Company X as the requester evaluation summary and the applicant evaluation summary. This enables evaluators to be aware that accumulation of each evaluation produce useful information. This motivates the evaluators to make accurate evaluations.

As a result, the accuracy of the requester evaluation summary and the applicant evaluation summary is improved. This makes it possible to usefully utilize the requester evaluation summary as reference data when selecting posted tasks. Similarly, the applicant evaluation summary can be usefully utilized as reference data when selecting a contractor.

Furthermore, according to the present embodiment, when the member search processing (step S4A) is performed in the requester device 200, the requester is provided with search results from which the poorly evaluated members are excluded (step S1432A). Similarly, when the member search processing (step S4B) is performed in the applicant device 300, the requester is provided with search results from which the poorly evaluated members are excluded (step S1432B). That is, the matching system 1 includes a filtering function that provides search results from which the poorly evaluated members are excluded.

Therefore, the requester can prevent, on a company-by-company basis, a mistake of hiring a poorly evaluated member when determining a contractor for a posted task. Similarly, the applicant can prevent, on a company-by-company basis, a mistake of selecting a posted task solicited by a poorly evaluated member when determining the application target from a large number of posted tasks. Note that the sharing server 100 may perform filtering using department-by-department based evaluation summaries.

The requester device 200 may transmit, to the sharing server 100, a command signal instructing which of filtering using evaluation summaries of a company as a whole or filtering using the department-by-department based evaluation summaries is to be used. In this case, the sharing server 100 is provided with a function to change the evaluation summary to be used for filtering, in response to the command signal.

### [Example of Screen Displayed When Checking Side Job Status]

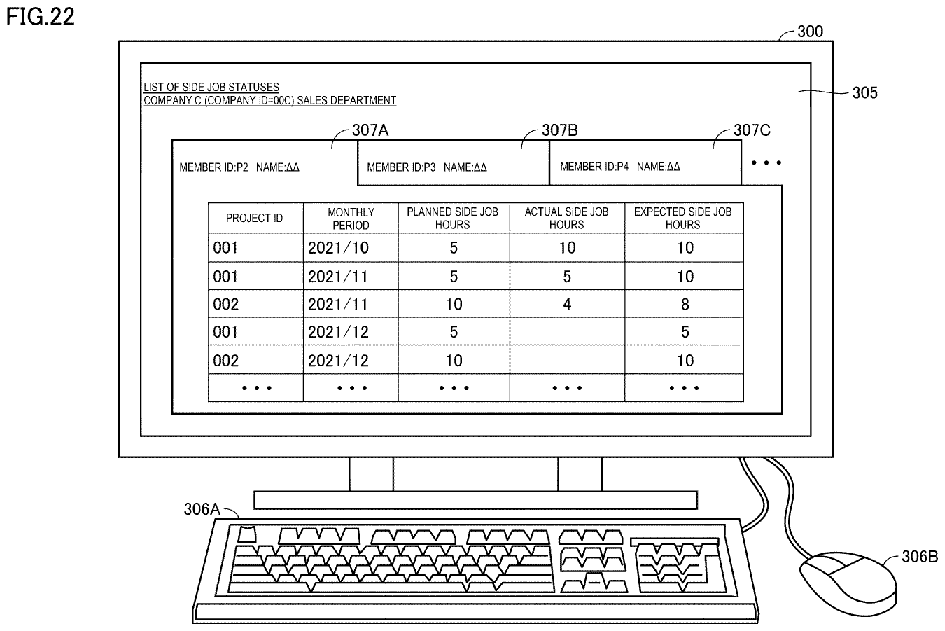

FIG. 22 is a diagram illustrating a screen to be displayed on the supervisor's applicant device 300 when the supervisor (the superior of the applicant) checks the side job statuses of his/her subordinates. FIG. 22 illustrates an example in which the side job statuses of the supervisor's subordinates are displayed to the applicant device 300. The applicant device 300 is provided with a keyboard 306A and a mouse 306B as operating units.

Here, the supervisor is, for example, a department head of Sales Department of Company C. The side job statuses of employees who belong to Sales Department are displayed on the display 305. The supervisor can check the side job statuses of the employees belonging to Sales Department, by specifying any of tab 307A, tab 307B, tab 307C, . . . using the keyboard 306A or the mouse 306B. Therefore, the supervisor can manage the working hours of his/her subordinates so that the subordinates do not fall into an overwork status. Note that the progress rate may also be displayed on the screen.

### [Details of Project Content]

FIG. 23 is a diagram illustrating details of project content included in the posted project database 124. As illustrated in FIG. 23, project content (posting requirements) is registered in the posted project database 124 by project ID. The posted project database 124 is an example of a database in which the task information indicating the content of posted tasks is registered for each of posted projects.

The project content includes items of a project name, project details, and required skills. The project name lists a title of a posted project. The project details describe content of the posted project. The required skills describe content of skills required of an applicant. The required skills are classified into basic skills and applied skills, depending on the level of skills required of the applicant.

For example, applied skills may be highly specialized skills that could be obtained only at a company that has registered a posted project. In contrast, basic skills may be general skills that are known at many companies, including the company that has registered the posted project. As described with reference to FIG. 1, the list of posted projects is displayed on the screen 350 of the applicant device 300. In the list of posted projects, the project details registered in the posted project database 124 and the required skills are reflected. An applicant views the project details and the required skills displayed in the list of posted projects, and determines a posted project for which he/she wishes to apply, from among the large number of posted projects.

### [Example in Which Disclosure Ranges of Posted Projects and Educational Content are Restricted]

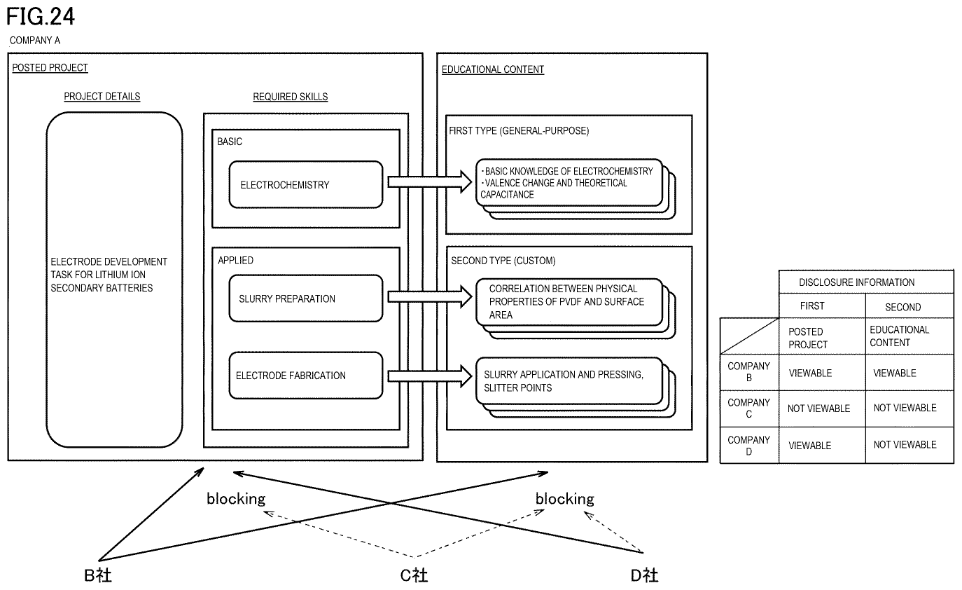

FIG. 24 is a diagram illustrating an example in which a posted project and educational content are restricted for each company by the disclosure information. FIG. 24 illustrates a relationship between a posted project of Company A and educational content corresponding to the posted project.

As illustrated in FIG. 24, the posted project includes the project details and the required skills. The project details include detailed content of the project, such as “electrode development task for lithium ion secondary batteries”, and the like. The required skills are classified into basic skills and applied skills.

For example, applied skills are highly practical skills that are required to fulfill tasks described in the project details. The applied skills may be skills that are difficult to acquire anywhere outside the company that has registered the posted project. The applied skills may be skills that can be acquired at a smaller number of companies including the company that has registered the posted project. In contrast, basic skills may be fundamental skills disclosed in books, and the like. FIG. 24 exemplarily illustrates “electrochemistry” as the basic skill and “slurry preparation” and “electrode fabrication” as the applied skills.

Educational content includes first-type content (general-purpose content) corresponding to a classification of basic skills and second-type content (custom content) corresponding to a classification of applied skills. The first-type content is created by any of the companies utilizing the matching system 1. The second-type content is created by companies having the applied skills. The first-type content may also be created by, for example, a company engaged in a business of creating general-purpose educational content, other than the companies utilizing the matching system 1.

The first-type content is associated with basic skills, and the second-type content is associated with applied skills. The number of educational contents associated with the basic skills or the applied skills may be one or may be more than one. FIG. 24 illustrates an example in which “basic knowledge of electrochemistry” and “valence change and theoretical capacitance” are associated with “electrochemistry”, an example in which “correlation between physical properties and surface area of PVDF” are associated with “slurry preparation”, and an example in which “slurry application and pressing, and slitter points” are associated with “electrode fabrication”.

The matching system 1 receives, from the requester who has registered the posted project, an operation to set a disclosure range of the posted project and an operation to set a disclosure range of educational content associated with the required skills of the posted project. The matching system 1 sets the “disclosure information” applied to the posted project, in response to the operation to set the disclosure range of the posted project, and sets the “disclosure information” applied to the educational content, in response to the operation to set the disclosure range of the educational content. The “disclosure information” applied to the posted project is an example of first disclosure information, and the “disclosure information” applied to the educational content is an example of second disclosure information.

FIG. 24 illustrates the setting example of disclosure information separately for the first disclosure information and the second disclosure information. According to the setting example, a user belonging to Company B is allowed to view both posted projects of Company A and educational content associated with the posted projects. A user belonging to Company C is not allowed to view both the posted projects of Company A and the educational content associated with the posted projects. A user belonging to Company D is allowed to view the posted projects of Company A, but is not allowed to view the educational content associated with the posted projects. Note that although not illustrated in FIG. 24, a user belonging to Company A, which is the registration source of the posted projects, is usually privileged to view the posted projects and the educational content associated with the posted projects.

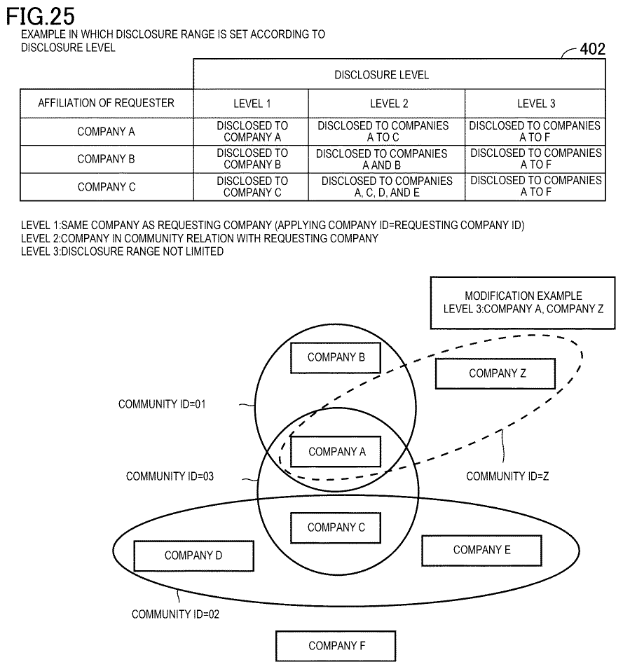

As such, in this embodiment, the disclosure range of the posted project and the disclosure range of the educational content are set by the disclosure information. As described with reference to FIG. 6, the disclosure information includes the disclosure level and the non-disclosure list. Next, the disclosure level will be described in detail with reference to FIG. 25.

### [Example in Which Disclosure Range is Set According to Disclosure Level]

FIG. 25 is a diagram illustrating an example in which the disclosure range is set according to the disclosure level. Here, as illustrated in FIG. 25, a case is considered in which Company A to Company E form a community relationship, and Company F has no community relationship with any company. In this case, the disclosure range of posted projects or educational contents is as illustrated in Table 402, according to the company to which the requester belongs and the disclosure level set by the requester.

The disclosure levels of “Level 1” to “Level 3” illustrated in FIG. 25 correspond to the three levels of “Own Company”, “Within Community”, and “All” which have already been described.

Therefore, the posted projects for which Level 1 is set are disclosed only to users who belong to the company to which the requester belongs. The posted projects for which Level 2 is set are disclosed to the users who belong to the company to which the requester belongs, and to users who belong to companies that have a community relationship with the company to which the requester belongs. The posted projects for which Level 3 is set are disclosed to all users.

Similarly, the educational content for which Level 1 is set is disclosed only to the users who belong to the company to which the requester belongs. The educational content for which Level 2 is set is disclosed to the users who belong to the company to which the requester belongs, and to users who belong to companies that have a community relationship with the company to which the requester belongs. The educational content for which Level 3 is set is disclosed to all users.

However, if IDs of non-disclosure companies are specified in the non-disclosure list, the companies corresponding to those IDs are excluded from the companies to be disclosed, irrespective of the set disclosure level. Among the disclosure levels of the present embodiment, “Level 1” is a level corresponding to “allowing disclosure of task information to a first applicant, and prohibiting disclosure of the task information to applicants who do not belong to the first group”. “Level 2” is a level corresponding to “allowing disclosure of task information to an applicant who belongs to the first group or a community group that has formed a community relationship with the first group, and prohibiting the disclosure of the task information to applicants who do not belong to any of the first group or a community group”. “Level 3” is a level corresponding to “allowing disclosure of task information to applicants irrespective of a group to which the applicant belongs”.

Here, the Level 1 to Level 3 are described above as an example of a plurality of types of disclosure levels. However, the plurality of types of disclosure levels is not limited thereto. For example, a community may be divided to a plurality of small communities, and whether or not to disclose “posted project/educational content” may be set for each small community. More specifically, Community 02 illustrated in FIG. 5 is divided into a first small community and a second small community. Company C belongs to the first small community, and Company D and Company E belong to the second small community. In this case, the requester from Company D may be able to select whether to set the disclosure range of “posted project/educational content” to the first small community or to the second small community.

The sharing server 100 may receive an operation to set the disclosure range differently for “each posted project/each educational content”. For example, among a large number of posted projects, by taking Project 001 to Project 003 as examples, a description will be given of a specific example in which the disclosure range is set differently for each posted project. Note that it is assumed that in the following description, the specific example will be apprehended by replacing the “posted projects” with the “educational content”.

For example, the disclosure range of the posted project 001 may be limited only to Companies A and C that belong to the community identified with the community ID=03. Alternatively, the disclosure range of the posted project 002 may be limited to only Companies C, D, and C, which belong to the community identified with the community ID=02. Alternatively, the disclosure range of Project 003 may be limited to Companies C, D, and C that belong to the community identified with the community ID=02, and Companies A and C that belong to the community identified with the community ID=03.

Company A may form another community that is separate from the communities identified the community IDs=01 or 02. For example, as illustrated by the dashed line in FIG. 25, Company A may form a community identified by community ID=Z, with Company Z. For example, if the requester belongs to Company A, the posted project may be disclosed to applicants belonging to Company A and applicants belonging to Company Z. Such a disclosure level may be adopted as a modification example of “Level 3”, as illustrated in FIG. 25.

In this case, “Level 3” corresponds to “allowing task information to applicants who belong to a first group (Company A), and a specific community group (community identified with community ID=Z) that is different from the second level community groups (Company A to Company C) that have formed a community relationship with the first group, and prohibiting the disclosure of the task information to applicants who do not belong to any of the first group or the specific community group”.

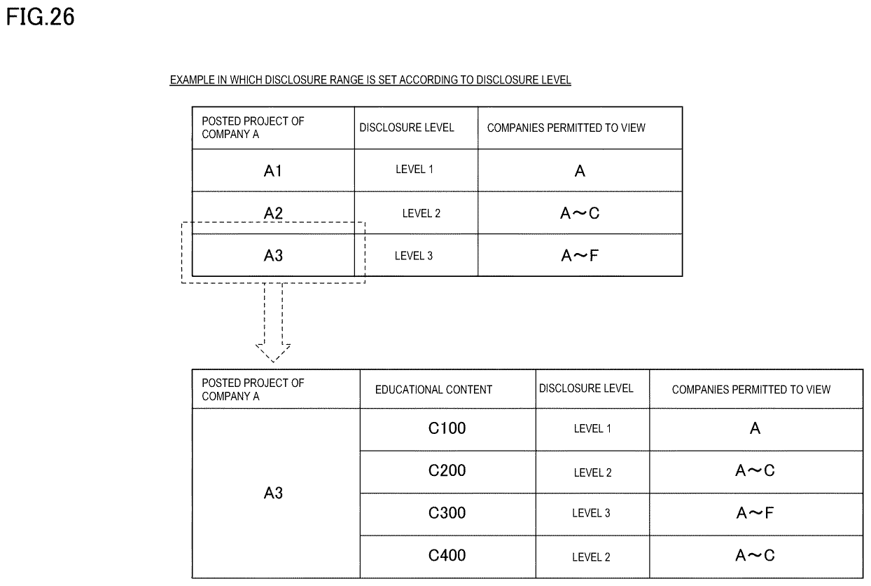

FIG. 26 is a diagram illustrating an example in which the disclosure range of the posted project and the disclosure range of the educational content are set according to the disclosure level.

It is assumed here that there are Project A1, Project A2 and Project A3 as posted projects of Company A. It is assumed that only Company A to Company F have joined the matching system 1, and that Company A to Company F have the relationship illustrated in FIG. 25. Note that the “posted projects of Company A” refer to posted projects drafted by the requester belonging to Company A.

As illustrated in FIG. 26, the requester belonging to company A can set the disclosure levels for Project A1 to Project A3. FIG. 26 illustrates an example in which Level 1 is set for Project A1, Level 2 is set for Project A2, and Level 3 is set for Project A3. In this case, Project A1 is disclosed only to the users belonging to Company A. Project A2 is disclosed to users who belong to any of Company A to Company C. Project A3 is disclosed to users (all users) belonging to any of Company A to Company F.

The requester belonging to Company A can further set the disclosure level for each educational content associated with the posted projects. FIG. 26 illustrates an example in which the disclosure level is set for each educational content associated with the posted Project A3. As already described, the educational content is associated with the required skills among various types of information included in the posted projects. For simplicity of the description, in FIG. 26, illustration of the required skills associated with the educational content is omitted.

As illustrated in FIG. 26, Educational Contents C100, C200, C300, and C400 are associated with the posted Project A3. Educational Contents C100, C200, C300, and C400 are each different educational content. Educational Contents C100, C200, C300, and C400 may be the first-type content or the second-type content. Educational Contents C100, C200, C300, and C400 may include the first-type content and the second-type content.

In the example illustrated in FIG. 26, Level 1 is set for Educational Content C100, Level 2 is set for Educational Content C200, Level 3 is set for Educational Content C300, and Level 2 is set for Educational Content C100.

Therefore, Educational Content C100 is disclosed only to the users belonging to Company A. Educational Content C200 and C400 are disclosed to the users who belong to any of Company A to Company C. Educational Content C300 is disclosed to the users (all users) belonging to any of Company A to Company F.

Considering the disclosure level of the posted project and the disclosure level of the educational content, although the posted Project A3 is disclosed to all users, the disclosure range of the educational content differs depending on the company to which the user belongs. In this manner, users utilizing the matching system 1 can set the disclosure range separately for the posted projects and the educational content.

The companies affiliated with the matching system 1 can allow their employees to gain varied task experiences by providing the employees with opportunities to accept orders for posted tasks not only for their own company but also for other companies. In addition, requesting companies can increase their task efficiency by leveraging human resources of other companies. Furthermore, the requesting companies can attract high-quality applicants by clearly indicating not only the skills necessary for applying for the posted projects but also the educational content useful for learning those skills.

However, the requesting companies would not like their rival companies to know about specific posted tasks. In particular, large companies like those that are publicly listed tend to compete with other companies due to their diversified operations. In addition, the requesting companies may allow their posted tasks to be disclosed to a large number of companies, but might wish to refrain from disclosing, to a specific company, the educational content related to the skills of the posted tasks. In particular, it is thought that many companies wish to limit the disclosure range especially for (customized) educational content that reflects extremely high technological capabilities of their companies, such as the second-type content (see FIG. 24).

According to this embodiment, users can set the disclosure range separately for the posted projects and the educational content. As a result, the requesting companies can adjust the disclosure range of the posted projects and the disclosure range of the educational content so as to prevent any disadvantage from arising, while taking into consideration their relationships with respective companies.

### [Display Example of List of Posted Projects]

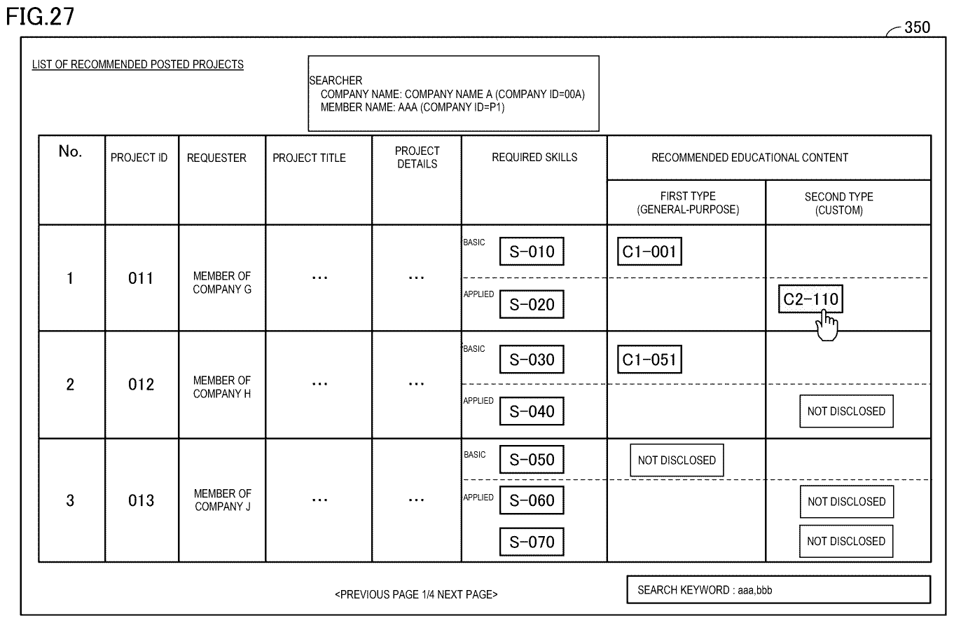

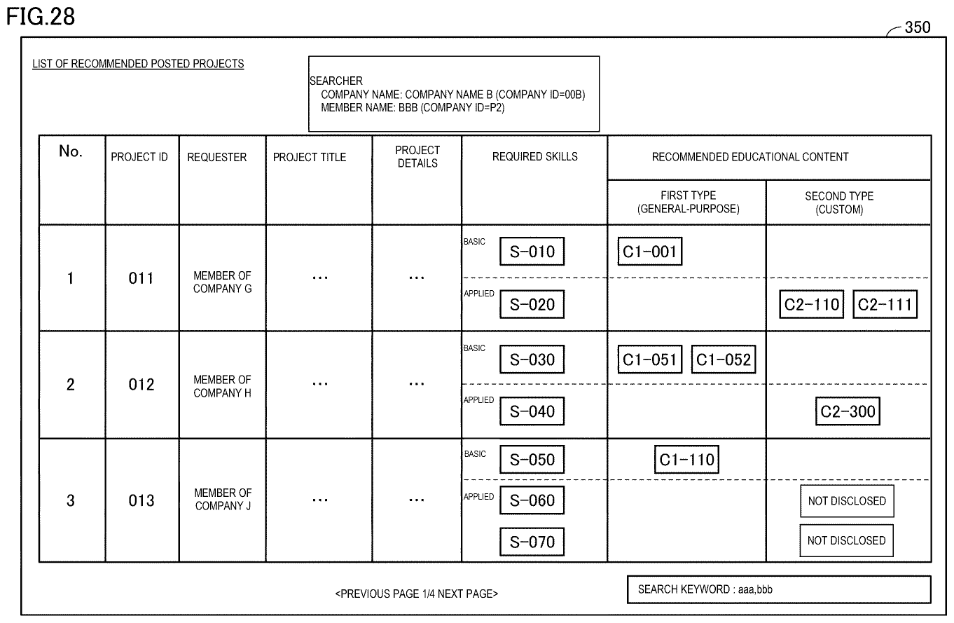

FIG. 27 is a diagram illustrating a display example of the list of posted projects. FIG. 28 is a diagram illustrating another display example of the list of posted projects. The list of posted projects is displayed on the screen 350 of the applicant device 300. FIG. 27 and FIG. 28 illustrate a more specific example of the list of posted projects illustrated in FIG. 1.

With reference to FIG. 27, the posted projects are displayed by project ID on the screen 350. The list of posted projects includes the project IDs, requester information, project titles, project details, required skills, and educational content (recommended educational content).

Information related to searchers of posted projects is displayed above the list of posted projects. Keywords that a searcher used when searching for the posted projects are displayed below on the right side of the list of posted projects. According to the screen 350 illustrated in FIG. 27, the searcher is a member belonging to Company A.

A posted project (Project 011) with a project ID=011 is drafted by a member belonging to Company G. As the required skills, “S1-010” and “S2-020” are set for Project 011. Note that “S1-010” and “S2-020” represent IDs for identifying content of the skills. The same also applies to other symbols shown in Required Skills column. In FIG. 27, IDs are shown for simplicity, while on the actual screen 350, the content of the skills identified by IDs is displayed in text. This also applies to the list of posted projects illustrated in FIG. 28.

A plurality of required skills is displayed in Required Skills column for Project 011. Of the plurality of required skills, “S1-010” displayed in the upper part corresponds to the “basic skills”, and “S2-020” displayed in the lower part corresponds to the “applied skills”. This also applies to projects other than Project 011.

The list of posted projects includes the first-type content “C1-001” associated with the required skill “S1-010”. Furthermore, the list of posted projects includes the second-type content “C2-110” associated with the required skill “S2-020”. Here, “C1-001” and “C2-110” represent IDs for identifying the content. This also applies to other symbols shown in Recommended Educational Content column. In FIG. 27, the IDs are shown for simplicity, while on the actual screen 350, titles of the educational content identified by IDs are displayed. This also applies to the list of posted projects illustrated in FIG. 28.

Searchers select and operate the second-type content “C2-110”, for example. Then, a screen for viewing the selected content is displayed on the applicant device 300.

The searcher on the screen 350 illustrated in FIG. 27 is different from the searcher on the screen 350 illustrated in FIG. 28. According to the screen 350 illustrated in FIG. 28, the searcher is a member belonging to Company B. Here, for simplicity of the description, a comparison is made between examples of search results when the member belonging to Company A searches for a posted project and when the member belonging to Company B searches for the same posted project.

As is clear from the comparison of FIG. 27 and FIG. 28, the disclosure range of the educational content differs when the companies to which the searchers belong differ.

For example, in the list of posted projects illustrated in FIG. 27, only “C2-110” is displayed as the second-type content, for the required skill “S2-020” of Project 011. In contrast, in the list of posted projects illustrated in FIG. 28, “C2-111” is displayed in addition to “C2-110”.

In the list of posted projects illustrated in FIG. 27, “C1-051” is displayed as the first-type content associated with the basic skills for Project 012. In contrast, in the list of posted projects illustrated in FIG. 28, “C1-052” is displayed, in addition to “C1-051”.

In the list of posted projects illustrated in FIG. 27, the second-type content associated with the applied skills for Project 012 is set to “not disclosed”. In contrast, in the list of posted projects illustrated in FIG. 28, the second-type content associated with the applied skills is displayed.

In the list of posted projects illustrated in FIG. 27, the first-type content and the second-type content associated with the required skills for Project 013 are set to “not disclosed”. In contrast, in the list of posted projects illustrated in FIG. 28, the first-type content associated with the basic skills for Project 013 is displayed.

In this manner, according to this embodiment, it is possible to vary the disclosure range of the educational content, depending on a relationship between the searcher (applicant) and the requester.

### [Other Databases]

In the following, a description will be given of other databases adopted in the present embodiment, in addition to various types of databases 121 to 127 illustrated in FIG. 2.

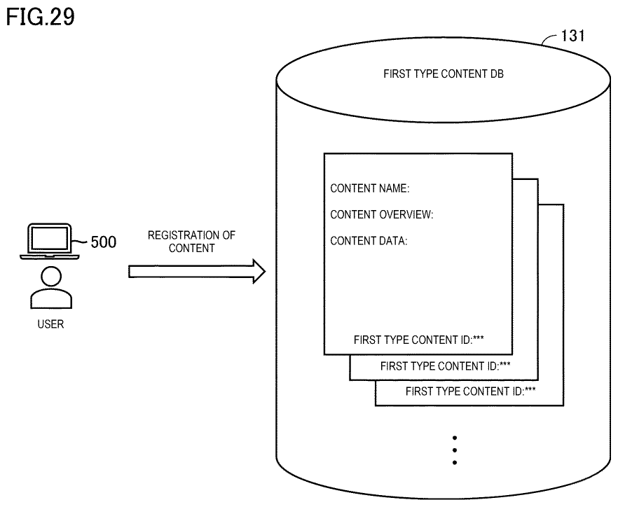

FIG. 29 is a diagram illustrating an example of a first-type content database 131. As illustrated in FIG. 29, first-type content information is registered for each first-type content ID in the first-type content database 131. The first-type content information includes a content name, information describing a content overview, and content data. The content data is a moving image, for example.

The first-type content is general-purpose educational content. Users can register first-type content in the first-type content database 131 using the user device 500. The first-type content may be registered in the first-type content database 131 by a vendor specialized in creation of educational content. The sharing server 100 may access a system of a vendor providing general-purpose content and provide users with the first-type content. In this case, instead of the content data, information that specifies a storage destination of the content data may be registered in the first-type content database 131.

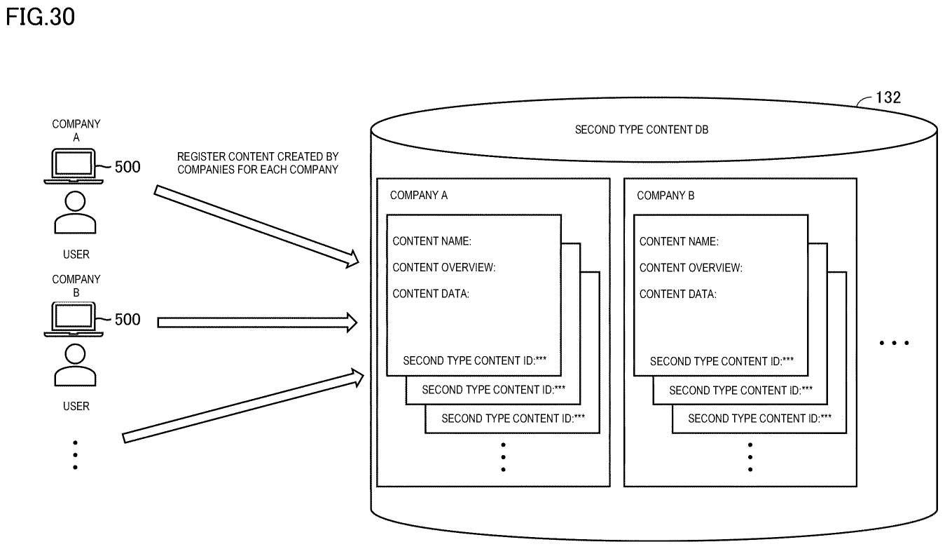

FIG. 30 is a diagram illustrating an example of a second-type content database 132. As illustrated in FIG. 30, second-type content information is registered for each second-type content ID in the second-type content database 132. The second-type content information includes a content name, information describing a content overview, and content data. The content data is a moving image, for example. Instead of the content data, information that specifies a storage destination of the content data may be registered in the second-type content database 132.

The second-type content is highly specialized educational content that each company creates by reflecting its advanced technological capabilities. Users of each company can register the second-type content in the second-type content database 132 using the user device 500. The second-type content information is classified and registered in the second-type content database 132 according to each company that has created the content.

The first-type content ID and the second-type content ID are examples of content information that can identify educational content related to posted projects. Furthermore, the first-type content ID and the second-type content ID are examples of the first-type content information and the second-type content information for registering educational levels of the educational content in a hierarchical manner in a database.

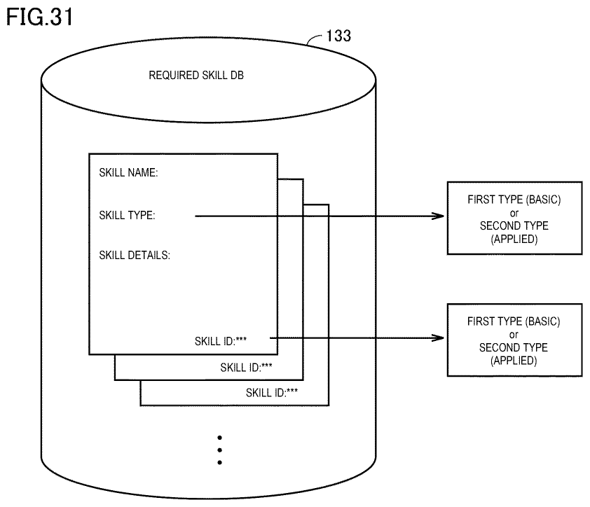

FIG. 31 is a diagram illustrating an example of a required skill database 133. As illustrated in FIG. 31, various skills are registered by skill ID in the required skill database 133. The registered information includes a skill name, a skill type, and information describing skill details.

A first-type skill or a second-type skill is specified as a skill type. The first-type skill means the basic skills. The second-type skill means the applied skills. The skill ID is an example of skill information that can identify skills necessary for the task of the posted project.

The skill ID is classified into a first-class ID and a second-class ID. The first-class ID corresponds to the first-type skill. The second-type ID corresponds to the second-type skill. The first type ID and the second-type ID are examples of first-type skill information and second-type skill information for registering levels of skills in a hierarchical manner in the required skill database 133 (database 120). The skill name and the skill details are displayed in Required Skills column in the list of posted projects.

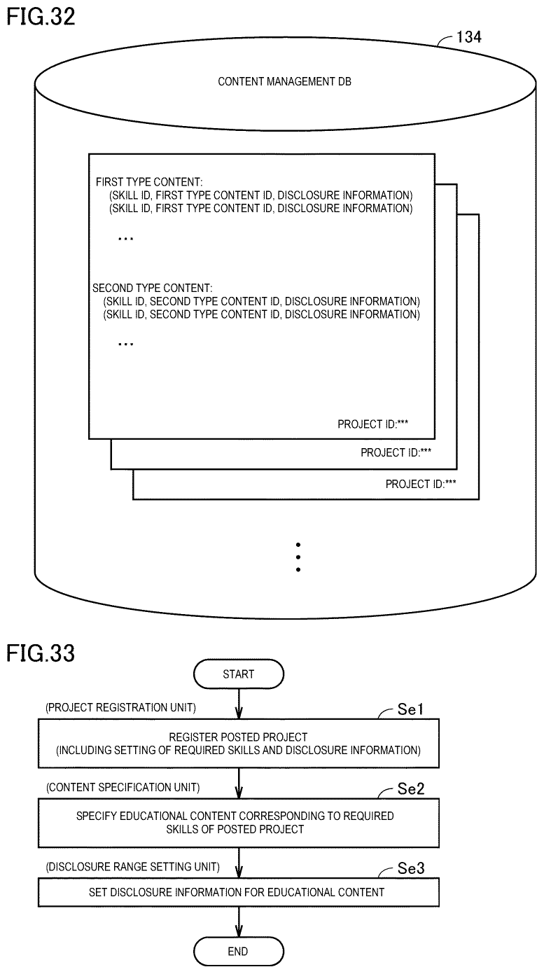

FIG. 32 is a diagram illustrating an example of a content management database 134. As illustrated in FIG. 32, in the content management database 134, content management information is registered for each project ID. The content management information includes information related to the first-type content and information related to the second-type content.

The information related to the first-type content includes a set of (the skill ID, the first-type content ID, and the disclosure information). The skill ID identifies the required skills included in the posted project. The first-type content ID identifies the first-type content associated with the skill ID. The disclosure information identifies the range of disclosing the first-type content. The skill ID associated with the first-type content ID is the first-type ID illustrated in FIG. 31. The sharing server 100 registers the first-type content information in the content management database 134, in association with the first-type ID, which is an example of the first-type skill information.

When a plurality of required skills is set for a posted project, the information related to the first-type content includes a set according to the number of the required skills. Even when a plurality of first-type content is associated with one required skill, the set according to the number of the first-type content is included in the information related to the first-type content.

The information related to the second-type content includes a set of (the skill ID, the second-type content ID, and the disclosure information). The skill ID identifies the required skills included in the posted project. The second-type content ID identifies the second-type content associated with the skill ID. The disclosure information identifies the range of disclosing the second-type content. The skill ID associated with the second-type content ID is the second-type ID illustrated in FIG. 31. The sharing server 100 registers the second-type content information in the content management database 134, in association with the second-type ID, which is an example of the second-type skill information.

When a plurality of required skills is set for a posted project, the information related to the second-type content includes a set according to the number of the required skills. Even when a plurality of second-type content is associated with one required skill, the set according to the number of the second-type content is included in the information related to the second-type content.

The sharing server 100 judges the disclosure ranges of the first-type content and the second-type content set for the posted project, by referring to the information registered in the content management database 134. The content management database 134 and the database 120 are examples of databases for registering content information that can identify educational content related to the posted projects, in association with the posted projects.

### [Description of Processing Procedure Related to Posted Projects and Educational Content]

Next, various processing procedures related to posted projects and educational content will be described with reference to FIGS. 33 to 37. FIG. 33 is a flowchart illustrating a processing procedure for registering a posted project together with educational content.

In the flowchart illustrated in FIG. 33, first, the sharing server 100 registers a posted project (step Se1). The processing of registering the posted project includes processing of setting the disclosure information and the required skills for the posted project. In step Se1, the sharing server 100 functions as a project registration unit.

Next, the sharing server 100 specifies educational content corresponding to the required skills of the posted project (step Se2). In step Se2, the sharing server 100 functions as a content specification unit.

Next, the sharing server 100 sets the disclosure information for the educational content (step Se3). In step Se3, the sharing server 100 functions as a disclosure range setting unit.

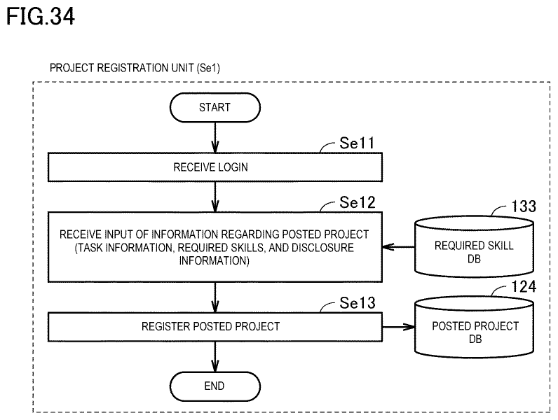

FIG. 34 is a flowchart illustrating a processing procedure of the project registration unit (Se1). First, the sharing server 100 receives user's login (step Se11). Then, the sharing server 100 receives input of information related to the posted project (step Se12). The information related to the posted project includes the task information, the required skills, and the disclosure information.

The user divides the required skills corresponding to the posted project into the “basic skills” and “applied skills”, and inputs them. When inputting the required skills, the user refers to the required skill database 133. The user inputs the disclosure information corresponding to the posted project. The input disclosure information sets the range of disclosing the posted project. The disclosure information input here is an example of the first disclosure information indicating the disclosure range of the posted project.

Next, the sharing server 100 registers the posted project in the posted project database 124, in accordance with the user's instructions (step Se13). At this time, the sharing server 100 registers, in the posted project database 124, the skill information that can identify the skills required for the task of the posted project, in association with the posted project. With the above, the processing of the project registration unit is terminated.

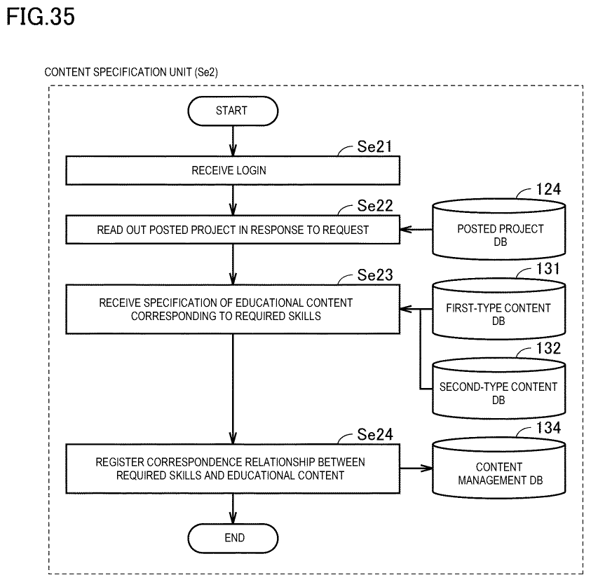

FIG. 35 is a flowchart illustrating a processing procedure of the content specification unit (Se2). First, the sharing server 100 receives user's login (step Se21). Then, the sharing server 100 reads out a posted project from the posted project database 124, in response to the user's request (step Se22).

Next, the sharing server 100 receives, from the user, specification of the educational content corresponding to the required skills (step Se23). At this time, the user refers to the first-type content database 131 and the second-type content database 132. The required skills are classified into the basic skills and the applied skills (See FIG. 24). With step Se23, the educational content corresponding to the basic skills and the educational content corresponding to the applied skills are set for each posted project.

Next, the sharing server 100 registers a correspondence relationship between the required skills and the educational content for each posted project in the content management database 134 (step Se24). With the above, the processing of the content specification unit is terminated.

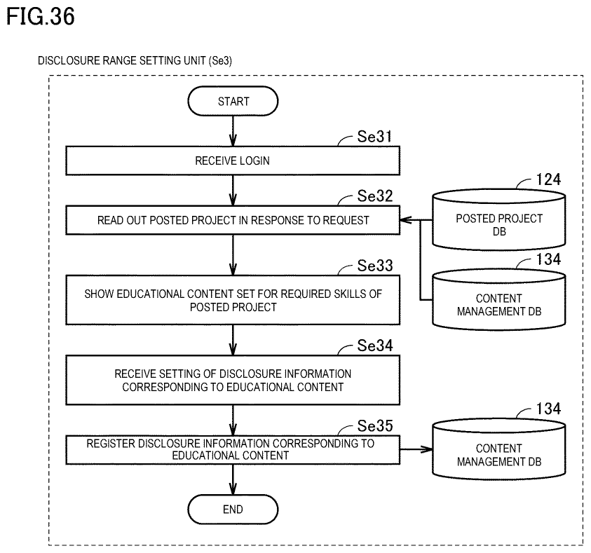

FIG. 36 is a flowchart illustrating a processing procedure of the disclosure range setting unit (Se3). First, the sharing server 100 receives a user's login (step Se31). Then, the sharing server 100 reads out a posted project from the posted project database 124, in response to the user's request (step Se32). At this time, the sharing server 100 reads out information for the educational content associated with the required skills of the posted project from the content management database 134.

Next, the sharing server 100 shows, to the user, the educational content set for the required skills of the posted project (step Se33). Then, the sharing server 100 receives setting of the disclosure information corresponding to the educational content from the user (step Se34). The disclosure information set here is an example of the second disclosure information indicating the disclosure range of the content information.

Next, the sharing server 100 registers the disclosure information corresponding to the educational content in the content management database 134 (step Se35). That is, the sharing server 100, which is an example of a computing device, registers, in a database, the second disclosure information indicating the disclosure range of the content information. With the above, the processing of the disclosure range setting unit is terminated.

As described above with reference to FIG. 34 to FIG. 36, the sharing server 100 receives, from the requester device 200, an operation to register task content of the posted projects, skills required for tasks of the posted projects, and the content information in a database (step Se12, step Se23).

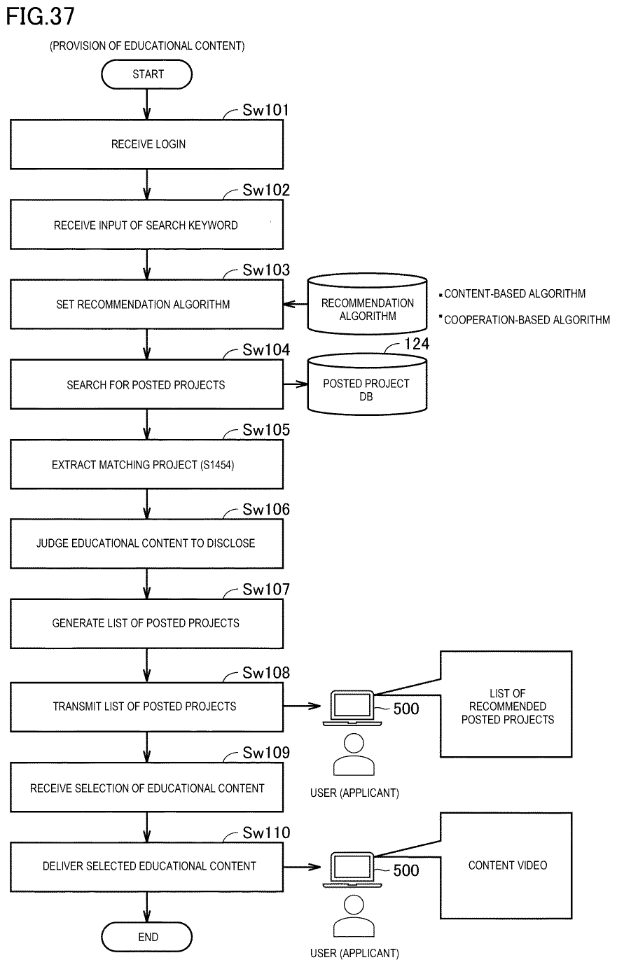

FIG. 37 is a flowchart illustrating a processing procedure for providing an applicant with educational content related to a posted project, in response to an operation by the applicant. First, the sharing server 100 receives a user's login (step Sw101). Then, the sharing server 100, then the sharing server 100 receives input of a search keyword from the user (step Sw102). That is, the computing device receives an instruction to search for the posted project from the applicant device 300.

Next, the sharing server 100 sets the recommendation algorithm (step Sw103). The recommendation algorithm extracts matching projects recommended to the user. The recommendation algorithm includes, for example, a content-based algorithm generated based on content-based filtering and a cooperation-based algorithm generated based on cooperation filtering.

When the content-based algorithm is set, the sharing server 100 calculates content algorithm priority by inputting user-specific characteristics (affiliation, skills, age, and the like) into the content-based algorithm, and reflects a calculation result in the processing of extracting matching projects. When the cooperation-based algorithm is set, the sharing server 100 calculates cooperative algorithm priority by inputting user-specific action histories (project viewing history, the search history, and the like) into the cooperation-based algorithm, and reflects a calculation result in the processing of extracting matching projects.

Next, the sharing server 100 searches for posted projects based on the set recommendation algorithm (step Sw104). Then, the sharing server 100 extracts matching projects from the posted project database 124 (step Sw105). Step Sw105 is an example of processing of judging, based on the first disclosure information, posted projects allowed to be disclosed to applicants, among the posted projects registered in the database. Details of this processing have already been described as step S1454.

Next, the sharing server 100 judges, based on the disclosure information, educational content to disclose to the user (applicant), from among the educational content associated with each of the matching projects (step Sw106). The disclosure information used here in the judgment is an example of the second disclosure information that indicates the disclosure range of the content information. Step Sw106 is an example of processing of judging, based on the second disclosure information, the content information allowed to be disclosed to the applicant, from among the content information registered in the database.

Next, the sharing server 100 generates the list of posted projects based on the judgment result in step Sw106 and the matching projects (step Sw107). Then, the sharing server 100 transmits the generated list of posted projects to the user (applicant) (step Sw108).

As a result, the list of recommended posted projects is displayed on the applicant device 300. That is, the sharing server 100, which is an example of the computing device, displays, on the user device 500 (applicant device 300), the posted projects allowed to be disclosed to applicants. In addition, the sharing server 100, which is an example of the computing device, displays the content information together with the posted projects on the user device 500 (applicant device 300). The generation of the list of recommended posted projects (FIG. 27) is not a generic display of information. The processor 101 is specially programmed to execute a multi-step process (FIG. 37) that involves first extracting matching projects based on a recommendation algorithm (Sw105), and then, in a subsequent step, judging which specific educational content to disclose for each of those projects based on separate disclosure information (Sw106). The resulting graphical user interface is a technical improvement as it is a customized data object generated from multiple, disparate database sources and permission levels, which could not be generated by a conventional computer without the specific architecture and methods disclosed herein.

Next, the sharing server 100 receives selection of the educational content from the user (applicant) (step Sw109). Then, the sharing server 100 delivers the selected educational content to the user (applicant) (step Sw110). As a result, the educational content is displayed on the applicant device 300.

As described above, according to the matching system 1 according to this embodiment, learning content useful for acquiring the required skills and the basic skills is displayed to the applicant for each of the posted projects. Therefore, it is possible to prevent the inadequacy of skills of those who plan to utilize a matching system as an applicant from becoming an obstacle to their plans.

Even if employees are given opportunities to be educated regarding the knowledge level, employees' motivation to learn cannot be enhanced unless it is clearly specified “what skills are required for what purposes”. The employees' motivation to learn can be enhanced only when the employees are given opportunities that allow them to utilize, in their tasks, the knowledge they have acquired through education. According to the matching system 1 according to this embodiment, it also becomes possible to provide the employees with an environment for practical education. Consequently, the employees' motivation to learn can be enhanced.

From such a perspective, posted projects registered in the matching system 1 do not have to be projects that are premised on contractors being rewarded. Posted projects that are positioned as educational materials may be registered.

In the matching system 1 according to this embodiment, the highly specialized educational content that reflects advanced technological capabilities is registered in the second-type content database 132. Each company often creates educational content, such as highly specialized and high-quality training materials, for the purpose of in-house education. Types of the educational content thus created cover a broad range from technical materials, materials related to quality control, materials related to the field of intellectual properties, and the like. Such educational content can be effectively utilized by registering the educational content created at the company in the second-type content database 132. Moreover, in this embodiment, the company can set the disclosure range of the educational content. This can prevent a company that provides educational content from suffering disadvantages due to the educational content being viewed by the rival companies.

In order to find more suitable human resources through crowdsourcing, it is desirable to further extend the range of crowdsourcing rather than limiting the range within a specific company or within a small number of companies. In this case, there arises a need to consider interests between requesters who solicit a contractor of a task and applicants who apply for the solicited task. In the present embodiment, the requester device 200 transmits, to the sharing server 100, the posted project and the disclosure information indicating the disclosure range of the posted information. The sharing server 100 registers the posted information together with the disclosure information in the database 120. The sharing server 100 judges on the posted information that is permitted to be disclosed to the applicants among the posted information registered in the database 120 based on the disclosure information, and provides the applicant device 300 with the posted information that is permitted to be disclosed to the applicants. Therefore, according to the present embodiment, it is possible to select appropriate applicants in consideration of the interests between the requesters and the applicants. Conventional database systems are not configured to efficiently manage and serve data based on multiple, independent, and dynamically changing sets of disclosure rules (e.g., one for posted projects, another for associated educational content). The disclosed system, by utilizing a content management database 134 that links project IDs to skill IDs, content IDs, and distinct disclosure information, provides a specific, unconventional data structure. This structure enables the sharing server 100 to perform a single, optimized query that simultaneously filters projects and their associated content based on user-specific viewing permissions. This reduces server load, minimizes data transmission to the applicant device 300 and results in a faster and more responsive user interface, thereby representing a specific improvement in computer networking and data management.

In the present embodiment described above, “groups by company” and “groups by department within the same company” are examples of a “group”. Applicants who do not belong to a company, such as freelancers, may form one “group”. A “company group” may be formed of a plurality of companies.

In the present embodiment, “companies forming a community relationship” is an example of a “community group”.

In the present embodiment, information included in the “non-disclosure target” included in the disclosure information is an example of the “information capable of identifying a target party to which disclosure of the task information is prohibited”.

A communication for transmitting approval information from the applicant device 300 of the supervisor who serves as the approver to the approval unit 147 (S9 in FIG. 11) is performed on a logical communication path identified by the member ID of that approver. “The approval unit 147 receiving the approval information on such a communication path” is an example of “receiving an approval notice in a communication involving the identification information of the approver of the first applicant”.

In the present embodiment, the “applicant evaluation summary” registered in the evaluation summary database 127 is an example of the “evaluation information based on the evaluation received from the requester device 200 that functions as the evaluator device”. In the present embodiment, the “requester evaluation summary” registered in the evaluation summary database 127 is an example of the “evaluation information based on the evaluation received from the applicant device 300 that functions as the evaluator device”.

FIG. 9 merely illustrates an example of the data registered in the evaluation summary database 127. In the present embodiment, it is also assumed that the member belonging to Company A, in the position of the applicant, evaluates members who belong to Companies A, B, C, . . . and behave as the requester. In the present embodiment, it is also assumed that the member belonging to Company B, in the position of the applicant, evaluates members who belong to Companies A, B, C, . . . and behave as the requester. In the present embodiment, it is also assumed that the member belonging to Company A, in the position of the requester, evaluates members who belong to Companies A, B, C, . . . and behave as the applicant. In the present embodiment, it is also assumed that the member belonging to Company B, in the position of the requester, evaluates members who belong to Companies A, B, C, . . . and behave as the applicant.

In the present embodiment, the “requester device 200A” operated by the requester belonging to Company A functions as the evaluator device, and is an example of a “first evaluator device (first evaluation device on the posting side) operated by one or more evaluators belonging to the first group”. In the present embodiment, the “applicant device 300A” operated by the applicant belonging to Company A functions as the evaluator device, and is an example of the “first evaluator device (first evaluation device on the applying side) operated by one or more evaluators belonging to the first group”.

In the present embodiment, the “requester device 200B” operated by the requester belonging to Company B functions as the evaluator device, and is an example of a “second evaluator device (second evaluation device on the posting side) operated by one or more evaluators who belong to the second group that is different from the first group”. In the present embodiment, the “applicant device 300B” operated by the applicant belonging to Company B functions as the evaluator device, and is an example of the “second evaluator device (second evaluation device on the posting side) operated by one or more evaluators who belong to the second group that is different from the first group”.

FIG. 21 exemplarily illustrates System Department and Planning Department as departments of Company B. In the present embodiment, “one of System Department and Planning Department” is an example of a “first divided group” included in the first group, and the other is an example of a “second divided group” included in the first group.

The sharing server 100 extracts, from the list of the posted project database 124, the task information for which the applicant's working hours do not exceed the upper limit of hours, based on the estimated man-hour registered in the posted project database 124, the upper limit of side job hours registered in the company database 121, the actual side job hours registered in the side job database 125, and the expected side job hours registered in the side job database 125. Specifically, for example, when the applicant is engaged in a plurality of side jobs, the sharing server 100 calculates a total value of the actual side job hours corresponding to each of the side jobs to determine the total actual side job hours, and calculates a total value of the estimated side job hours corresponding to each of the side jobs to determine the total expected side job hours.

The sharing server 100 adds the determined total actual side job hours and the total expected side job hours to determine the total side job hours. The sharing server 100 determines the applicant's available hours for side job by subtracting the total actual side job hours from the applicant's upper limit of side job hours. The sharing server 100 searches the list of the posted project database 124 for a project that can be handled with the determined available hours for side job.

At this time, the sharing server 100 calculates hours necessary for handling each posted project based on the estimated man-hour in the posted project database 124, and searches for a posted project that falls within the range of the available hours for side job. Here, the “upper limit of side job hours” is an example of the “upper limit of hours that are the upper limit of the applicant's working hours”, the “actual side job hours” are an example of the “actual hours that are hours the applicant has already spent on actual working”, and the “expected side job hours” are an example of the “expected hours that the applicant is expected to spend on working”. The upper limit of hours may be hours for which the upper limit is set not only on side jobs, but also on the total hours of main job hours and side job hours.

A first upper limit of hours is not the upper limit of side job hours, but may be the upper limit of hours for all tasks including main jobs and side jobs. The first actual hours and the first expected hours may be the total hours of all tasks including not only side job hours but also the combined hours of the main job and the side job.

The requester device 200 and the applicant device 300 may be not only devices provided with all of the processor, the memory, the communication interface, and the input/output interface illustrated in FIG. 2, but also a thin client system that utilizes VDI (Virtual Desktop Infrastructure), or the like. A thin client system utilizing the VDI is a system utilizing a desktop environment that is transferred from a server to a terminal on a remote location. The requester device 200, the applicant device 300, and the sharing server 100 do not necessarily need to be independent devices. When a thin client system such as the above is utilized, it is possible to provide the functions of the requester device 200, the applicant device 300, and the sharing server 100 on the same aggregation server.

The database 120 is not limited to a relational database, and a database of an object type or NoSQL type, or the like, may be utilized.

The sharing server 100 is an example of a computing device. A computing device may include a server (an on-premise server, a cloud server, or the like), a serverless system, or the like. Here, an on-premise server is a server installed and managed in facilities managed within its own company. A cloud server is a server (a rented server) provided by another operator via a network. A serverless system is a system in which computing/memory functions can be used only when necessary, without being aware of the existence of a server. Computing devices include servers and serverless systems. Servers include on-premise servers and cloud servers.

### Modification Example 1

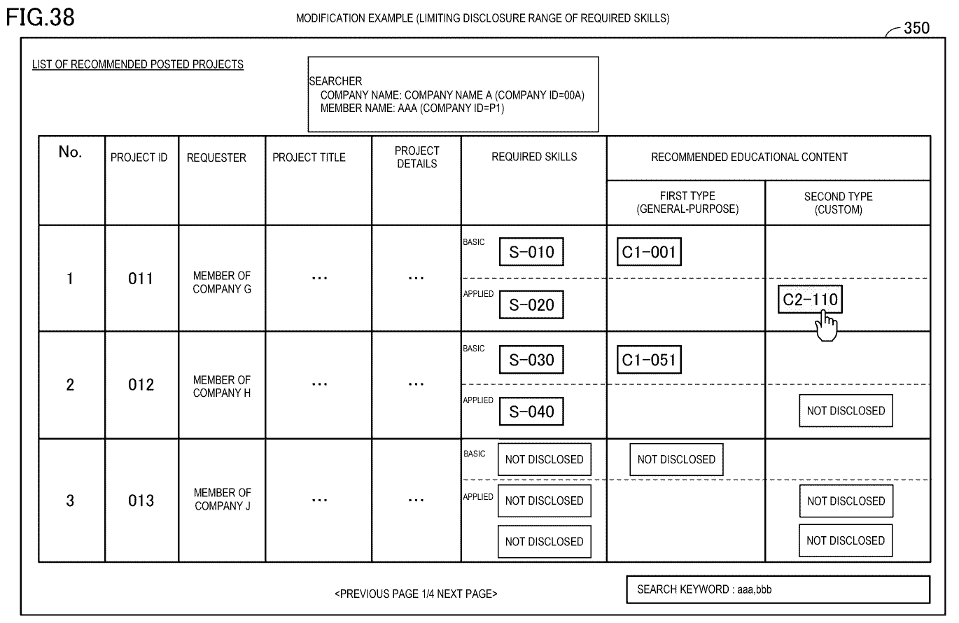

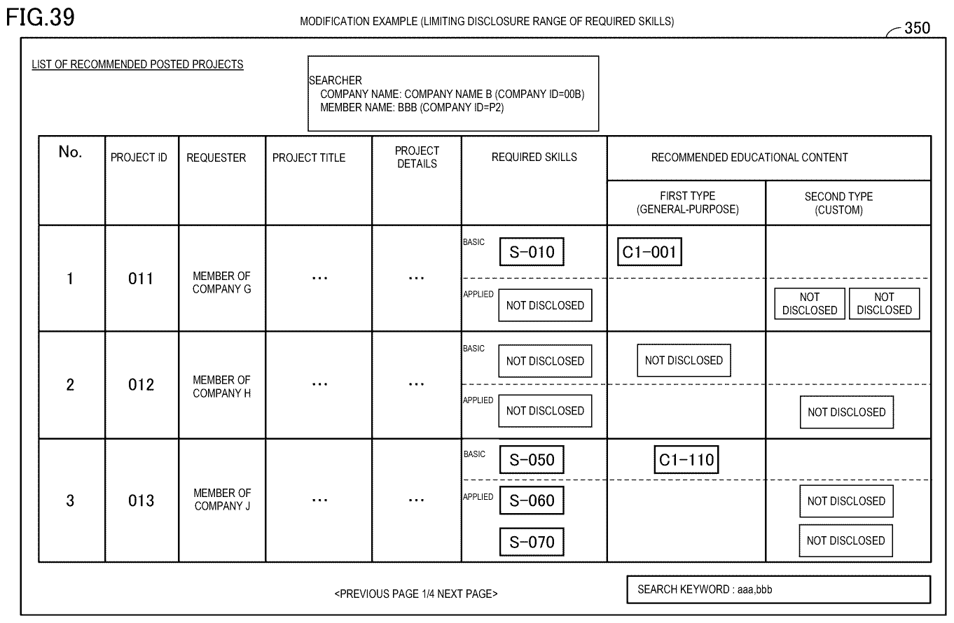

Next, Modification Example 1 will be described with reference to FIG. 38 and FIG. 39. FIG. 38 is a diagram illustrating a display example of a list of posted projects according to Modification Example 1. FIG. 39 is a diagram illustrating another display example of the list of posted projects according to Modification Example 1.

In the embodiment described above, the example is illustrated in which the disclosure ranges of the posted projects and the educational content are set based on the disclosure information. However, the matching system 1 may be configured such that the disclosure range of the required skills set for the posted projects can also be set based on the disclosure information.

FIG. 38 and FIG. 39 illustrate an example in which the disclosure range of the required skills is further restricted in the list of posted projects illustrated in FIG. 27 and FIG. 29.

For example, in the list of posted projects illustrated in FIG. 38, “S1-110” and “S2-020” are displayed as the required skills for Project 011. In contrast, “S2-020” is set to non-disclosure in the list of posted projects illustrated in FIG. 39.

In the list of posted projects illustrated in FIG. 38, “S1-030” and “S2-040” are displayed as the required skills for Project 012. In contrast, the required skills for Project 012 are set to non-disclosure in the list of posted projects illustrated in FIG. 39.

In the list of posted projects illustrated in FIG. 38, the required skills for Project 013 are set to non-disclosure. In contrast, the required skills for Project 013 are disclosed in the list of posted projects illustrated in FIG. 39.

In this manner, by making it possible to set the disclosure range of the required skills, the matching system 1 can be provided that can respond to needs of companies that can allow content of posted projects to be disclosed, but wish to refrain from disclosing educational content and required skills.

### Modification Example 2

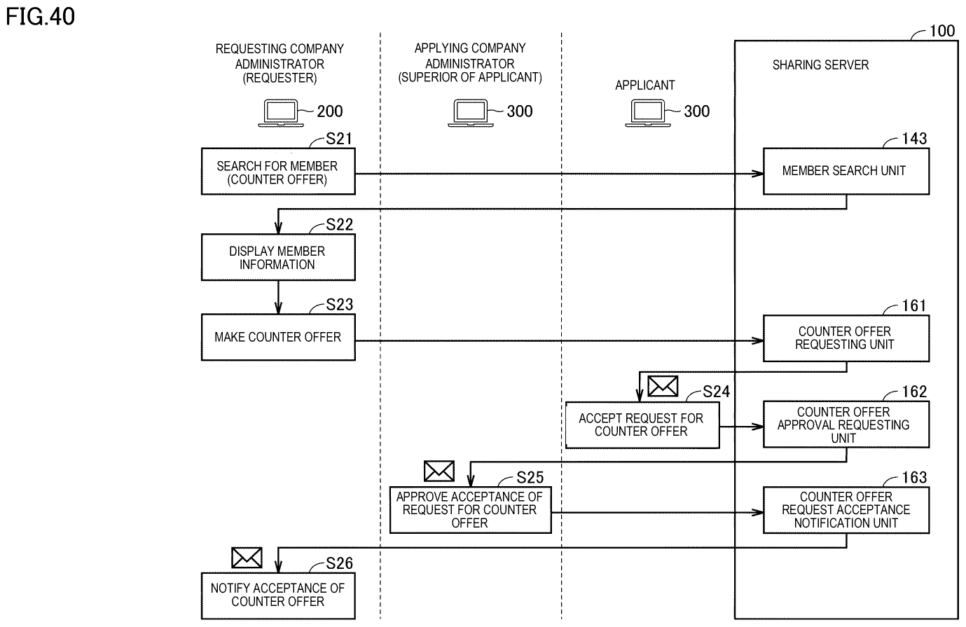

Next, with reference to FIG. 40 to FIG. 42, Modification Example 2 will be described. In Modification Example 2, a counter offer function is described that allows a requester to encourage those selected from a large number of members to solicit a posted task.

### [Background for Proposing Counter Offer Function]

In crowdsourcing, a requester generally discloses information on a posted project, and waits for applications from those who are interested in contents of the posted project. In such a posting method, however, it may take time to receive a response from applicants. In addition, it is unknown whether or not those who have skills expected by the requester apply.

Then, it is conceivable that the requester searches for members and nominates suitable members (counter offer). However, in a situation in which the requester is informed of only member IDs and member names, it is difficult for the requester to nominate an applicant the requester truly desires. In addition, in order to prevent confidential information from leaking to companies, or the like, in a competitive relationship, member information of the companies in a competitive relationship must be excluded from search results.

In Modification Example 2, considering such a background, the requester who performed the member search is provided with search results including detailed member profile information. Furthermore, in Modification Example 2, the member information of the companies, or the like, in a competitive relationship with the company to which the requester belongs, or the like, is excluded from the search results. In the following, Modification Example 2 will be described in detail with reference to the drawings.

FIG. 40 is a diagram for explaining the functions of a sharing server 100, a requester device 200, and an applicant device 300 according to Modification Example 2.

As illustrated in FIG. 40, in addition to a member search unit 143, the sharing server 100 functionally includes a counter offer request unit 161, a counter offer approval request unit 162, and a counter offer request acceptance notification unit 163. These various types of functions are realized by the processor 101, the memory 102, the storage 103, and the communication interface 104 that the sharing server 100 includes.

As already described, the member search unit 143 includes a function to search for members of a matching system 1. In Modification Example 2, in particular, the member search unit 143 includes a function to provide a searcher with detailed member profile information. When receiving a search operation from a requester, a requester device 200 performs member search processing (step S21). In step S21, in particular, the requester device 200 receives the search operation for the requester to make a counter offer. The member search unit 143 provides the requester device 200 with information on members registered in a member database 122. The provided member information includes the detailed member profile information. However, the member search unit 143 excludes information on members of companies, or the like, that are in a competitive relationship to the company to which the requester belongs.

The requester device 200 receives the member information (search result) from the member search unit 143, and displays the member information as the search result on a display 205 (step S22). Then, the requester device 200 receives an operation for the requester to select an applicant from the search result. That is, the requester selects members to whom a counter offer is made based on the search result, and makes a counter offer by operating the requester device 200 (step S23). The requester device 200 transmits, to the sharing server 100, a member ID of a member who is a target of the counter offer.

The counter offer request unit 161 receives, from the requester device 200, the member ID of the member who is a target of the counter offer. The counter offer request unit 161 identifies the member corresponding to the received member ID. The counter offer request unit 161 notifies an applicant device 300 of the member who is the target of the counter offer that a counter offer request has been received. Information on a posted project, which is a target of the counter offer, may be included in this notice. The member who is the target of the counter offer receives a request for counter offer from the applicant device 300. The “request” received here is an example of “information encouraging applicants to apply”. The member who is the target of the counter offer determines whether or not to accept the request for counter offer. The member who is the target of the counter offer can perform an operation to accept the request for counter offer or an operation to reject the request for counter offer, using the applicant device 300. The applicant device 300 accepts the request for counter offer, for example (step S24). The applicant device 300 that has accepted the request for counter offer transmits application information to the counter offer approval request unit 162.

The counter offer approval request unit 162 transmits, to a superior of the applicant, his/her subordinate's application information. The counter offer approval request unit 162 identifies a member ID of the superior, who is a supervisor of the applicant, based on a relationship between the applicant's member ID and the superior's member ID that are registered in the member database 122. The superior of the applicant checks the application information at his/her own applicant device 300, and approves the application (step S25).

The counter offer request acceptance notification unit 163 receives approval information from the superior of the applicant. The counter offer request acceptance notification unit 163 receives the applicant's application on the condition that the approval information has been received. The counter offer request acceptance notification unit 163 notifies the requester device 200 that the application from the applicant to whom the counter offer was made has been received. The requester device 200 notifies the requester that the counter offer has been accepted, based on that notice (step S26). More specifically, the requester device 200 displays, on the display 205, information notifying the requester that the counter offer has been accepted.

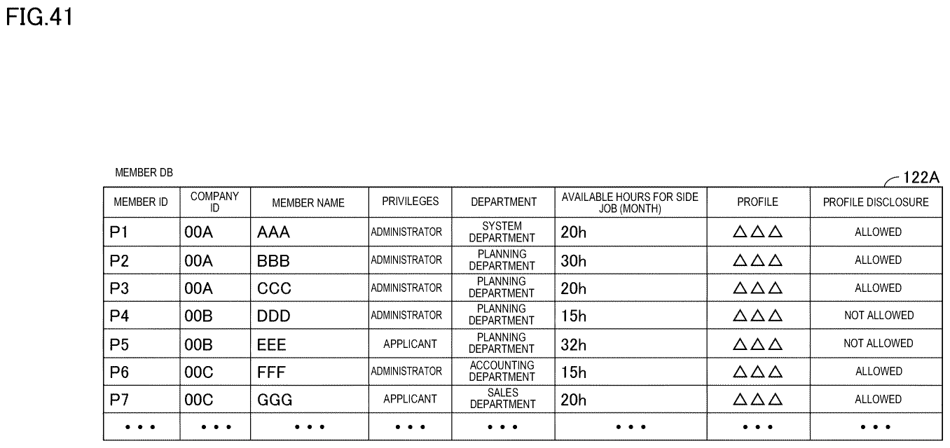

FIG. 41 is a diagram illustrating an example of a member database 122A according to Modification Example 2. When compared to the member database 122 illustrated in FIG. 4, profile information and profile disclosure information indicating whether or not to disclose profiles are added to the member database 122A illustrated in FIG. 41.

The matching system 1 provides members with a privilege that enables the members to register and modify their own profile information in the member database 122A, using the applicant device 300. The members use the applicant device 300 to register their various profile information in the member database 122A. The profile information includes, for example, information on SPI (Synthetic Personality Inventory) of members, members' work histories, members' performance, qualifications possessed by members, and the like.

The member sets the profile disclosure information, using the applicant device 300. The profile information of a member for whom the profile disclosure information is set to “allowed” is provided to a searcher. The profile information of a member for whom the profile disclosure information is set to “not allowed” is not provided to a searcher. The sharing server 100 registers the profile disclosure information in the member database 122A based on the setting selected by each of the members. In this manner, the sharing server 100 receives, from each of a plurality of the members, input of the information indicating whether or not the members permit their profile information to be included in search results.

Here, an example has been described in which it is determined whether or not disclosure of the members' profile information is permitted based on the setting of the profile disclosure information. However, the sharing server 100 may receive an operation to set whether to permit disclosure according to the type of the profile information. This enables, for example, the members to set the SPI information as a non-disclosure target, while setting performance and possessed qualifications as disclosure targets. Alternatively, if age is included in the profile information, the members can set the age as a non-disclosure target, and set the profile information other than the age as disclosure targets. In this case, the sharing server 100 registers a plurality of pieces of profile information of each of a plurality of registered persons (member) in the member database 122A. The sharing server 100 receives, from each of the plurality of registered persons, input for setting a range of the plurality of pieces of profile information to be disclosed as search results.

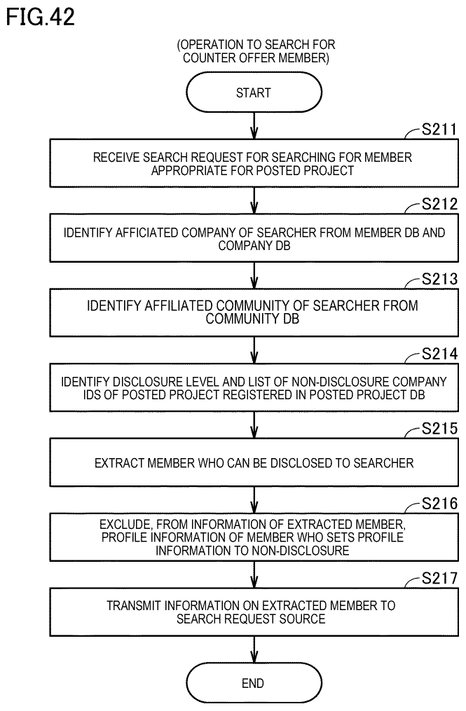

FIG. 42 is a flowchart illustrating a processing procedure of counter offer member search processing according to Modification Example 2. The processing based on this flowchart is performed by the sharing server 100.

First, the sharing server 100 receives a search request for a searcher to search for members appropriate for a posted project (step S211). Here, the searcher is a requester having a posted project. The requester searches for members using his/her own requester device 200, in order to make a counter offer to members who have skills appropriate for the posted project. In step S211, the requester's search request is received by the sharing server 100. The search request may include the searcher's member ID and a project ID of the posted project.

Next, the sharing server 100 identifies a company to which the searcher belongs, from the member database 122A and a company database 121 (step S212). Next, the sharing server 100 identifies a community to which the searcher belongs, from a community database 123 (step S213).

Next, the sharing server 100 identifies a disclosure level and a list of non-disclosure company IDs registered in a posted project database 124 (step S214). Next, the sharing server 100 extracts members who can be disclosed to the searcher (step S215).

More specifically, the sharing server 100 identifies companies to which the posted project held by the searcher (requester) should not be disclosed, based on a non-disclosure company list and the disclosure level in the posted project database 124. The sharing server 100 judges members belonging to such companies as members that cannot be disclosed to the searcher. The sharing server 100 extracts members other than the members belonging to such companies, as members that can be disclosed to the searcher.

Next, the sharing server 100 refers to the member database 122A to exclude, from the extracted member information, profile information of the members who set the profile information to non-disclosure (step S216).

Next, the sharing server 100 transmits the extracted member information to a search request source (step S217), and terminates the processing based on this flowchart. The requester device 200, which is the search request source, receives the member information transmitted from the sharing server 100, and displays that information on the display 205. The information displayed on the display 205 includes an ID, a name, and profile information of each extracted member. However, for the members who set their profile information to non-disclosure, only a company ID and a name are displayed, and the profile information is not displayed.

As described above, according to Modification Example 2, the requester searches for a member who is considered most appropriate for application for the posted task referring to the member's detailed profile information, and can make a counter offer to the member. However, members of the company to which the requester belongs and members of companies that are in a competitive relationship with a community are excluded from the members displayed as search results. This makes it possible to prevent any inconvenience that the requester places an order for the task to the members of such rival companies. Furthermore, members themselves can decide whether or not to disclose their profile information, so that a system can be provided in which a free will of each member is respected.

Note that members may be allowed to set whether or not to disclose their names, in addition to the profile information. In addition, the profile information may be provided with several categories, and the members may be allowed to set whether or not to disclose the profile information for each category.

By adding the offer function described above to the matching system 1, the requester can check the profile information of the members who are permitted to view the posted project. Furthermore, the requester can encourage a member with whom the requester himself/herself wishes to place an order to apply. In addition, the member encouraged by the requester to apply can view the project information, and accept and reject the application. In addition, each of the members can decide whether or not to disclose the profile information, when registering and editing the member information, or the like. This enables the requester to actively select who to offer to, and have the most appropriate applicant engaged in the task early.

### Modification Example 3

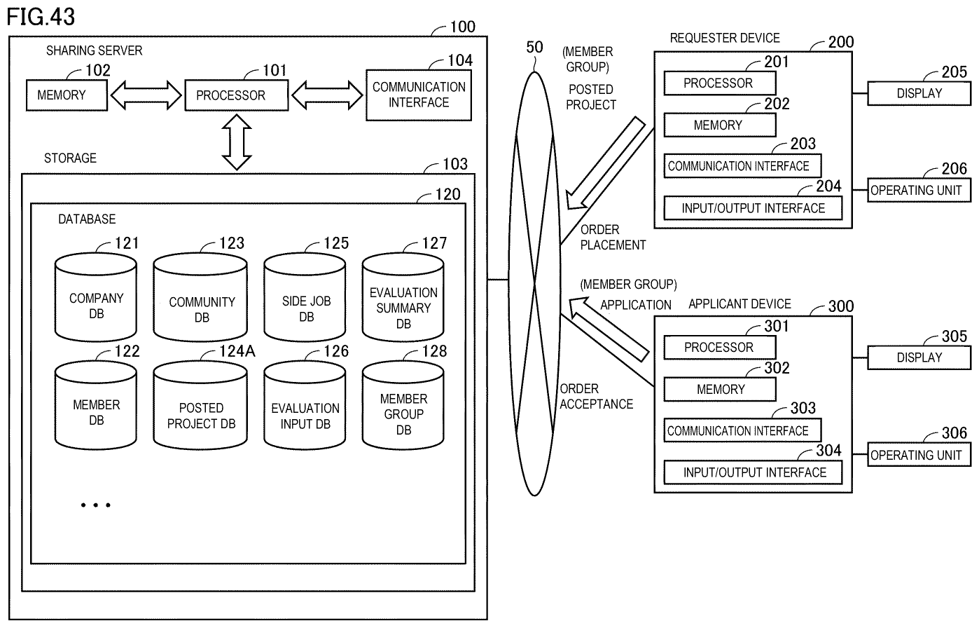

Next, Modification Example 3 will be described with reference to FIG. 43 to FIG. 47. In Modification Example 3, a member group application function is described that allows a plurality of members to apply for a posted task as a group.

### [Background of Proposing Member Group Application Function]

In crowdsourcing, the requester generally discloses information of a posted project, and waits for applications from those who are interested in contents of the posted project. However, there are not a few projects that should be handled by a team of several persons or projects that are desirably handled by a team, such as comprehensive tasks from business planning to acquisition of an intellectual property right related to the planning. Therefore, if the number of solicited members is limited to one person, it is difficult for a person who wishes to accept an order to undertake a task volume of which is more than a task that he/she can handle individually.

In Modification Example 3, considering such a background, the member group application function is provided that allows a plurality of members to apply for a posted task as a group. Modification Example 3 will be described below in detail.

FIG. 43 is a block diagram illustrating configurations of a sharing server 100, a requester device 200, and an applicant device 300 according to Modification Example 3. In the block diagram illustrated in FIG. 43, a member group database 128 is added compared with the block diagram illustrated in FIG. 2. Relative to the posted project database 124 illustrated in FIG. 6, a function to register posted projects that allow application as a member group is added to a posted project database 124A illustrated in FIG. 43.

Member groups including a plurality of members are registered in the member group database 128. Using a requester device 200, a requester can register, in the posted project database 124A, posted projects that allow application by a member group. Using an applicant device 300, applicants can apply, as a member group registered in the member group database 128, for the posted projects that allow application by a member group.

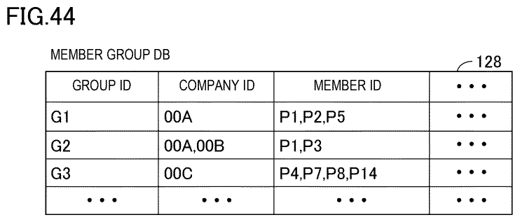

FIG. 44 is a diagram illustrating an example of the member group database 128 according to Modification Example 3. Member group information is registered in the member group database 128. The member group information includes a group ID for identifying a member group, a company ID of a company to which each member of a member group belongs, a member ID of each member of a member group, and the like. Hereinafter, using group IDs, member groups corresponding to each of the group IDs may be referred to as Member Group G1, Member Group G2, Member Group G3, . . . .

Member Group G1 includes three members identified by member IDs=P1, P2, and P5. Since the company ID registered corresponding to the Member Group G1 is 00A, it can be seen that all of the three members belong to Company A.

Member Group G2 includes two members identified by member IDs=P1 and P3. Since the company IDs registered corresponding to the Member Group G2 are 00A and 00B, it can be seen that one of the two members belongs to Company A, and the other belongs to Company B. As can be understood by comparing Member Group G1 with Member Group G2, the member ID=P1 is registered in both member groups G1 and G2. Therefore, Member P1 belongs to the two member groups.

Member Group G3 includes four members identified by member IDs=P4, P7, P8, and P14. Since the company ID registered corresponding to the Member Group G3 is 00C, it can be seen that all of the four members belong to Company C.

As illustrated in FIG. 43, the member group database 128 is stored in a storage 103 of a sharing server 100. Members form a member group with agreements with other members with whom they become acquainted in a same company or community, or the like, and register the member group in the member group database 128. A “member group” is an example of an “applicant group”.

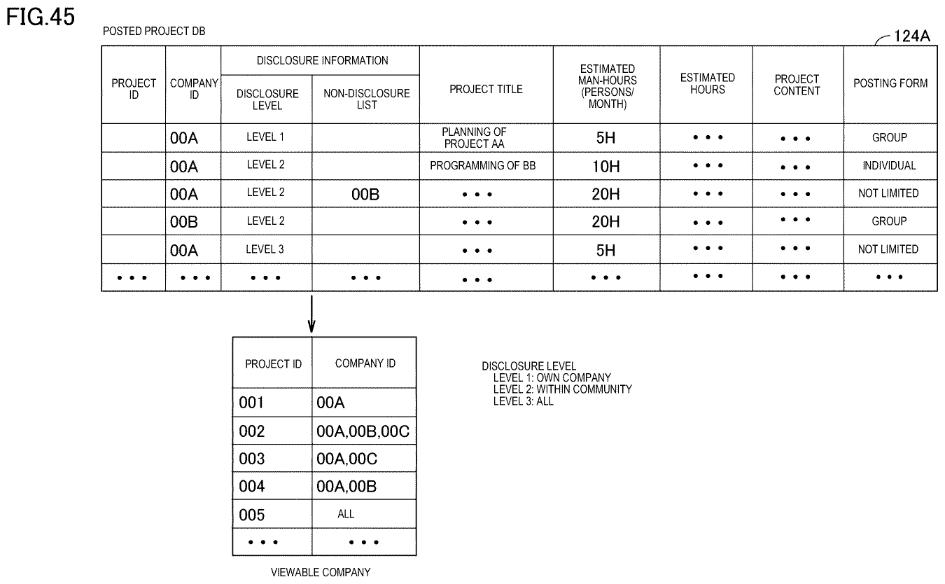

FIG. 45 is a diagram illustrating an example of the posted project database 124A according to Modification Example 3. When compared to the posted project database 124 illustrated in FIG. 6, posting form information is added to the posted project database 124A illustrated in FIG. 45. The requester operates the requester device 200 to set a posting form. The sharing server 100 associates a posting form based on the setting with task information, and registers the posting form in the posted project database 124A.

The requester can select a posting form from groups and individuals. If the requester does not select the posting form, it is considered that the posting form of the posted project is neither limited to groups nor individuals. A project with the posting form set to groups can only be accepted by member groups. A project with the posting form set to individuals can only be accepted by individual members. A project with no posting form restrictions can be accepted by both member groups and individuals. The “posting form information” is an example of “information capable of identifying that a task soliciting a contractor is a task that a plurality of requesters should jointly apply”.

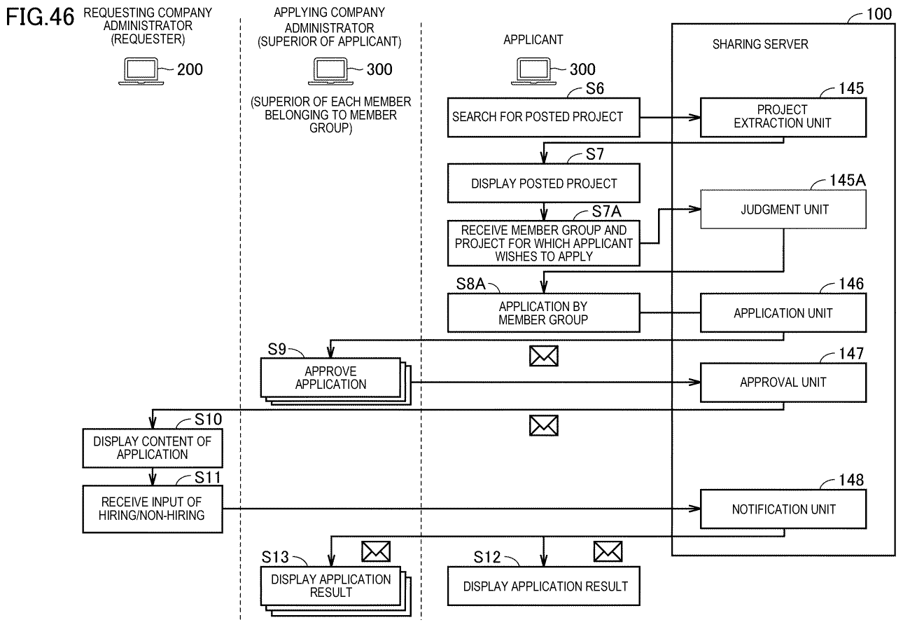

FIG. 46 is a diagram for explaining functions of the sharing server 100, the requester device 200, and the applicant device 300 according to Modification Example 3. In FIG. 46, a judgment unit 145A is added to the sharing server 100, as compared to FIG. 11. In addition, in FIG. 46, when compared to FIG. 11, step S7A is added after step S7 and step S8A of group allocation is adopted instead of step S8 of application.

Here, it is assumed that an applicant belongs to a plurality of member groups. The applicant operates the applicant device 300 to search for a posted project (step S6). The applicant device 300 transmits a search request to a project extraction unit 145 of the sharing server 100.

When receiving the search request, as illustrated with reference to FIG. 11, the project extraction unit 145 extracts the project allowed to be viewed by the applicant from posted projects registered in the posted project database 124. The projects extracted from the project extraction unit 145 include projects the posting form of which is set to any of “Group”, “Individual”, and “Not Limited”. The project extraction unit 145 transmits the extracted posted projects to the applicant device 300. The applicant device 300 receives the posted projects from the project extraction unit 145. The applicant device 300 displays the received posted projects on a display 305 (step S7).

For each of the posted projects, a disclosure level, a project title, estimated man-hour, an estimated period, project contents, the posting form, and the like are displayed on the display 305. If applicants wish to apply as a member group, the applicants specify a member group, using an operating unit 306 such as a mouse and a keyboard, or the like, and then, select a project for which the posting form is set to “Group” or “Not Limited”. The applicant device 300 receives the member group and the project for which the member group wishes to apply, based on applicants' operations (step S7A). The applicant device 300 transmits the group ID of the received member group and the project ID of the received project to the sharing server 100. The judgment unit 145A of the sharing server 100 acquires a group ID and a project ID.

The judgment unit 145A accesses the member group database 128 and identifies the member ID registered in association with the acquired group ID. The judgment unit 145A accesses the member database 122 and identifies the company ID in association with the identified member ID.

The judgment unit 145A accesses to a community database 123 and identifies a community ID of a community to which the company with the identified company ID belongs. The judgment unit 145A accesses the posted project database 124A and identifies the company ID (the requester's company ID), the non-disclosure company ID, the disclosure level, and the posting form registered in association with the acquired project ID.

Based on the identified information as described above, the judgment unit 145A judges whether or not the posted project received by the applicant device 300 is a project for which application by the member group specified by the applicants is allowed. In other words, the judgment unit 145a judges whether or not the application by member group is permitted.

For example, the judgment unit 145A does not permit the application by member group when one of the members in the member group belongs to a company listed in a list of non-disclosure company IDs associated with the posted project. Alternatively, the judgment unit 145A does not permit the application by member group when one of the members in the member group belongs to a company outside the community, even though the disclosure level of the posted project is set to “Within Community”.

The judgment unit 145A returns the judgment result to the applicant device 300. FIG. 46 illustrates a flow when the judgment unit 145A has permitted the application by member group. When the judgment unit 145A has permitted the application by member group, the applicant device 300 receives the application by member group (step S8A). For example, the applicant device 300 displays, on the display 305, a screen indicating that the application received in step S7A has been allowed and a screen for checking whether or not to apply. The applicant selects to apply, using the operating unit 306 such as a mouse and a keyboard, or the like.

When receiving the application by member group (step S8A), the applicant device 300 transmits application information to the sharing server 100. A submission unit 146 of the sharing server 100 acquires the application information. Contents of the subsequent processing are similar to the contents described with reference to FIG. 11. However, the submission unit 146 transmits the application information to a superior of each of the members belonging to the member group. Thus, the application approval processing of step S9 is performed for each superior of each member belonging to the member group. Therefore, an approval unit 147 received, from a plurality of the superiors, approval information indicating that he/she approves application of his/her subordinate or rejection information indicating that he/she rejects the application of his/her subordinate.

The approval unit 147 receives the applicants' application only in the case in which the approval information is obtained from all of the superiors of the respective members belonging to the member group. The approval unit 147 that has received the applicants' application transmits the application information to the requester device 200. As already described with reference to FIG. 11, the requester device 200 displays contents of the application on a display 205 (step S10). The requester inputs results of determination on hiring or non-hiring in the requester device 200. The requester device 200 receives the input results (step S11), and transmits the received result of hiring or non-hiring to a notification unit 148 of the sharing server 100.

The notification unit 148 transmits the application result (result of hiring or non-hiring) to the applicant's applicant device 300 and the applicant device 300 of the superior of the applicant (administrator). However, the notification unit 148 transmits the application result to the superiors of the respective members belonging to the member group.

The applicant's applicant device 300 and the applicant device 300 of the superior of each member belonging to the member group displays the application result on the display 305 (step S12 and step S13). The applicant and the superior of each member belonging to the member group confirms the application result by looking at the display on the display 305.

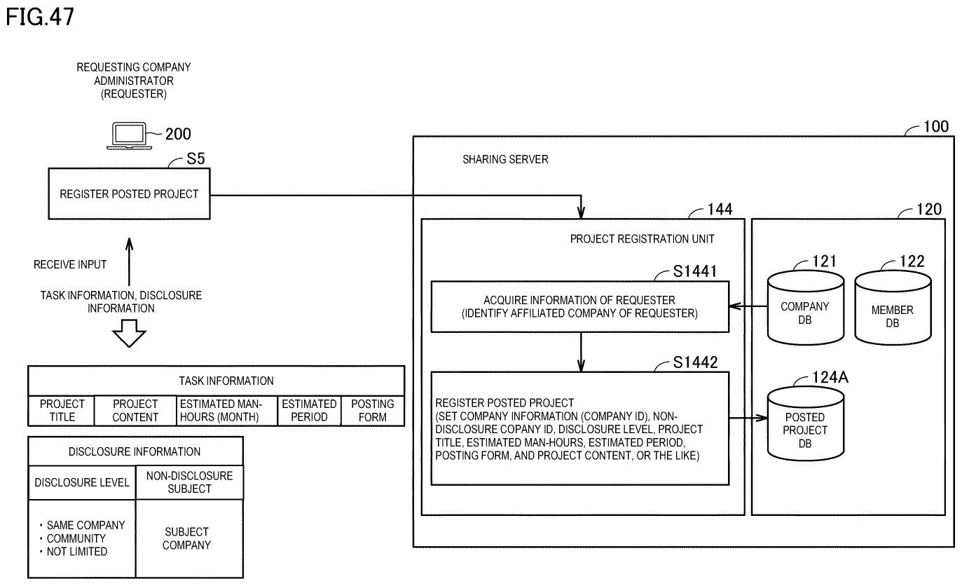

FIG. 47 is a diagram for explaining a procedure for registering a posted project in the posted project database 124A according to Modification Example 3. In FIG. 47, the posting form is added to the project information input into the requester device 200, as compared to FIG. 14.

In Modification Example 3, the requester that registers a posted project can include a posting form of the posted project in the task information, when inputting the task information and the disclosure information of the posted project in the requester device 200. The posting form is any of group or individual. A project registration unit 144 of the sharing server 100 registers the posted project including the posting form selected by the requester in the posted project database 124A (step S1442). When the requester does not select the posting form, the project registration unit 144 registers, in the posted project database 124A, information indicating that the posting form is not limited. Other contents illustrated in FIG. 47 are similar to FIG. 14 already described, and a description thereof is not repeated here.

As described above, according to Modification Example 3, a plurality of members can apply for a posted project as a group. Yet, according to Modification Example 3, it is judged whether or not the application by member group is allowed, based on a relationship between the company and the community to which the requester belongs and the company and the community to which each member of the member group belongs. This makes it possible to prevent a member group including members belonging to an organization that is in a competitive relationship with the applicant from accepting an order for the posted project of that applicant.

By adding the member group application function as described above to the matching system 1, it is possible to provide a system in which an order accepting party can view a posted project and apply for the posted project as a member group. This enables the matching system 1 to handle order placement and order acceptance of a large-scale task that is desirably tackled by a team.

The present embodiment described above includes configurations listed below:
(a) In a matching system, a requester device that is operated by a requester transmits, to a computing device, task information for soliciting a contractor and disclosure information indicating a disclosure range of the task information, the computing device registers the task information together with the disclosure information in a database, and the computing device judges, based on the disclosure information, task information, among the task information registered in the database, that is allowed to be disclosed to a first applicant, and provides the first applicant device with the task information that is allowed to be disclosed to the first applicant.
(b) In the matching system further including a second applicant device that is operated by a second applicant who is different from the first applicant, the computing device judges, based on the disclosure information, task information, among the task information registered in the database, that is allowed to be disclosed to the second applicant, and provides the second applicant device with the task information allowed to be disclosed to the second applicant.
(c) In the matching system, the matching system further includes a third applicant device operated by a third applicant who is different from the first applicant and the second applicant, a plurality of disclosure levels is set for the disclosure information, and the computing device judges whether or not to allow disclosure according to the disclosure level for each of the first applicant to the third applicant.
(d) In the matching system, the first applicant belongs to a first group, the second applicant belongs to a second group that is different from the first group, the plurality of disclosure levels includes a first level and a second level, the first level corresponds to allowing the task information to be disclosed to the first applicant and prohibiting the task information from being disclosed to an applicant who does not belong to the first group, and the second level corresponds to allowing the task information to be disclosed to an applicant who belongs to any of the first group and a community group that has formed a community relationship with the first group and prohibiting the task information from being disclosed to an applicant who does not belong to any of the first group and the community group.
(e) In the matching system, the first applicant belongs to the first group, the second applicant belongs to the second group that is different from the first group, the plurality of disclosure levels includes the first level, the second level, and a third level, the first level corresponds to allowing the task information to be disclosed to the first applicant and prohibiting the task information from being disclosed to the applicant who does not belong to the first group, the second level allows the task information to be disclosed to the applicant who belongs to any of the first group and the community group that has formed a community relationship with the first group, and the third level corresponds to allowing the task information to be disclosed to an applicant who belongs to the specific community group that is different from the first group and the community group of the second level that has formed a community relationship with the first group and prohibiting the task information from being disclosed to the applicant who does not belong to any of the first group and the specific community group.
(f) In the matching system, the plurality of disclosure levels includes a disclosure level that corresponds to allowing the task information to be disclosed to an applicant, irrespective of a group to which the applicant belongs.
(g) In the matching system, the database registers attribute data capable of identifying a community group, and the computing device identifies an applicant to whom the task information is allowed to be disclosed, based on the disclosure information and the attribute data.
(h) In the matching system, the requester device receives an operation to input a target group to which the task information is prohibited from being disclosed and transmits information capable of identifying the received target group to the computing device, and the computing device prohibits the task information from being disclosed to an applicant belonging to the target group even if the disclosure level is a level that allows the task information to be disclosed to the target group.
(i) In the matching system, the first applicant belongs to a first company and the second applicant belongs to a second company that is different from the first company.
(j) In the matching system, the computing device receives, from the requester device, a request to search for information on a plurality of registered persons registered in the database and provides the requester device with search results based on the received request, the requester device receives an operation to select by the requester, from the search results, an application-recommended person who is recommended to apply as an applicant and transmits identification information of the selected application-recommended person to the computing device, and the computing device transmits information for encouraging application to an applicant device of the selected application-recommended person.
(k) In the matching system, the computing device registers a plurality of pieces of profile information of each of the plurality of registered persons in the database, and the computing device receives, from each of the plurality of registered persons, input for setting a range of disclosure as search results among the plurality of pieces of profile information.
(l) In the matching system, the requester device transmits, to the computing device, posting form information capable of identifying whether a task soliciting a contractor is a group task that can be accepted when a plurality of applicants jointly apply, or a task that can be accepted for application by a single applicant, and the computing device registers the posting form information in the database in association with the task information.
(m) In the matching system, the computing device registers, in the database, an application group including a plurality of applicants, and the computing device can receive application from the application group for task information that is allowed to be disclosed to all applicants belonging to the application group.

### [Aspects]

In the following, aspects of the present disclosure are listed.

(Aspect 1) A matching system according to Aspect 1 is a matching system that matches a requester who solicits a contractor for a task with an applicant, the matching system including: a first applicant device operated by a first applicant; and a computing device that communicates with the first applicant device and is accessible to a database in which task information indicating content of a posted task is registered for each posted project, in which the computing device registers, in the database, content information that can identify educational content related to the posted project, in association with the posted project, and the computing device displays the content information together with the posted project on the first applicant device.

(Aspect 2) The matching system according to Aspect 1, in which the computing device registers, in the database, first disclosure information indicating a disclosure range of the posted project, the computing device judges, based on the first disclosure information, a posted project allowed to be disclosed to the first applicant, from among posted projects registered in the database, and the computing device displays, on the first applicant device, the posted project allowed to be disclosed to the first applicant.

(Aspect 3) The matching system according to Aspect 1 or 2, in which the computing device registers, in the database, second disclosure information indicating a disclosure range of the content information, the computing device judges, based on the second disclosure information, content information allowed to be disclosed to the first applicant, from among content information registered in the database, and the computing device displays, on the first applicant device, the content information allowed to be disclosed to the first applicant together with the posted project.

(Aspect 4) The matching system according to any one of Aspects 1 to 3, in which the computing device registers, in the database, skill information that can identify a skill required for a task of the posted project, in association with the posted project, and the computing device registers the content information in the database, in association with the skill information.

(Aspect 5) The matching system according to Aspect 4, in which the skill information includes first-type skill information and second-type skill information for registering levels of the skill in a hierarchical manner in the database, the content information includes first-type content information and second-type content information for registering educational levels of the educational content in a hierarchical manner in the database, and the computing device registers the first-type content information in the database in association with the first-type skill information, and registers the second-type content information in the database in association with the second-type skill information.

(Aspect 6) The matching system according to any one of Aspects 1 to 5, in which the computing device receives an instruction to search for the posted project from the first applicant device, and when receiving the instruction to search, the computing device extracts the posted project to be provided to the applicant based on a predetermined filtering algorithm, and displays an extraction result on the first applicant device.

(Aspect 7) In the matching system according to any one of Aspects 1 to 6, the matching system further includes: a requester device operated by the requester, the computing device receives, from the requester device, an operation to register task content of the posted project, a skill required for the task of the posted project, and the content information in the database.

(Aspect 8) A computing device according to Aspect 8 is a computing device included in a matching system that matches a requester who solicits a contractor for a task with an applicant, the computing device including: a communication interface that communicates with a first applicant device operated by a first applicant; and a processor that communicates with the first applicant device and is accessible to a database in which task information indicating content of a posted task is registered for each posted project, in which the processor registers, in the database, content information that can identify educational content related to the posted project, in association with the posted project, and the processor displays the content information together with the posted project on the first applicant device.

(Aspect 9) A method according to Aspect 9 is a method for matching a requester who solicits a contractor for a task with an applicant, the method including steps of: communicating with a first applicant device operated by a first applicant; communicating with the first applicant device and accessing a database in which task information indicating content of a posted task is registered for each posted project; registering, in the database, content information that can identify educational content related to the posted project, in association with the posted project, and displaying the content information together with the posted project on the first applicant device.

It should be considered that the embodiments disclosed herein are merely illustrative and not limiting in all respects. The scope of the present invention is described by the claims, and not by the description of the embodiments described above. It is intended to include all modifications within the scope and meaning equivalent to the claims.

### REFERENCE SIGNS LIST

1 matching system, 50 Internet, 100 sharing server, 101 processor, 102 memory, 103 storage, 104 communication interface, 120 database (DB), 121 company database (company DB), 122, 122A member database (member DB), 123 community database (community DB), 124, 124A posted project database (posted project DB), 125 side job database (side job DB), 126 evaluation input database (evaluation input DB), 126A requester evaluation unit, 126B applicant evaluation unit, 127 evaluation summary database (evaluation summary DB), 127A requester evaluation summary unit, 127B applicant evaluation summary unit, 128 member group database (member group DB), 131 first-type content database (DB), 132 second-type content database (DB), 133 required skill database (DB), 134 content management database (DB), 1271, 1272 data group, 140 community registration unit, 141 company registration unit, 142 member registration unit, 143 member search unit, 144 project registration unit, 145 project extraction unit, 146 submission unit, 147 approval unit, 148 notification unit, 149 performance receiving unit, 150 performance output unit, 151 evaluation receiving unit, 152 evaluation output unit, 161 counter offer request unit, 162 counter offer approval request unit, 163 counter offer request acceptance notification unit, 200, 200A, 200B, 200C requester device, 201 processor, 202 memory, 203 communication interface, 204 input/output interface, 205 display, 206 operating unit, 206A keyboard, 206B mouse, 207, 550 screen, 300, 300A, 300B, 300C applicant device, 301 processor, 302 memory, 303 communication interface, 304 input/output interface, 305 display, 306 operating unit, 306A keyboard, 306B mouse, 307A to 307C tabs, 350 screen, 401, 402 table, 500 user device

1. A matching system that matches a requester who solicits a contractor for a task with an applicant, the matching system comprising:
a first applicant device operated by a first applicant; and
a computing device, the computing device communicatively coupled with the first applicant device and a database, wherein the database stores task information for posted projects, first disclosure information defining a disclosure range for each posted project, and second disclosure information defining a disclosure range for educational content associated with each posted project, wherein the second disclosure information is independent of the first disclosure information, wherein the second disclosure information is independent of the first disclosure information;
wherein the computing device is configured to:
receive a search request from the first applicant device;
based on the first disclosure information, identify a subset of posted projects permitted for disclosure to the first applicant;
based on the second disclosure information,
identify a subset of educational content permitted for disclosure to the first applicant; and
generate for display on the first applicant device a graphical user interface presenting the subset of posted projects and, for each presented project, only the identified subset of educational content.

2. The matching system according to claim 1, wherein
the computing device is further configured to
register, in the database, skill information that can identify a skill required for a task of the posted project, in association with the posted project, and
register the content information in the database, in association with the skill information.

3. The matching system according to claim 2, wherein
the skill information includes first-type skill information and second-type skill information for registering levels of the skill in a hierarchical manner in the database,
the content information includes first-type content information and second-type content information for registering educational levels of the educational content in a hierarchical manner in the database, and
the computing device is further configured to
register the first-type content information in the database in association with the first-type skill information, and
register the second-type content information in the database in association with the second-type skill information.

4. The matching system according to claim 3, wherein the first-type skill information corresponds to a basic skill and the second-type skill information corresponds to an applied skill.

5. The matching system according to claim 3, wherein the first-type content information corresponds to general-purpose educational content and the second-type content information corresponds to custom educational content.

6. The matching system according to any claim 2, wherein
the computing device is further configured to
receive an instruction to search for the posted project from the first applicant device, and
in response to receiving the instruction to search, extract the posted project to be provided to the applicant based on a predetermined filtering algorithm, and output an extraction result to the first applicant device.

7. The matching system according to claim 2, further comprising:
a requester device operated by the requester, wherein
the computing device is further configured to receive, from the requester device, an operation to register task content of the posted project, a skill required for the task of the posted project, and the content information in the database.

8. The matching system according to claim 1, wherein the first disclosure information includes a plurality of disclosure levels, wherein a first disclosure level permits disclosure only to applicants within a first group, and a second disclosure level permits disclosure to applicants within the first group and applicants within a community group.

9. The matching system according to claim 8, wherein the first disclosure information further includes a non-disclosure list identifying a target group to which the posted project is prohibited from being disclosed.

10. The matching system according to claim 1, further comprising a requester device operated by the requester, wherein the computing device is configured to receive, from the requester device, a request to search for a registered person, and in response, provide the requester device with profile information of one or more registered persons.

11. The matching system according to claim 10, wherein the computing device is further configured to receive a counter-offer from the requester device directed to a selected registered person and transmit an application encouragement to a device of the selected registered person.

12. The matching system according to claim 1, wherein the database is further configured to store applicant group information identifying an applicant group including a plurality of applicants, and wherein the computing device is configured to receive an application for a posted project from the applicant group.

13. The matching system according to claim 1, wherein the computing device is further configured to:
receive an evaluation of the first applicant from a requester device; and
store the evaluation in an evaluation summary database.

14. The matching system according to claim 13, wherein access to the evaluation is restricted based on an affiliation of a party requesting to view the evaluation.

15. A computing device included in a matching system that matches a requester who solicits a contractor for a task with an applicant, the computing device comprising:
a communication interface that communicates with a first applicant device operated by a first applicant; and
a processor that is communicatively coupled with the first applicant device and a database that stores task information for posted projects, first disclosure information defining a disclosure range for each posted project, and second disclosure information defining a disclosure range for educational content associated with each posted project, wherein the second disclosure information is independent of the first disclosure information wherein
the processor is configured to:
receive a search request from the first applicant device;
based on the first disclosure information, identify a subset of posted projects permitted for disclosure to the first applicant;
based on the second disclosure information, identify a subset of educational content permitted for disclosure to the first applicant; and
generate for display on the first applicant device a graphical user interface presenting the subset of posted projects and, for each presented project, only the identified subset of educational content.

16. The computing device according to claim 15, wherein the database further stores skill information for each posted project, the skill information comprising first-type skill information and second-type skill information for registering skill levels in a hierarchical manner, and wherein the processor is further configured to register first-type content information in association with the first-type skill information and second-type content information in association with the second-type skill information.

17. The computing device according to claim 15, wherein the processor is further configured to:
receive, from a requester device, a selection of a registered person from a search result; and
in response to the selection, transmit an application encouragement message to an applicant device associated with the registered person.

18. The computing device according to claim 15, wherein the database further stores applicant group information identifying an applicant group comprising a plurality of applicants, and wherein the processor is further configured to receive a single application for a posted project from the applicant group and transmit the single application to a requester device.

19. A computer-implemented method for matching a requester with an applicant, the method comprising:
storing, in a database on a server: (i) a plurality of posted projects, each associated with an estimated time for completion, (ii) a first disclosure information for each posted project, and (iii) an upper limit of work hours for a first applicant;
receiving a search request at the server from a first applicant device associated with the first applicant;
in response to the search request, performing, by a processor on the server, a multi-step filtering process to generate a customized data set, the process including:
(a) calculating the first applicant's available work hours by subtracting a total of the first applicant's current expected work hours from the stored upper limit of work hours;
(b) identifying a first subset of the plurality of posted projects wherein the estimated time for completion for each project is less than or equal to the calculated available work hours; and
(c) identifying a second subset of projects from the first subset based on the first disclosure information associated with each project in the first subset; and
transmitting the customized data set representing the second subset of projects for display on the first applicant device.

20. The method according to claim 19, further comprising:
judging, based on the first disclosure information stored in the database, a posted project allowed to be disclosed to the first applicant; and
judging, based on the second disclosure information stored in the database, content information allowed to be disclosed to the first applicant.
